(19) United States
(12) Patent Application Publication
(10) Pub. No.: US 2005/0234159 A1
(43) Pub. Date: Oct. 20, 2005

(54) Nucleation effect inhibitor, crystalline resin composition and method of controlling crystallization of crystalline resin composition

(76) Inventors: Hiroshi Takeuchi, Kadoma-shi (JP); Kazuaki Sukata, Yawata-shi (JP)

Correspondence Address: MCGLEW & TUTTLE, PC, P.O. BOX 9227, SCARBOROUGH STATION, SCARBOROUGH, NY, 10510-9227, US

(21) Appl. No.: 10/520,750

(22) PCT Filed: Jul. 7, 2003
(86) PCT No.: PCT/JP03/08580

§ 371 Date: Jan. 7, 2005

(30) Foreign Application Priority Data
Jul. 9, 2002 (JP) 2002-200674

(51) Int. Cl. C08K 5/34

(52) U.S. Cl. 524/90; 544/250; 548/150; 548/428; 546/95; 546/98; 544/35; 544/101; 544/350; 544/333

(57) ABSTRACT

A nucleating-effect-suppressor comprising a compound being any of the compounds having at least one structure selected from among polycyclic structures wherein three or more 4-membered or higher cyclic structures are condensed to form condensed ring, excluding nigrosine, aniline black and copper phthalocyanine derivative, a crystalline resin composition containing the nucleating-effect-suppressor, and a method of controlling crystallization by the used of the nucleating-effect-suppressor.

### TECHNICAL FIELD

The present invention relates to a nucleating-effect-suppressor for lowering the crystallization temperature or crystallization rate of a crystalline resin composition by incorporating it in the crystalline resin composition, a crystalline resin composition containing the nucleating-effect-suppressor, and a method of controlling crystallization wherein the crystallization temperature and crystallization rate of a crystalline resin are lowered using the nucleating-effect-suppressor.

### BACKGROUND ART

Because crystalline resins are excellent in mechanical and chemical properties, they are widely used in such fields as parts of automobiles, electric/electronic products and the like. In particular, the demand for engineering plastics is growing in various fields.

Also, there have been attempts to improve the heat resistance and chemical resistance of a crystalline resin, or to confer mechanical strength according to individual uses, by formulating a fibrous reinforcing material therein, so as to meet the requirements of a wide variety of industrial applications. Furthermore, in recent years, there has been a marked trend toward replacement of conventional metal parts with fiber-reinforced crystalline resins, to resolve the problems of weight reduction, manufacturing process simplification and corrosion prevention, in the fields of electronic parts, automobile parts, electrical equipment parts and the like.

When a crystalline resin used as a molding material is cooled from a molten state, crystallization occurs. The state of crystallization varies depending on the cooling conditions during the molding stage, the presence of a fine particle that serves as a core of crystallization, that is, a nucleating agent, and the like. Because the properties of the crystalline resin are significantly influenced by the state of crystallization, how to control its crystallization is the key to making use of the characteristics of the resin. For example, because the presence of a nucleating agent as described above has an effect of increasing the crystallization rate of a crystalline resin and raising the crystallization temperature (nucleating effect), cooling time during molding can be shortened.

By the way, crystalline resins are colored for the purpose of decoration, color identification, improvement of light fastness of molded products, content protection and shading, and the like. As colorants, inorganic pigments, organic pigments, dyes and the like are commonly used, and carbon black, in particular, is widely used for black coloring.

The inorganic pigments, organic pigments and the like used for coloring crystalline resins, in particular, carbon black and fibrous reinforcing materials (glass fiber, inorganic fillers such as mica and talc) exhibit behaviors similar to those of nucleating agents. Therefore, adding these materials causes an increase in the crystallization rate and micro-crystallization, and can hence considerably reduce the toughness. Also, because adding these materials causes a rise in crystallization temperature, it is necessary to raise the mold temperature in injection molding, which not only leads to an increase in energy cost, but also increases the shrinkage factor due to cooling of the molded product and hence decreases molding accuracy.

To resolve these problems, it is considered effective to suppress the actions of the aforementioned colorants, fibrous reinforcing materials and the like as nucleating agents, that is, to control crystallization by allowing the presence of a material capable of lowering the crystallization rate to suppress micro-crystallization and of lowering the crystallization temperature to lower the mold temperature in the crystalline resin. Note that hereinafter this effect is referred to as nucleation suppressing effect (crystallization retarding effect), and a material having this effect is referred to as nucleating-effect-suppressor (crystallization retarding effect agent).

In line with this concept, use of nigrosine, aniline black (Japanese Patent Laid-Open No. SHO-57-115454) and copper phthalocyanine derivatives (Japanese Patent Laid-Open No. SHO-61-181861) was proposed. Thereafter, various improvements of crystalline resin compositions using these materials were conducted. For example, 1) a polyamide-based member for vehicles (Japanese Patent Laid-Open No. SHO-62-246958), 2) a reinforced good-appearance black polyamide resin composition (Japanese Patent Laid-Open No. HEI-4-370148), 3) a glass-fiber-reinforced black polyamide resin composition (Japanese Patent Laid-Open No. HEI-6-128479), 4) a black polyamide resin composition (Japanese Patent Laid-Open No. HEI-9-255869), 5) a black colored polyamide resin composition having excellent weatherability (Japanese Patent Laid-Open Nos. HEI-11-343405, HEI-11-343406 and HEI-11-349807), 6) a black colored reinforced polyamide resin composition (Japanese Patent Laid-Open No. 2000-53861) and the like can be mentioned.

However, of those that have been used to date as nucleating-effect-suppressors, nigrosine and aniline black are black and copper phthalocyanine derivatives are dark blue. Hence, the range of color selection is very narrow when they are used in colored crystalline resin compositions; in almost all cases, their use has been limited to black or nearly black colored resin compositions.

However, since the demand for coloring a crystalline resin in various colors is very strong, there has been a strong need for the development of a colorless, light-colored or variously colored nucleating-effect-suppressor (a material that lowers the crystallization temperature and crystallization rate of a crystalline resin when present in the crystalline resin, compared to the case without the crystalline resin), that is, a nucleating-effect-suppressor that, unlike nigrosine, aniline black or copper phthalocyanine derivatives, does not narrow the range of color selection for colored crystalline resins.

The present invention was done in view of the above-described problems in the prior art, and the object thereof is to provide a nucleating-effect-suppressor that lowers the crystallization temperature and crystallization rate of a crystalline resin and allows free selection of colors in coloring the crystalline resin when contained in the crystalline resin, a crystalline resin composition containing the nucleating-effect-suppressor, and a method of controlling crystallization wherein the crystallization temperature and crystallization rate of crystalline resin are lowered using the nucleating-effect-suppressor.

### DISCLOSURE OF THE INVENTION

The present inventor investigated a new substance capable of suppressing a nucleating effect on a crystalline resin, focusing on the three-dimensional structure thereof, finding that the crystallization temperature and crystallization rate of a crystalline resin composition containing a compound having a particular structural characteristic fall compared to the case wherein the compound is not contained, and developed the present invention.

The nucleating-effect-suppressor of the present invention, which accomplishes the above-described object, is a nucleating-effect-suppressor comprising a compound that controls the crystallization of a crystalline resin in a crystalline resin composition, characterized in that said compound is any of the compounds having at least one structure selected from among polycyclic structures wherein three or more 4-membered or higher cyclic structures are condensed to form condensed ring, excluding nigrosine, aniline black and copper phthalocyanine derivatives.

As examples of the aforementioned polycyclic structures, those wherein three or more 4-membered and 6-membered cyclic structures are condensed to form condensed ring, those wherein three or more 5-membered and 6-membered cyclic structures are condensed to form condensed ring, those wherein three or more 6-membered and 7 or higher-membered cyclic structures are condensed to form condensed ring, those wherein three or more 4-membered and 5-membered cyclic structures are condensed to form condensed ring, those wherein a 4-membered, 5-membered and 6 or higher-membered cyclic structures are condensed to form condensed ring, those wherein three or more 4-membered and 6 or higher-membered cyclic structures are condensed to form condensed ring, and those wherein three or more 5-membered and 6 or higher-membered cyclic structures are condensed to form condensed ring, can be mentioned.

Also, the aforementioned compound may be one having one or two or more units of one kind of the aforementioned polycyclic structures (for example, one wherein two or more units of the same polycyclic structure are directly bound via single bonds or double bonds), and may be one having one or two or more units of each of two or more kinds of the aforementioned polycyclic structures (for example, one wherein two or more kinds of polycyclic structures are directly bound via single bonds or double bonds).

The nucleating-effect-suppressor of the present invention may be one that satisfies the following requirement (A).

(A) The crystallization temperature of a crystalline resin composition containing the nucleating-effect-suppressor is lower than the crystallization temperature of a crystalline resin in the aforementioned crystalline resin composition, which does not contain the aforementioned nucleating-effect-suppressor.

Also, the nucleating-effect-suppressor of the present invention may be one that satisfies the following requirement (B).

(B) The crystallization temperature of a crystalline resin composition containing 0.1 to 30 parts by weight of the nucleating-effect-suppressor per 100 parts by weight of a crystalline resin is lower than the crystallization temperature of a crystalline resin in the aforementioned crystalline resin composition, which does not contain the aforementioned nucleating-effect-suppressor by 4° C. or more.

Also, the nucleating-effect-suppressor of the present invention may be one that satisfies the following requirement (C).

(C) The crystallization rate of a crystalline resin composition containing the nucleating-effect-suppressor is smaller than the crystallization rate of a crystalline resin in the aforementioned crystalline resin composition, which does not contain the aforementioned nucleating-effect-suppressor

Also, the nucleating-effect-suppressor of the present invention may be one that satisfies the following requirement (D).

(D) The difference between the extrapolated crystallization initiation temperature and extrapolated crystallization end temperature of a crystalline resin composition containing 0.1 to 30 parts by weight of the nucleating-effect-suppressor per 100 parts by weight of a crystalline resin is larger than the difference between the extrapolated crystallization initiation temperature and extrapolated crystallization end temperature of a crystalline resin in the aforementioned crystalline resin composition, which does not contain the aforementioned nucleating-effect-suppressor by 2° C. or more.

Also, the nucleating-effect-suppressor of the present invention may be one that satisfies the following requirement (E).

(E) The sizes of sphaerocrystals in a crystalline resin composition containing the nucleating-effect-suppressor are larger than the sizes of sphaerocrystals in a crystalline resin in the aforementioned crystalline resin composition, which does not contain the aforementioned nucleating-effect-suppressor.

Also, the nucleating-effect-suppressor of the present invention may be one that satisfies the following requirement (F).

(F) The average diameter (for example, the median diameter of 2-axis average diameters) of sphaerocrystals in a crystalline resin composition containing 0.1 to 30 parts by weight of the nucleating-effect-suppressor per 100 parts by weight of a crystalline resin is larger than the average diameter of sphaerocrystals in a crystalline resin in the aforementioned crystalline resin composition, which does not contain the aforementioned nucleating-effect-suppressor by a factor of 2 times or more.

Also, the nucleating-effect-suppressor of the present invention may be one that satisfies the following requirement (G).

(G) The number of sphaerocrystals in a prescribed area (for example, a fixed surface or section) in a crystalline resin composition containing the nucleating-effect-suppressor is smaller than the number of sphaerocrystals in the aforementioned prescribed area in a crystalline resin in the aforementioned crystalline resin composition, which does not contain the aforementioned nucleating-effect-suppressor.

Also, the nucleating-effect-suppressor of the present invention may be one that satisfies the following requirement (H).

(H) The number of sphaerocrystals in a prescribed area in a crystalline resin composition containing 0.1 to 30 parts by weight of the nucleating-effect-suppressor per 100 parts by weight of a crystalline resin is smaller than the number of sphaerocrystals in the aforementioned prescribed area in a crystalline resin in the aforementioned crystalline resin composition, which does not contain the aforementioned nucleating-effect-suppressor by a factor of ⅔ or less.

The crystalline resin composition of the present invention contains one kind or more of any nucleating-effect-suppressor of the present invention in a crystalline resin.

Also, in the method of the present invention of controlling the crystallization of a crystalline resin composition, by containing one kind or more of any nucleating-effect-suppressor of the present invention in a crystalline resin, the crystallization temperature and crystallization rate of the crystalline resin composition containing the nucleating-effect-suppressor are lowered compared to the crystallization temperature and crystallization rate of the crystalline resin in the crystalline resin composition, which does not contain the aforementioned nucleating-effect-suppressor.

Crystal growth in the crystallization of a crystalline resin begins when a crystal nucleus is first produced by concentration fluctuations of impurities, molten polymers, or the like. The crystal nucleus having a size at which a crystal begins growing is the critical nucleus; nuclei of sizes smaller than the critical nucleus appear and disappear. Also, the period until the critical nucleus is formed is called nucleation induction period. When a nucleating agent or a substance equivalent thereto is contained in a crystalline resin, the result will be the same as in the presence of a crystal nucleus as the critical nucleus in advance. Hence, substantially without following the nucleation induction period, a crystal begins growing at a high temperature.

However, when the nucleating-effect-suppressor in the present invention is contained in a crystalline resin, the nucleation induction period lengthens, the temperature at which a crystal begins growing falls, and the crystallization rate falls. The three-dimensional structure of the compound that constitutes the aforementioned nucleating-effect-suppressor of the present invention significantly influences this nucleating effect suppression phenomenon.

The structure the compound that controls the crystallization of a crystalline resin in the nucleating-effect-suppressor of the present invention needs to have is at least one structure selected from among polycyclic structures wherein three or more 4-membered or higher cyclic structures (structure of a circular atomic sequence) are condensed to form condensed ring.

The nucleating-effect-suppressor of the present invention is capable of being effective in nucleating effect suppression compared to the following compounds. None of a compound having a structure wherein two 4-membered or higher cyclic structures are condensed to form condensed ring, a compound having a structure wherein cyclic structures with two 4-membered or higher cyclic structures condensed to form condensed ring are linked via single bonds, and a compound having a structure wherein three 4-membered or higher cyclic structures are linked via single bonds, has an effective nucleation suppressing effect.

When the nucleating-effect-suppressor of the present invention is contained in a crystalline resin, the nucleation induction period of the crystalline resin lengthens, the temperature at which a crystal begins growing falls, and the crystallization rate falls. Hence, the sizes of sphaerocrystals in a crystalline resin composition containing the nucleating-effect-suppressor of the present invention are larger than the sizes of sphaerocrystals in the original crystalline resin, which does not contain the nucleating-effect-suppressor. When the nucleation suppression effect is significant, the difference in the sizes of sphaerocrystals will be 2 times or more.

### BRIEF DESCRIPTION OF THE DRAWINGS

FIG. 1 is a photomicrograph of Example 195.

FIG. 2 is a photomicrograph of Example 196.

FIG. 3 is a photomicrograph of Example 197.

FIG. 4 is a photomicrograph of Example 198.

FIG. 5 is a photomicrograph of Example 199.

FIG. 6 is a photomicrograph of Example 200.

FIG. 7 is a photomicrograph of Example 201.

FIG. 8 is a photomicrograph of Comparative Example 129.

### MODES FOR EMBODYING THE INVENTION

The compound that constitutes the nucleating-effect-suppressor of the present invention may comprise at least one structure selected from among (a) to (d) below.
(a) A polycyclic structure wherein three 4-membered or higher cyclic structures are condensed to form condensed ring
(b) A polycyclic structure wherein four 4-membered or higher cyclic structures are condensed to form condensed ring
(c) A polycyclic structure wherein five 4-membered or higher cyclic structures are condensed to form condensed ring
(d) A polycyclic structure wherein six or more 4-membered or higher cyclic structures are condensed to form condensed ring

It is desirable that the 4-membered or higher cyclic structures be aromatic rings or heterocyclic rings.

Also, of the aforementioned nucleating-effect-suppressors, as those preferred in terms of compatibility with polyamide resin and other properties, those having a polycyclic structure wherein three or four 4-membered or higher cyclic structures are condensed to form condensed ring can be mentioned.

Also, (a) to (d) above can be (a) to (d) below, respectively.
(a) A polycyclic structure wherein three 5-membered and/or 6-membered cyclic structures are condensed to form condensed ring (for example, a combination of one 5-membered ring and two 6-membered rings, a combination of two 5-membered rings and one 6-membered ring, a combination of three 6-membered rings, and the like)
(b) A polycyclic structure wherein four 5-membered and/or 6-membered cyclic structures are condensed to form condensed ring (for example, a combination of one 5-membered ring and three 6-membered rings, a combination of two 5-membered rings and two 6-membered rings, a combination of four 6-membered rings, and the like)
(c) A polycyclic structure wherein five 5-membered and/or 6-membered cyclic structures are condensed to form condensed ring (a combination of one 5-membered ring and three 6-membered rings, a combination of two 5-membered rings and three 6-membered rings, a combination of one 5-membered ring and four 6-membered rings, a combination of five 6-membered rings, and the like)
(d) A polycyclic structure wherein six or more 5-membered and/or 6-membered cyclic structures are condensed to form condensed ring (a combination of one 5-membered ring and five 6-membered rings, a combination of two 5-membered rings and four 6-membered rings, a combination of three 5-membered rings and three 6-membered rings, a combination of two 5-membered rings and five 6-membered rings, a combination of six 6-membered rings, a combination of seven 6-membered rings, and the like)

It is preferable that the aforementioned polycyclic structures (a) to (d) be structures having two or more 6-membered rings.

Also, as the aforementioned 5-membered rings, a cyclopentadiene ring, a pyrrole ring, a pyroline ring, a pyrrolidine ring, a pyrazole ring, a pyrazoline ring, an imidazole ring, an imidazoline ring, an imidazolidine ring, a furan ring, an oxolan ring, a dioxolan ring, a thiophene ring, a thiolan ring, a thiazole ring and the like can be mentioned. Preferred are a cyclopentadiene ring and a pyrrole ring.

It is preferable that each of the aforementioned polycyclic structures (a) to (d) has a 5-membered ring, and the 5-membered ring(s) be a cyclopentadiene ring and/or a pyrrole ring.

Also, as the above-described 6-membered rings, a benzene ring, a cyclohexane ring, a pyridine ring, a piperidine ring, a pyrazine ring, a piperazine ring, a pyridone ring, a pyran ring, a pyron ring, an oxane ring, a dioxane ring, an oxazine ring, a thian ring, a dithian ring, a thiazine ring and the like can be mentioned. Preferred are a benzene ring and a pyridine ring.

Each of the aforementioned polycyclic structures (a) to (d) has a 6-membered ring, and it is preferable that the 6-membered ring(s) be a benzene ring and/or a pyridine ring. For example, each can be a polycyclic structure of 6-membered ring(s) and 5-membered ring(s) or a polycyclic structure of 6-membered rings only.

In the present specification, as superior expressions to show examples of polycyclic structures, skeletal structures are mentioned; as intermediate expressions to show examples of preferable structures belonging to the skeletal structures or other preferable structures, basic structures are mentioned. Also, preferable specific examples belonging to the basic structure or other preferable specific examples are mentioned as example compounds. In the skeletal structures, the individual bonds that constitute the skeleton are single bonds or double bonds, and the kinds of atoms that constitute the skeleton and the kinds and positions of substituents are not specified. In the basic structures, the kinds and positions of substituents are not specified.

Examples of specific relationships among skeletal structures, basic structures and example compounds are as follows.

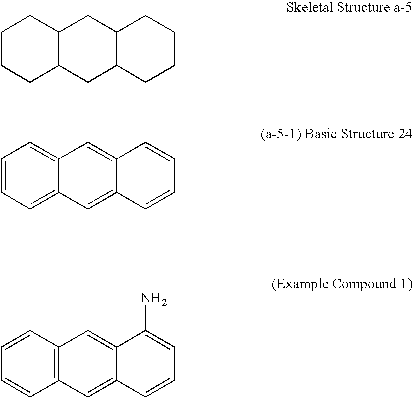

Skeletal Structure a-5 above is one of the skeletal structures belonging to the polycyclic structures wherein three 4-membered or higher cyclic structures are condensed to form condensed ring. Basic Structure 24 is one of the wide variety of basic structures of Skeletal Structure a-5, and Example Compound 1 is a preferred specific example belonging to Basic Structure 24, and has an amino group as a substituent at the 1-position thereof.

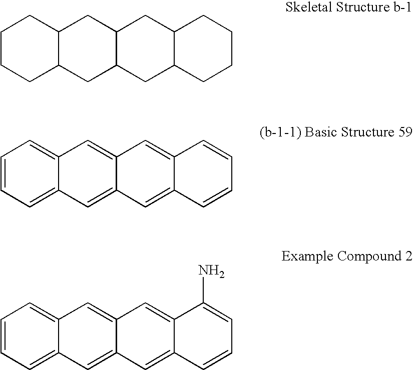

Skeletal Structure b-1 above is one of the skeletal structures belonging to the polycyclic structures wherein four 4-membered or higher cyclic structures are condensed to form condensed ring. Basic Structure 61 is one of the wide variety of basic structures of Skeletal Structure b-1, and Example Compound 2 is a preferred specific example belonging to Basic Structure 61, and has an amino group as a substituent at the 1-position thereof. 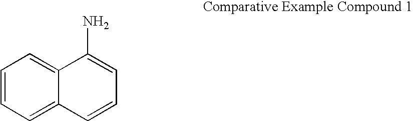
is a comparative compound relative to Example Compound 1 and Example Compound 2. Both Example Compound 1 and Example Compound 2 have in the molecules thereof the structure of Comparative Example Compound 1 (1-amino-naphthalene). That is, this is a comparative example compound with the number of condensed rings being smaller by one than a skeletal structure belonging to the polycyclic structures wherein three 4-membered or higher cyclic structures are condensed to form condensed ring (Example Compound 1).

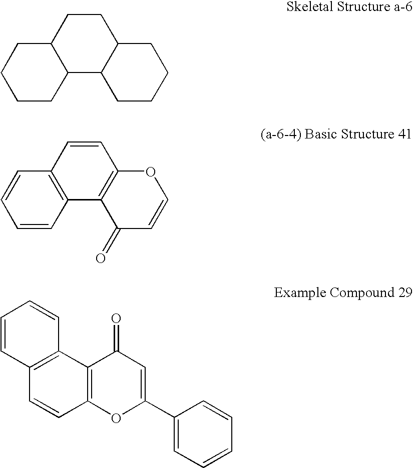

Skeletal Structure a-6 above is one of the skeletal structures belonging to the polycyclic structures wherein three 4-membered or higher cyclic structures are condensed to form condensed ring. Basic Structure 41 is one of the wide variety of basic structures of Skeletal Structure a-6, and Example Compound 29 is a preferred specific example belonging to Basic Structure 41. 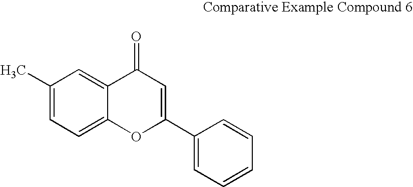
is a comparative compound relative to Example Compound 29. That is, this is a comparative example compound with the number of condensed rings being smaller by one than the skeletal structure belonging to a polycyclic structure wherein three 4-membered or higher cyclic structures are condensed to form condensed ring (Example Compound 1).

Changes in the crystallization temperature and crystallization rate of a crystalline resin composition containing the nucleating-effect-suppressor of the present invention can be determined as described below by conducting differential scanning calorimetry (DSC) on the crystalline resin composition containing the nucleating-effect-suppressor (a sample containing the nucleating-effect-suppressor) and on the crystalline resin alone in the crystalline resin composition (a sample not containing the nucleating-effect-suppressor).

(1) Changes in Crystallization Temperature

The magnitude thereof can be expressed by the difference between the crystallization temperature shown by the sample containing the nucleating-effect-suppressor (T_{CP}) and the crystallization temperature (T⁰_{CP}) shown by the sample not containing the nucleating-effect-suppressor (crystallization temperature fall ΔT_{CP}=T⁰_{CP}−T_{CP}). This shows that as the ΔT_{CP} increases, the nucleating effect suppressing effect increases, and that when the ΔT_{CP} has a negative value, a nucleating effect is evident.

(2) Changes in Crystallization Rate

The difference between extrapolated crystallization initiation temperature (T_{CIP}) and extrapolated crystallization end temperature (T_{CEP}), that is, crystallization temperature range, is expressed as ΔT_{C}=T_{CIP}-T_{CEP}. The difference between the extrapolated crystallization initiation temperature (T⁰_{CIP}) and extrapolated crystallization end temperature (T⁰_{CEP}) shown by the sample not containing the nucleating-effect-suppressor, that is, the crystallization temperature range of the sample not containing the nucleating-effect-suppressor, is expressed as ΔT⁰_{C}=T⁰_{CIP}−T⁰_{CEP}.

It is shown that the greater ΔΔT_{C}=ΔT_{C}−ΔT⁰_{C} is, the slower the crystallization rate is compared to the sample not containing a nucleating-effect-suppressor, and a negative value indicates that the crystallization rate became faster, that is, a nucleating effect appeared.

(1) Investigation of Crystallization Temperature Falls
T⁰_{CP} of polyamide 66 (crystalline resin alone): 232.8° C.
T_{CP} of polyamide 66 with Example Compound 1 added thereto: 217.7° C.
   ΔT_{CP}=T⁰_{CP}−T_{CP}=+15.1° C.
T_{CP} of polyamide 66 with Example Compound 2 added thereto: 218.6° C.
   ΔT_{CP}=T_{CP}−T_{C}=+14.2° C.
T_{CP} of polyamide 66 with Comparative Example Compound 1 added thereto: 232.2° C.
   ΔT_{CP}=T⁰_{CP}−T_{CP}=+0.6° C.

In the individual crystalline resin compositions with Example Compound 1 and Example Compound 2, which belong to the polycyclic structures wherein three and four 4-membered or higher cyclic structures are condensed to form condensed ring, respectively, added to polyamide 66, the crystallization temperature fell significantly compared to polyamide 66 alone. However, the crystallization temperature of a crystalline resin composition with Comparative Example Compound 1, which has a structure wherein two rings are condensed to form condensed ring to have a number of condensed rings smaller by one than Example Compound 1, added to polyamide 66, remains almost unchanged from the case of polyamide 66 alone; it is seen that the crystallization temperature cannot be lowered.
T_{CP} of polyamide 66 with Example Compound 29 added thereto: 220.0° C.
   ΔT_{CP}=T⁰_{CP}−T_{CP}=+12.8° C.
T_{CP} of polyamide 66 with Comparative Example Compound 6 added thereto: 230.8° C.
   ΔT_{CP}=T⁰_{CP}−T_{CP}=+2.0° C.

In the individual crystalline resin compositions with Example Compound 29, which belongs to the polycyclic structures wherein three 4-membered or higher cyclic structures are condensed to form condensed ring, added to polyamide 66, the crystallization temperature fell significantly compared to polyamide 66 alone. However, the crystallization point of the crystalline resin composition with Comparative Example Compound 6, resulting from replacement of one benzene ring of the condensed ring of Example Compound 29 with one methyl group (that is, the number of condensed rings is smaller by one than Example Compound 29), added to polyamide 66, remains almost unchanged from the case of polyamide 66 alone.

(2) Investigation of Crystallization Rate Falls
ΔT⁰_{C} (crystallization temperature range) of polyamide 66 (crystalline resin alone): 9.5° C.
ΔT_{C} (crystallization temperature range) of polyamide 66 with Example Compound 1 added thereto: 13.7° C.
   ΔΔT_{C}=ΔT_{C}−ΔT⁰_{C}=+4.2° C.
ΔT_{C} of polyamide 66 with Example Compound 2 added thereto: 15.8° C.
   ΔΔT_{C}=ΔT_{C}−ΔT⁰_{C}=+6.3° C.
ΔT_{C} of polyamide 66 with Comparative Example Compound 1 added thereto: 8.4° C.
   ΔΔT_{C}=ΔT_{C}−ΔT⁰_{C}=−1.1° C.

In the individual crystalline resin compositions with Example Compound 1 and Example Compound 2, which belong to the polycyclic structures wherein three and four 4-membered or higher cyclic structures are condensed to form condensed ring, respectively, added to polyamide 66, ΔΔT_{C} is large. This shows that the crystallization rate fell significantly compared to polyamide 66. However, in the case of the crystalline resin composition with Comparative Example Compound 1, which has a structure wherein two rings are condensed to form condensed ring to have a number of condensed rings smaller by one than Example Compound 1, added to polyamide 66, a negative value is obtained. That is, the crystallization rate rose, though the increase is slight, compared to the case of polyamide 66 alone; a nucleating effect is exhibited.
ΔT_{C} of polyamide 66 with Example Compound 29 added thereto: 16.5° C.
   ΔΔT_{C}=ΔT_{C}−ΔT⁰_{C}=+7.0° C.
ΔT_{C} of polyamide 66 with Comparative Example Compound 6 added thereto: 9.5° C.
   ΔΔT_{C}=ΔT_{C}−ΔT⁰_{C}=0° C.

In the individual crystalline resin compositions with Example Compound 29, which belongs to the polycyclic structures wherein three 4-membered or higher cyclic structures are condensed to form condensed ring, added to polyamide 66, the ΔΔT_{C} rose, and the crystallization rate fell significantly compared to polyamide 66 alone. However, in the case of the crystalline resin composition with Comparative Example Compound 6 added to polyamide 66, ΔΔT_{C}=0 is obtained; it is found that the crystallization rate of polyamide 66 cannot be lowered.

As shown in the above-described data, depending on whether or not the number of rings in the polycyclic structure wherein 4-membered or higher cyclic structures are condensed to form condensed ring in the compound added to the crystalline resin is three or more, the influences on the crystallization point (crystallization temperature) and crystallization rate of the crystalline resin vary widely. When the aforementioned number of rings is two, the influences on the crystallization point and crystallization rate are very small; when the aforementioned number of rings is three or more, significant falls are observed in the crystallization point and the crystallization rate.

Also, referring to the crystalline resin compositions containing Example Compound 1, Example Compound 2 and Example Compound 29, respectively, the extrapolated crystallization initiation temperature (T_{CIP}) is much lower than the crystalline resin alone (crystalline resin alone: 236.0° C., Example Compound 1: 224.8° C., Example Compound 2: 227.3° C., Example Compound 29: 229.6° C.); it is found that the nucleus induction period has lengthened in each case.

Combining these findings, it is found that there is an extremely wide difference in nucleating effect suppression between the compounds having a polycyclic structure wherein three or more 4-membered or higher cyclic structures are condensed to form condensed ring and the compounds having a structure wherein two 4-membered or higher cyclic structures are condensed to form condensed ring.

Next, specific examples of the skeletal structures and the basic structures are described.

Skeletal Structures

(a) As examples of polycyclic structures wherein three 4-membered or higher cyclic structures are condensed to form condensed ring, Skeletal Structures a-1 to a-8 below can be mentioned. Note that the individual bonds that constitute each skeletal structure are single bonds or double bonds.

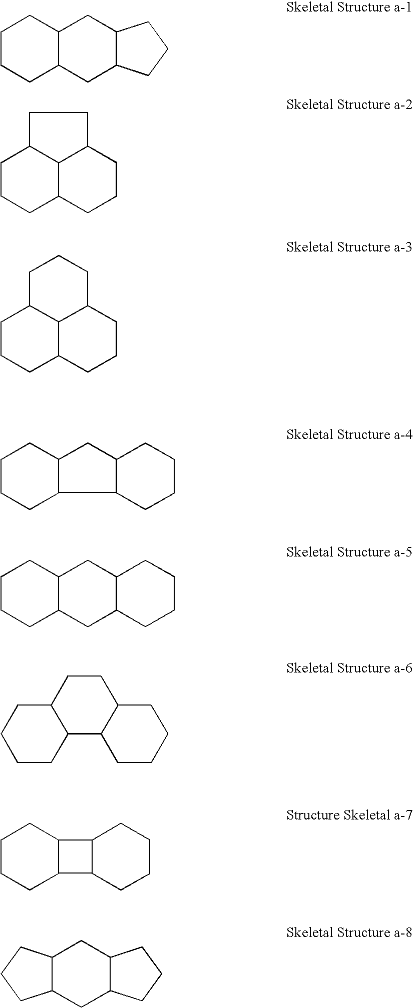

(b) As examples of polycyclic structures wherein four 4-membered or higher cyclic structures are condensed to form condensed ring, Skeletal Structures b-1 to b-12 below can be mentioned. Note that the individual bonds that constitute each skeletal structure are single bonds or double bonds.

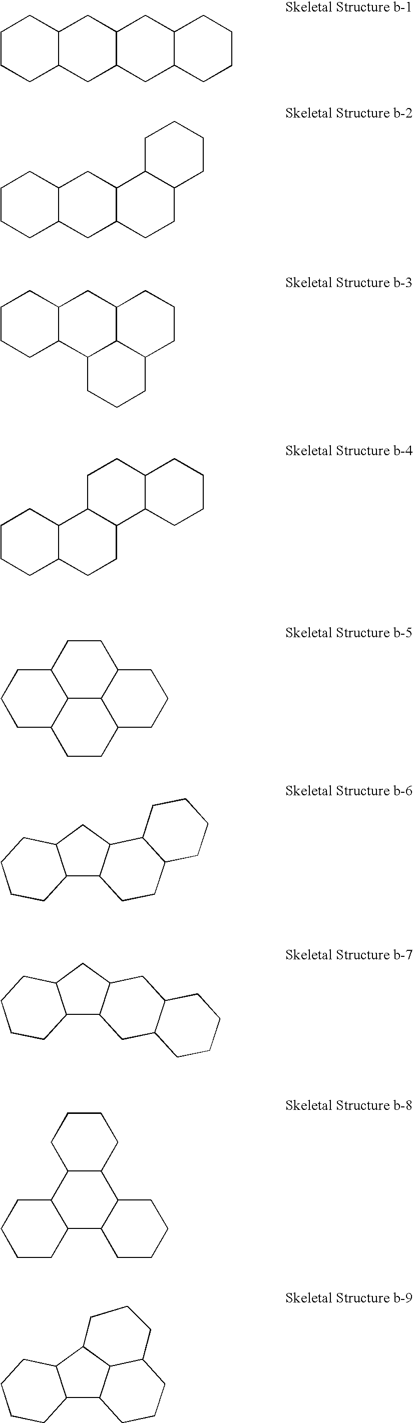

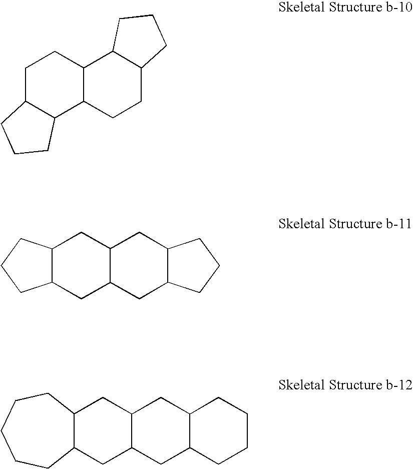

(c) As examples of polycyclic structures wherein five 4-membered or higher cyclic structures are condensed to form condensed ring, Skeletal Structures c-1 to c-8 can be mentioned. Note that the individual bonds that constitute each skeletal structure are single bonds or double bonds.

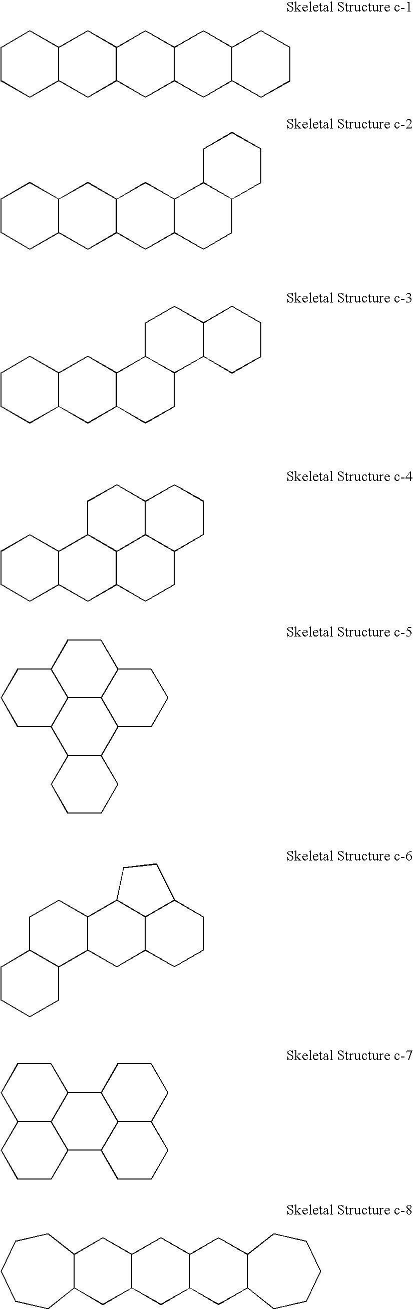

(d) As examples of polycyclic structures wherein six or more 4-membered or higher cyclic structures are condensed to form condensed ring, Skeletal Structures d-1 to d-10 below can be mentioned. Note that the individual bonds that constitute each skeletal structure are single bonds or double bonds. 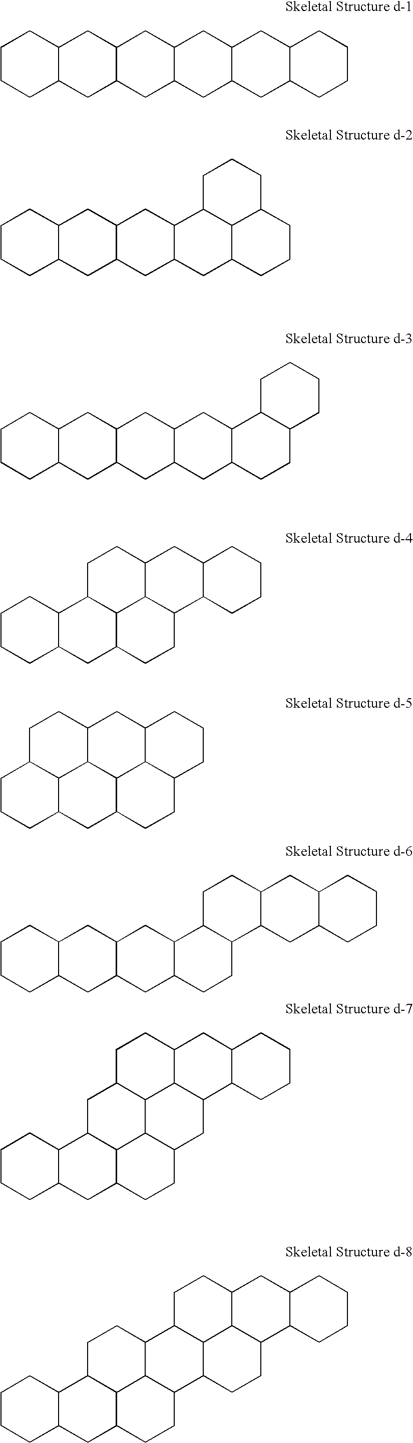 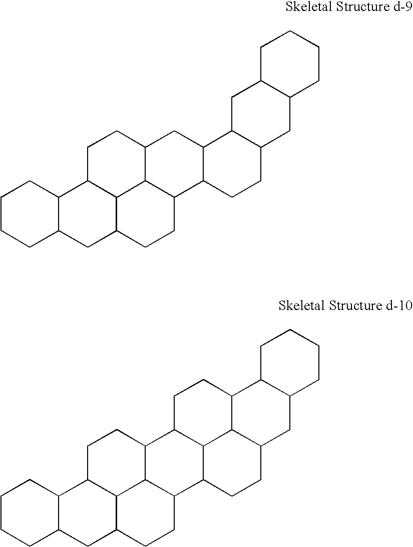
Basic Structures

(a) Examples of Preferred Basic Structures of Polycyclic Structures Wherein Three 4-Membered or Higher Cyclic Structures are Condensed to Form Condensed Ring

(a-1) Examples of Preferred Basic Structures Belonging to Skeletal Structure a-1: Basic Structures 1 to 8

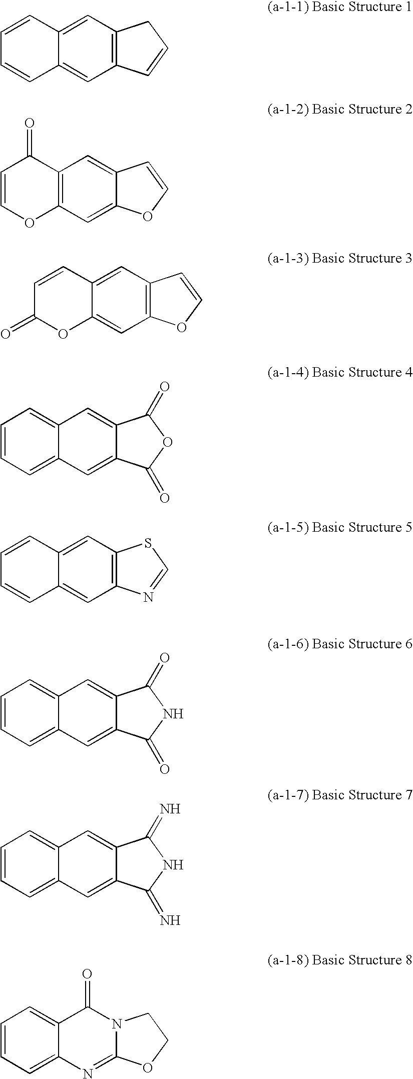

(a-2) Examples of Preferred Basic Structures Belonging to Skeletal Structure a-2: Basic Structures 9 to 11

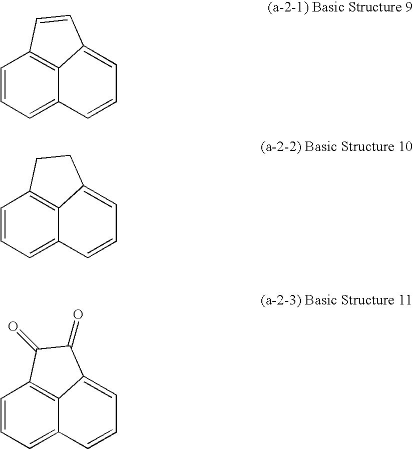

(a-3) Examples of Preferred Basic Structures Belonging to Skeletal Structure a-3: Basic Structures 12 to 17

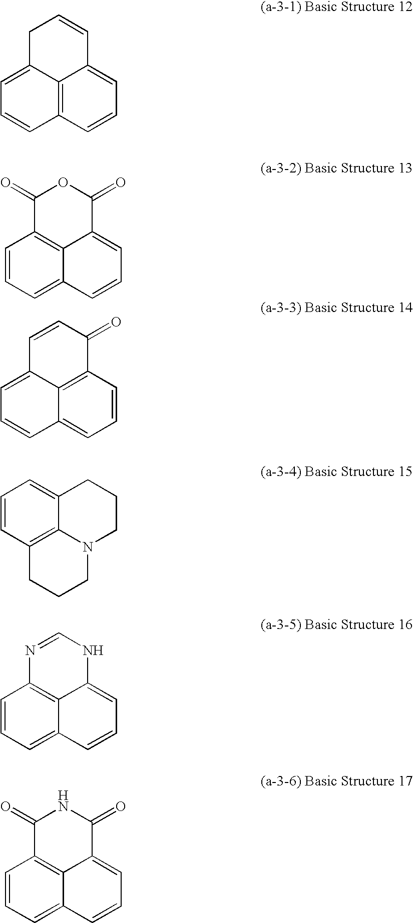

(a-4) Examples of Preferred Basic Structures Belonging to Skeletal Structure a-4: Basic Structures 18 to 23

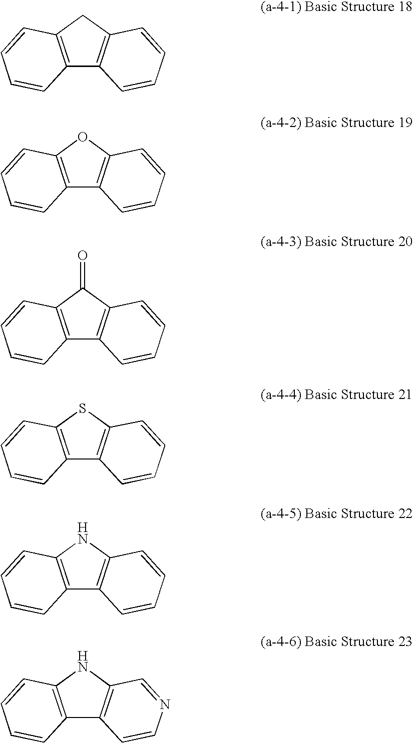

(a-5) Examples of Preferred Basic Structures Belonging to Skeletal Structure a-5: Basic Structures 24 to 38 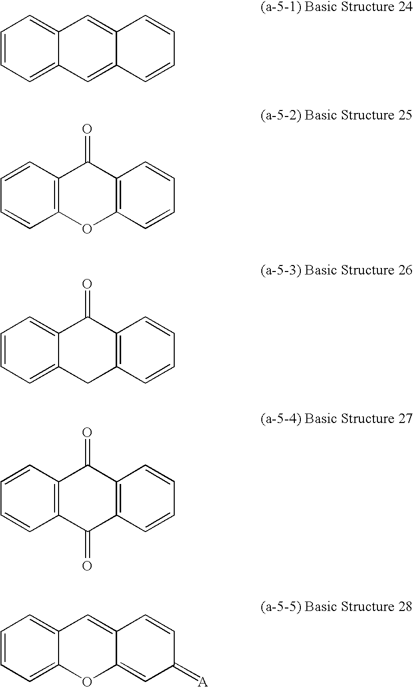
[In Basic Structure 28, A represents S, N—R, N⁺(—R¹)—R² or O, and each of R, R¹ and R² represents H, an alkyl group having or not having a substituent, or an aryl group having or not having a substituent.] 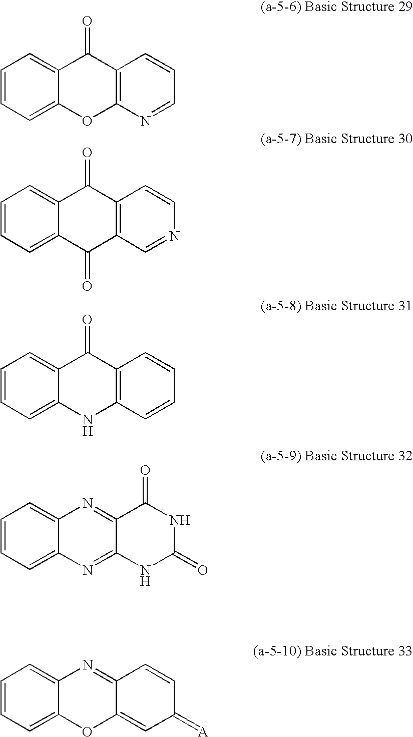
[In Basic Structure 33, A represents S, N—R, N⁺(—R¹)—R² or O, and each of R, R¹ and R² represents H, an alkyl group having or not having a substituent, or an aryl group having or not having a substituent.] 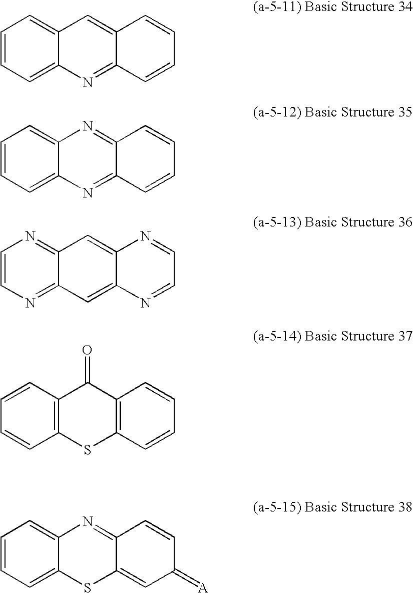
[In Basic Structure 38, A represents S, N—R, N⁺(—R¹)—R² or O, and each of R, R¹ and R² represents H, an alkyl group having or not having a substituent, or an aryl group having or not having a substituent.]

(a-6) Examples of preferred basic structures belonging to Skeletal Structure a-6: Basic Structures 39 to 49

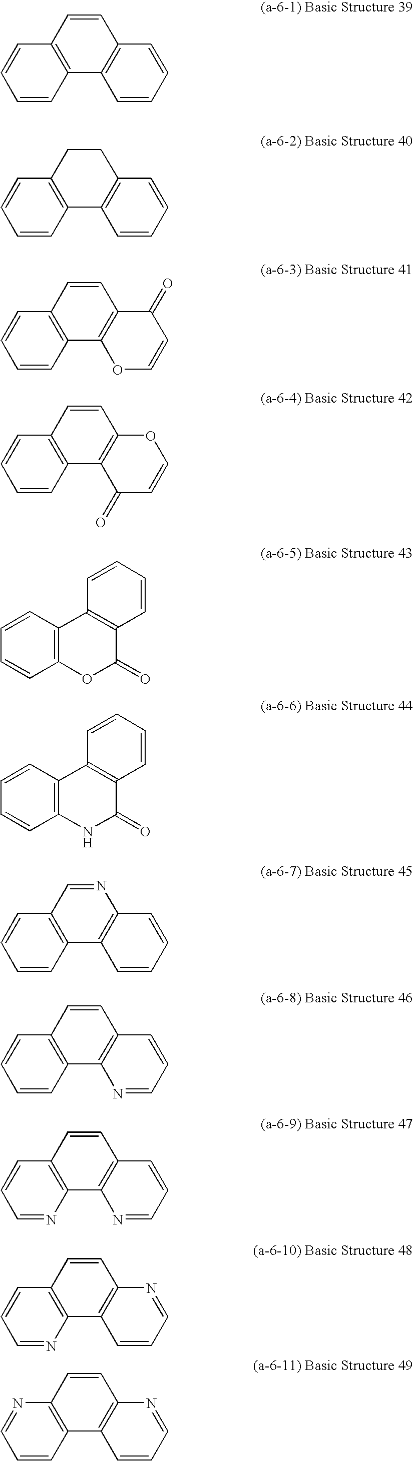

(a-7) Example of Preferred Basic Structure Belonging to Skeletal Structure a-7: Basic

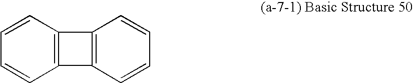

(a-8) Examples of Preferred Basic Structures Belonging to Skeletal Structure a-8: Basic Structures 51 to 53

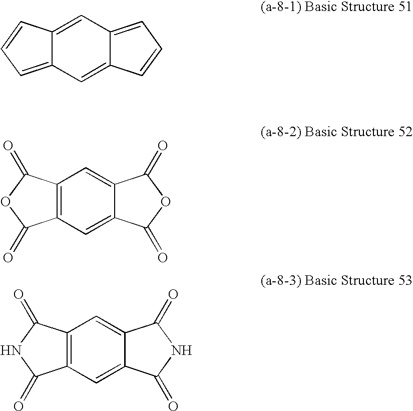

(a-9) Examples of Other Preferred Basic Structures of Polycyclic Structures Wherein Three 4-Membered or Higher Cyclic Structures are Condensed to Form Condensed Ring: Basic Structures 54 to 60

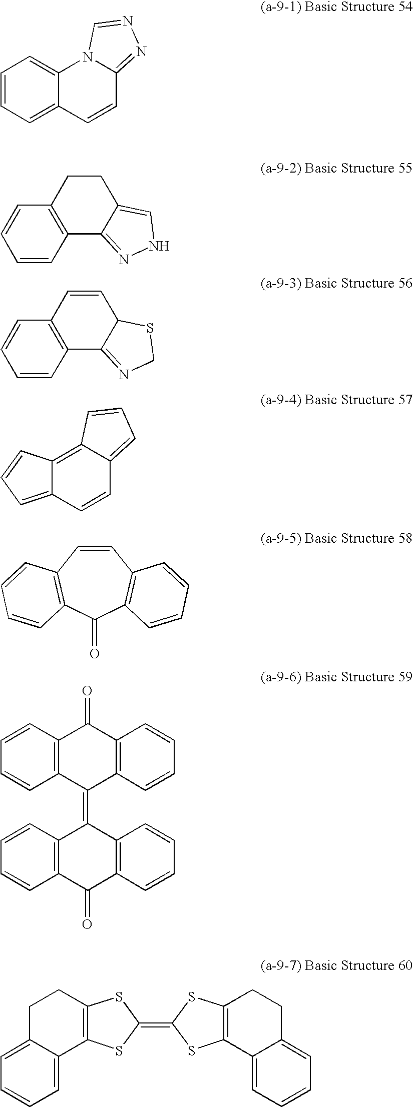

(b) Examples of Preferred Basic Structures of Polycyclic Structures Wherein Four 4-Membered or Higher Cyclic Structures are Condensed to Form Condensed Ring

(b-1) Examples of Preferred Basic Structures Belonging to Skeletal Structure b-1: Basic Structures 61 and 63

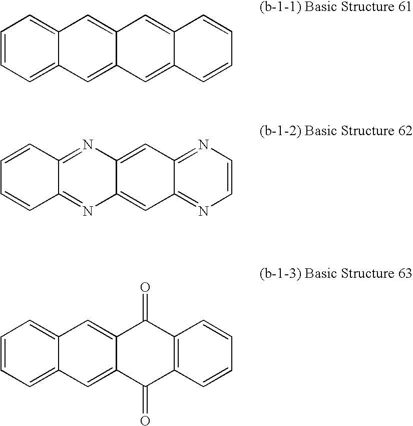

(b-2) Examples of Preferred Basic Structures Belonging to Skeletal Structure b-2: Basic Structures 64 to 69 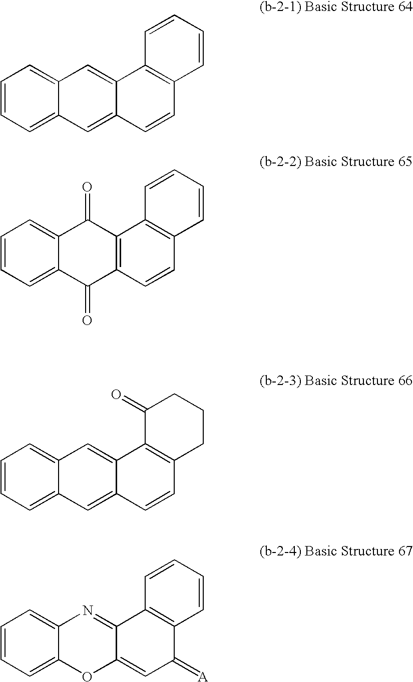
[In Basic Structure 67, A represents S, N—R, N⁺(—R¹)—R² or O, and each of R, R¹ and R² represents H, an alkyl group having or not having a substituent, or an aryl group having or not having a substituent.] 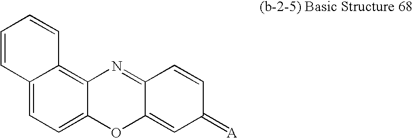
[In Basic Structure 68, A represents S, N—R, N⁺(—R¹)—R² or O, and each of R, R¹ and R² represents H, an alkyl group having or not having a substituent, or an aryl group having or not having a substituent.]

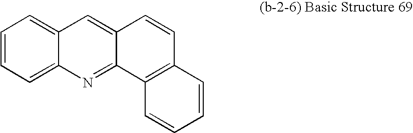

(b-3) Examples of Preferred Basic Structures Belonging to Skeletal Structure b-3: Basic Structures 70 to 73

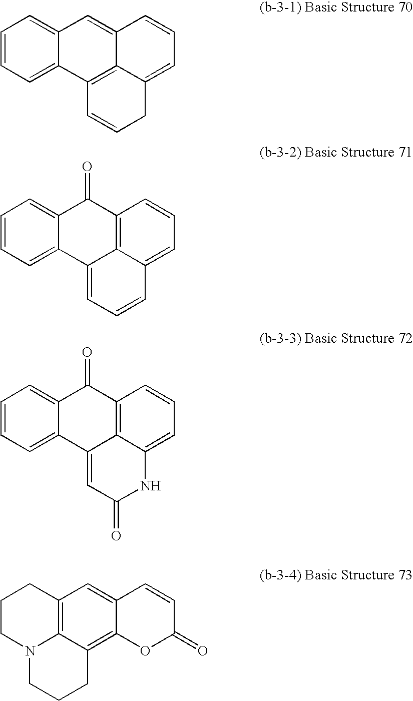

(b-4) Examples of Preferred Basic Structures Belonging to Skeletal Structure b-4: Basic Structures 74 and 75

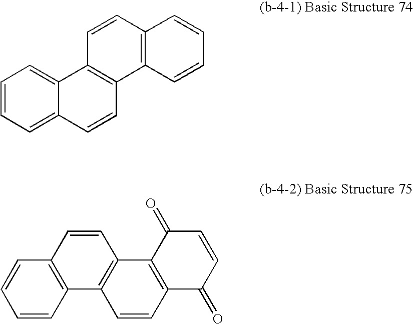

(b-5) Examples of Preferred Basic Structures Belonging to Skeletal Structure b-5: Basic Structures 76 to 78

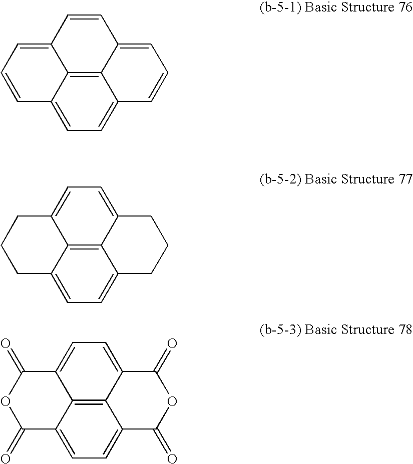

(b-6) Examples of Preferred Basic Structures Belonging to Skeletal Structure b-6: Basic Structures 79 to 81

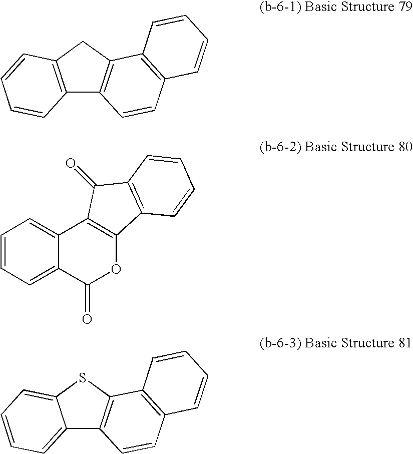

(b-7) Examples of Preferred Basic Structures Belonging to Skeletal Structure b-7: Basic Structures 82 and 83

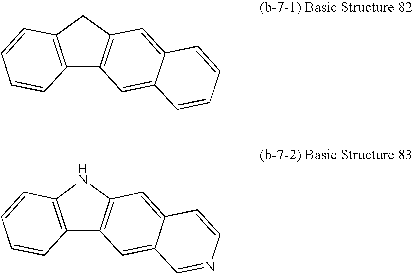

(b-8) Examples of Preferred Basic Structures Belonging to Skeletal Structure b-8: Basic Structure 84

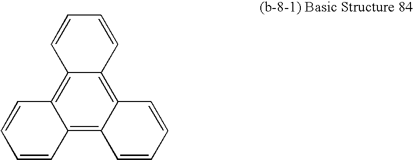

(b-9) Examples of Preferred Basic Structures Belonging to Skeletal Structure b-9: Basic Structure 85

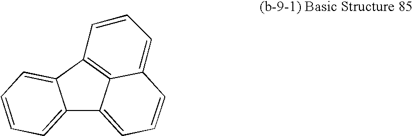

(b-10) Examples of Other Preferred Basic Structures of Polycyclic Structures Wherein Four 4-Membered or Higher Cyclic Structures are Condensed to Form Condensed Ring: Basic Structures 86 and 87

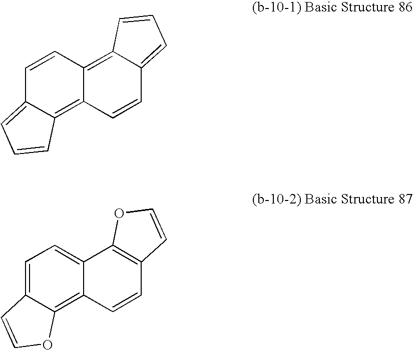

(b-11) Example of Other Preferred Basic Structure of Polycyclic Structure Wherein Four 4-Membered or Higher Cyclic Structures are Condensed to Form Condensed Ring: Basic Structure 88

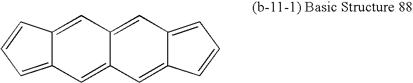

(b-12) Example of Other Preferred Basic Structure of Polycyclic Structure Wherein Four 4-Membered or Higher Cyclic Structures are Condensed to Form Condensed Ring: Basic Structure 89

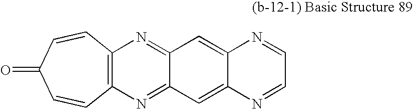

(b-13) Examples of Other Preferred Basic Structures of Polycyclic Structures Wherein Four 4-Membered or Higher Cyclic Structures are Condensed to Form Condensed Ring: Basic Structures 90 to 93

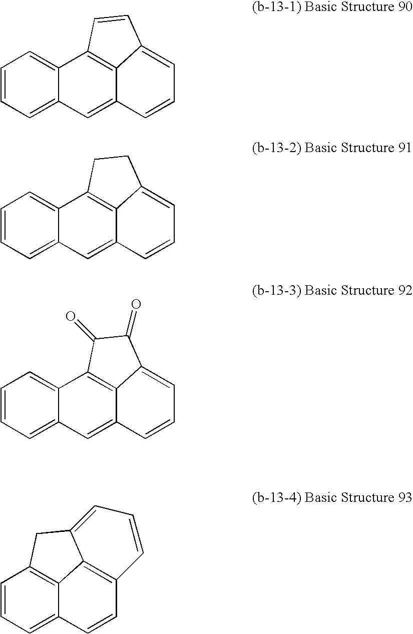

(c) Examples of Preferred Basic Structures of Polycyclic Structures Wherein Five 4-Membered or Higher Cyclic Structures are Condensed to Form Condensed Ring

(c-1) Examples of Preferred Basic Structures Belonging to Skeletal Structure c-1: Basic Structures 94 and 95

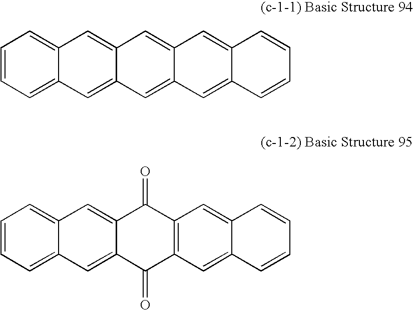

(c-2) Examples of Preferred Basic Structures Belonging to Skeletal Structure c-2: Basic Structures 96

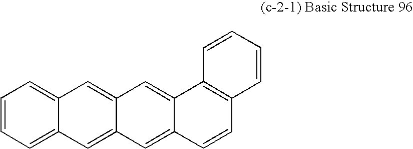

(c-3) Examples of Preferred Basic Structure Belonging to Skeletal Structure c-3: Basic Structures 97

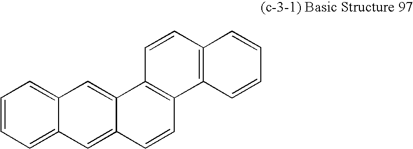

(c-4) Examples of Preferred Basic Structures Belonging to Skeletal Structure c-4: Basic Structures 98 and 99

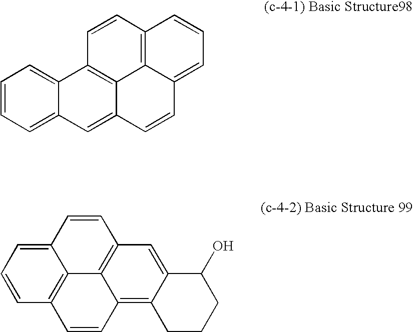

(c-5) Examples of preferred basic structures belonging to Skeletal Structure c-5: Basic Structures 100 and 101

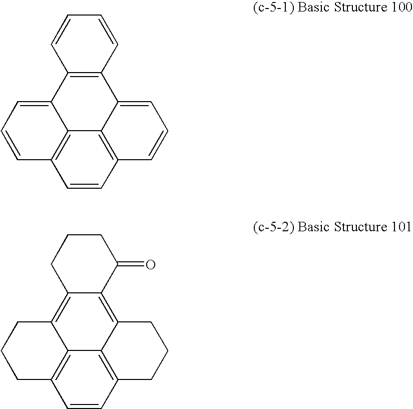

(c-6) Example of Preferred Basic Structure Belonging to Skeletal Structure c-6: Basic Structure 102

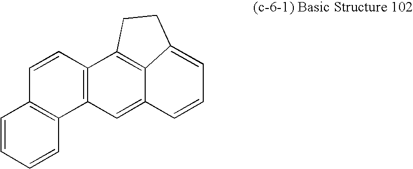

(c-7) Example of Preferred Basic Structure Belonging to Skeletal Structure c-7: Basic Structure 103

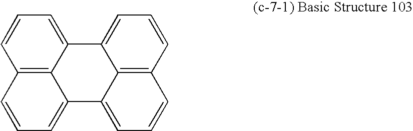

(c-8) Example of Preferred Basic Structure Belonging to Skeletal Structure c-8: Basic Structure 104

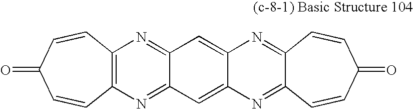

(c-9) Examples of Other Preferred Basic Structures of Polycyclic Structures Wherein Five 4-Membered or Higher Cyclic Structures are Condensed to Form Condensed Ring: Basic Structures 105 to 112

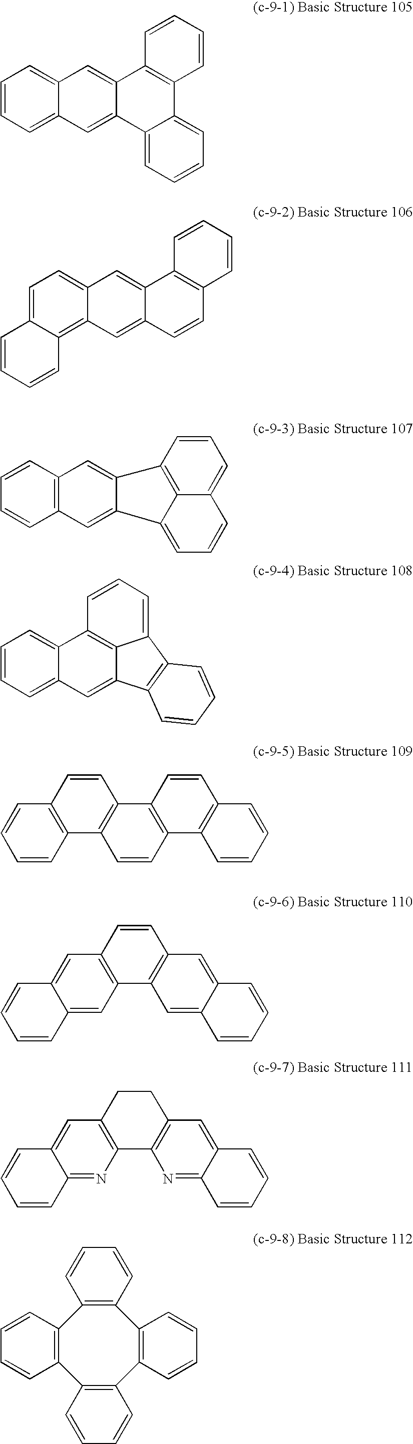

(d) Examples of Preferred Basic Structures of Polycyclic Structures Wherein Six or More 4-Membered or Higher Cyclic Structures are Condensed to Form Condensed Ring: Basic Structures 113 to 131

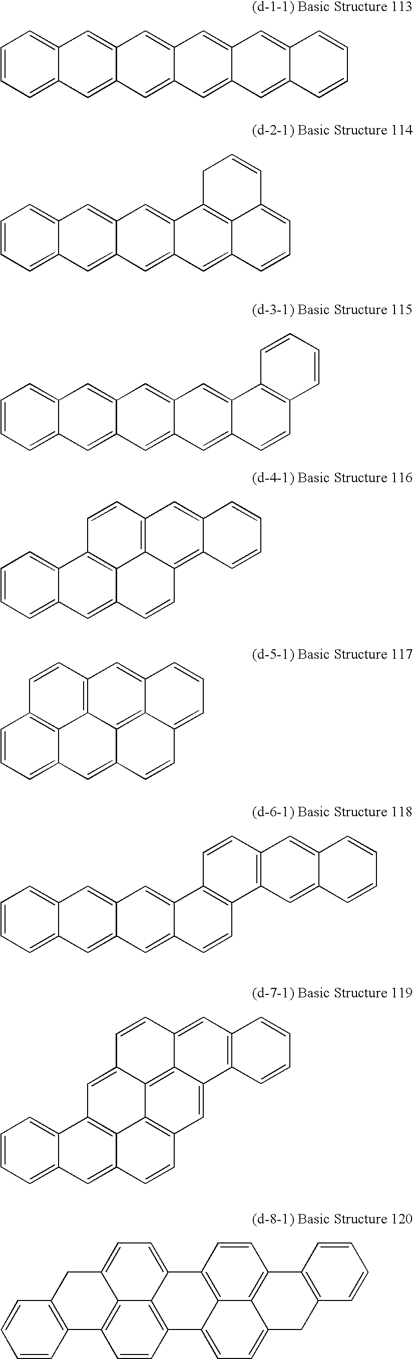

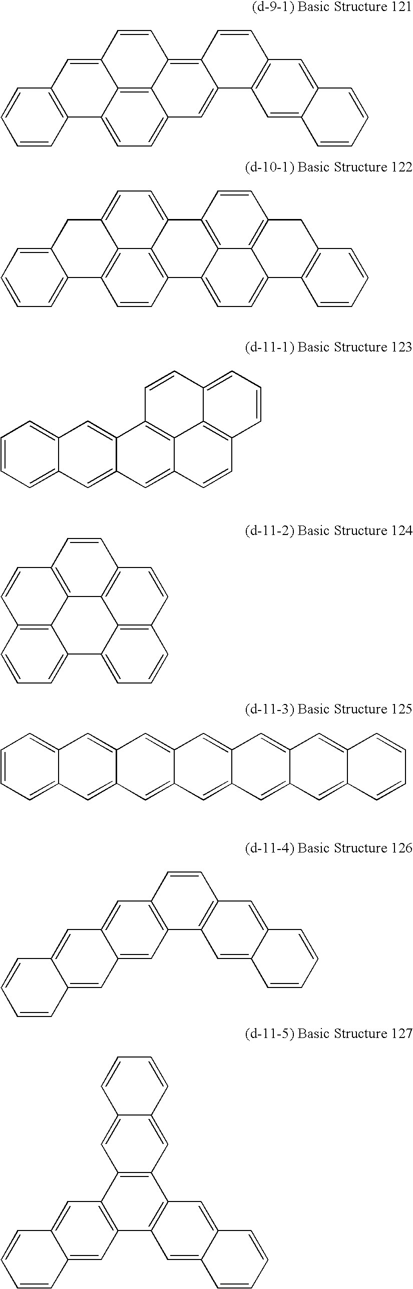

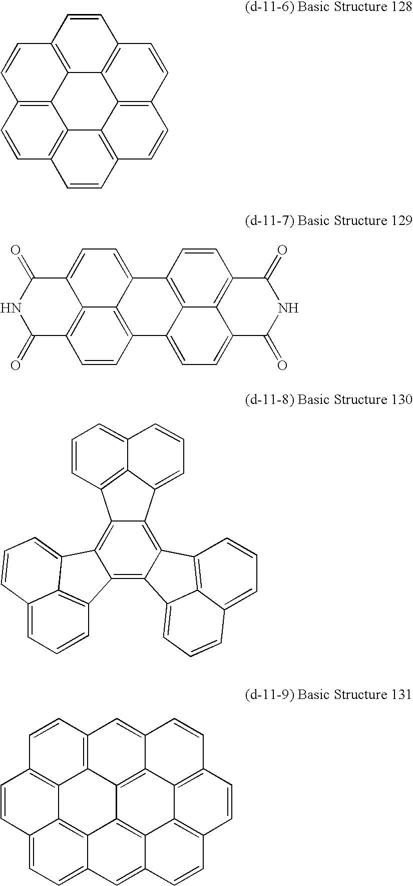

The nucleating-effect-suppressor of the present invention may comprise a salt wherein a cation and an anion are ionically bound. In this case, the salt that constitutes the nucleating-effect-suppressor may be a salt formed by ionic bond of an anion or a cation formed by ionizing of an amino group having or not having a substituent, a sulfone group or a carboxyl group in the above-described basic structure of the nucleating-effect-suppressor and a cation component or an anion component as a counterion. Also, the aforementioned anion component as the counterion may be an anion from a carboxylic acid or a sulfonic acid; as preferable ones, anion components resulting from an aromatic or aliphatic sulfonic acid and an aromatic or aliphatic carboxylic acid, respectively, can be mentioned.

The nucleating-effect-suppressor of the present invention may comprise a compound wherein another substituent or the like are bound to the aforementioned polycyclic structure. The other substituent or the like that bind to the polycyclic structure need to have no significant adverse effect (for example, causing cleavage of a polymer chain, and the like) on the subject crystalline resin, and are desirably supplementary to the compatibility with the subject crystalline resin. As specific examples of such substituents, one kind or two kinds of a hydroxyl group, a halogen, a nitro group, a cyano group, an alkyl group, an alkoxy group, an aralkyl group, an allyl group, an alkenyl group, an alkynyl group, an aryl group, an acyl group, an alkoxycarbonyl group, an aryloxycarbonyl group, an alkylaminocarbonyl group, an arylaminocarbonyl group, an alkylamino group, an arylamino group, an amino group, an acylamino group, a sulfonamide group, a sulfone group and a carboxyl group can be mentioned. Preferred are one kind or two kinds of an amino group, a dimethylamino group, a carbonyl group, a methyl group and an acetyl group.

As examples of the aforementioned halogen, F, Cl, Br, I and the like can be mentioned.

As examples of the aforementioned alkyl group, alkyl groups having 1 to 18 carbon atoms, such as a methyl group, an ethyl group, a propyl group, an isopropyl group, a butyl group and a tert-butyl group, can be mentioned.

As examples of the aforementioned alkoxy group, alkoxy groups having 1 to 18 carbon atoms, such as a methoxy group, an ethoxy group and an isopropoxy group, can be mentioned.

As examples of the aforementioned aralkyl group, a benzyl group, an α,α′-dimethylbenzyl group and the like, whether having or not having a substituent, can be mentioned.

As examples of the aforementioned alkenyl group, vinyl, propenyl, butenyl and the like can be mentioned.

As examples of the aforementioned allyl group, —CH₂CH═CH₂, —C(CH₃)═CH₂ and the like can be mentioned.

As examples of the aforementioned aryl group, a phenyl group, a tolyl group, a naphthyl group and the like, whether having a substituent (for example, alkyl groups having 1 to 18 carbon atoms, or halogen atoms such as Cl, Br, I, F, or the like) or not having a substituent, can be mentioned.

As examples of the aforementioned acyl group, an acetyl group, a propionyl group, a butyryl group, a benzoyl group and the like can be mentioned.

As examples of the aforementioned alkoxycarbonyl group, a methoxycarbonyl group, an ethoxycarbonyl group, an isopropoxycarbonyl group and the like can be mentioned.

As examples of the aforementioned aryloxycarbonyl group, a phenyloxycarbonyl group, a tolyloxycarbonyl group, a naphthyloxycarbonyl group and the like, whether having or not having a substituent, can be mentioned.

As examples of the aforementioned alkylaminocarbonyl group, a methylaminocarbonyl group, an ethylaminocarbonyl group, a propylaminocarbonyl group, an isopropylaminocarbonyl group, an octylaminocarbonyl group and the like can be mentioned.

As examples of the aforementioned arylaminocarbonyl group, a phenylaminocarbonyl group, a tolylaminocarbonyl group, a naphthylaminocarbonyl group and the like, whether having or not having a substituent, can be mentioned.

As examples of the aforementioned alkylamino group, a methylamino group, an ethylamino group, a propylamino group, an isopropylamino group, a pentylamino group, a dodecylamino group and the like can be mentioned.

As examples of the aforementioned arylamino group, a phenylamino group, a tolylamino group, a naphthylamino group and the like, whether having or not having a substituent, can be mentioned.

The amount of nucleating-effect-suppressor contained in the crystalline resin composition of the present invention can, for example, be 0.05 to 30 parts by weight per 100 parts by weight of a crystalline resin. Preferred are 0.1 to 10 parts by weight. Particularly preferred for sufficient falls in crystallization temperature are 1 to 5 parts by weight.

As the crystalline resin used in the present invention, any crystalline resin that has a nucleating effect suppressing effect with the addition of the aforementioned nucleating-effect-suppressor can be used; for example, polyamide resin, polyethylene resin, polypropylene resin, polyethylene terephthalate resin, polybutylene terephthalate resin, polyphenylene sulfide resin, polyether ether ketone resin and the like can be mentioned. As preferable crystalline resins, polyamide resin, polyethylene terephthalate resin, polybutylene terephthalate resin and polyphenylene sulfide resin can be mentioned; particularly in polyamide resin, the effect of the present invention is remarkable. These crystalline resins can be used singly or in combination of two kinds or more.

Also, in the present invention, a copolymer or mixture mainly comprising a polymer that constitutes these crystalline resins; a thermoplastic resin comprising an elastomer, such as a rubber or a rubber-like resin, formulated in these crystalline resins; a polymer alloy containing these crystalline resins at 10% by weight or more, and the like can also be used as crystalline resins. Copolymers of two kinds or more thereof, for example, polyamide 6/66, polyamide 6/66/610, polyamide 6/66/11/12 and the like, can also be used. Also, the crystalline resin used in the present invention may be an alloy comprising two kinds or more of synthetic resins mixed. As examples of such alloys, polyamide/polyester alloy, polyamide/polyphenylene oxide alloy, polyamide/polycarbonate alloy, polyamide/polyolefin alloy, polyamide/polystyrene/acrylonitrile alloy, polyamide/acrylic acid ester alloy, polyamide/silicon alloy and the like can be mentioned.

As specific examples of the above-described polyamide resin (nylon), polyamide 6 resin, polyamide 11 resin, polyamide 12 resin, polyamide 46 resin, polyamide 66 resin, polyamide 69 resin, polyamide 610 resin, polyamide 612 resin, polyamide 96 resin, polyamide MXD6 resin, polyamide RIM resin and the like can be mentioned.

The crystalline resin composition of the present invention may be formulated with various additives, in order to confer a desired characteristic according to the purpose thereof. As examples of such additives, colorants, crystal nucleating agents, mold-releasing agents, lubricants, dispersing agents, fillers, stabilizers, plasticizers, modifiers, ultraviolet absorbents or optical stabilizers, antioxidants, antistatic agents, flame retardants, elastomers for improving impact resistance, and the like can be mentioned.

The fibrous reinforcing material is not subject to limitation; any one usable as a reinforcing material for conventional synthetic resins can be used appropriately according to the intended use and purpose thereof. As examples of such fibrous reinforcing materials, glass fiber, carbon fiber and various organic fibers can be mentioned. For example, in the case of glass fiber, the content thereof is preferably 5 to 120 parts by weight per 100 parts by weight of a crystalline resin. If the content is less than 5 parts by weight, a sufficient glass fiber reinforcing effect is difficult to obtain; if the content exceeds 120 parts by weight, the moldability is likely to decrease. Preferably, the content is 10 to 60 parts by weight, particularly preferably 20 to 50 parts by weight.

As the aforementioned colorant, inorganic pigments, organic pigments or organic dyes and the like can be used. As specific examples of usable colorants, inorganic or organic pigments such as carbon black, quinophthalone, Hansa Yellow, Rhodamine 6G Lake, quinacridone, Rose Bengale, copper Phthalocyanine Blue and copper Phthalocyanine Green, various oil-soluble dyes or disperse dyes such as azo dyes, quinophthalone dyes, anthraquinone dyes, xanthene dyes, triphenylmethane dyes and phthalocyanine dyes, and dyes and pigments modified with higher fatty acids, synthetic resins or the like, and the like can be mentioned. By combining the colorless or light-colored nucleating-effect-suppressor of the present invention and various chromatic organic pigments, a full-color molded product with appropriate light fastness and heat resistance and good appearance and gloss is obtained.

As the aforementioned the crystal nucleating agent, inorganic microparticles such as mica, talc, kaolin, wollastonite, silica and graphite, inorganic fibers such as glass fiber and carbon fiber (those commonly used in crystalline resins can be used, not subject to limitation concerning fiber diameter and length), metal oxides such as magnesium oxide and aluminum oxide, and the like can be mentioned.

As examples of the mold releasing agent or lubricant, carboxylic acids such as stearic acid, palmitic acid and montanic acid, amides such as ethylene bis-stearylamide and methylene bis-stearylamide, carboxylic acid esters such as octyl stearate, stearic glyceride and montanic acid ester, carboxylic acid metal salts such as calcium stearate, aluminum stearate, barium stearate and partially saponified calcium salt of montanic acid ester, alcohols such as stearyl alcohol, waxes such as polyethylene wax and polyethylene oxide can be mentioned.

As examples of the ultraviolet absorbent or optical stabilizer, benzotriazole compounds, benzophenone compounds, salicylate compounds, cyanoacrylate compounds, benzoate compounds, oxalide compounds, hindered amine compounds, nickel complex salts and the like can be mentioned.

As examples of the flame retardant, halogen-containing compounds such as tetrabromobisphenol A derivatives, hexabromodiphenyl ether and tetrabromophthalic anhydride; phosphorus-containing compounds such as triphenyl phosphate, triphenyl phosphite, red phosphorus and ammonium polyphosphate; nitrogen-containing compounds such as urea and guanidine; silicon-containing compounds such as silicon oil, organic silane and aluminum silicate; antimony compounds such as antimony trioxide and antimony phosphate; and the like can be mentioned.

The crystalline resin composition of the present invention can be obtained by formulating raw materials using an optionally chosen method of formulation. It is usually preferable that these ingredients are homogenized to the maximum possible extent. Specifically, for example, by blending and homogenizing all raw materials in a mechanical mixer such as a blender, a kneader, a Banbury mixer, a roll mixer or an extruder, a crystalline resin composition can be obtained, or by blending some raw materials in a mechanical mixer and thereafter adding the remaining ingredients and further blending and homogenizing the raw materials, a crystalline resin composition can also be obtained. Also, previously dry-blended raw materials may be kneaded and homogenized in a molten state in a heated extruder, then extruded into a needle, which needle is then cut into desired length to yield a colored granular product (colored pellets). Also, a desired master batch can be obtained by an optionally chosen method using the crystalline resin composition of the present invention.

Molding of the crystalline resin composition of the present invention can be conducted by various procedures in common use. For example, pellets of the crystalline resin composition can be molded using a processing machine such as an extruder, an injection molding machine or a roll mill. Also, the crystalline resin composition of the present invention can also be molded by blending crystalline resin pellets or powder, a milled colorant, and where necessary various additives, in an appropriate mixer, and molding this blend using a processing machine. It is also possible, for example, that a blend of a colorant and a monomer containing an appropriated polymerization catalyst is polymerized to obtain a desired crystalline resin and then the desired crystalline resin is molded by an appropriate method. As examples of the method of molding, any commonly used method of molding, such as injection molding, extrusion molding, compression molding, foaming molding, blow molding, vacuum molding, injection blow molding, rotation molding and calender molding, can be adopted.

According to the nucleating-effect-suppressor of the present invention and the method of the present invention of controlling the crystallization of a crystalline resin composition, the action of a nucleating agent can be suppressed by lowering the crystallization temperature and crystallization rate of the crystalline resin. When a colorant, a fibrous reinforcing material or another additive that acts as a nucleating agent to cause a rise of crystallization temperature and a reduction in the surface gloss/appearance of the molded product is contained in the crystalline resin composition, because their actions as nucleating agents can be suppressed by using the nucleating-effect-suppressor of the present invention or the method of the present invention of controlling the crystallization of a crystalline resin composition, the range of acceptance of crystalline resin composition design broadens and it becomes possible to adapt to a wide range of applications. Also, because the nucleating-effect-suppressor in the present invention is colorless, light-colored or otherwise variously colored, the range of acceptance in color design in coloring the crystalline resin is broad.

Referring to the crystalline resin composition of the present invention, the crystallization temperature falls (by, for example, 4° C. or more) compared to the original crystalline resin, which does not contain a nucleating-effect-suppressor, and the crystallization rate falls. Hence, because the shrinkage of the molded product due to cooling decreases so that molding dimensional accuracy improves, and also because the anisotropy of the strength of the molded product decreases favorably so that excellent dimensional stability during heating is exhibited, the crystalline resin composition of the present invention is extremely effective in manufacturing a precise molded product under rigorous requirements of dimensional accuracy. Also, because the temperature of the mold for molding can be lowered during molding, the molded product cooling time can be shortened and mold temperature adjustment is facilitated, so that mold temperature adjustment equipment costs can be reduced and molding of a large molded product can be conducted with relatively small equipment. Also, because the nucleating-effect-suppressor contained in the crystalline resin composition of the present invention is colorless, light-colored or otherwise variously colored, the range of acceptance in color design in coloring the crystalline resin composition is broad.

### EXAMPLES

Next, the present invention is specifically described by means of examples; however, of course, the present invention is not limited to these examples. Note that in the description below, “part(s) by weight” is abbreviated as “part(s)”. Preparation of measuring samples and measurement of ΔT⁰_{C} of control sample (sample of polyamide 66 alone) 150 g of polyamide 66 (manufactured by Du Pont, trade name: Zytel 101L) was admixed with 1160 g of 2,2,2-trifluoroethanol, and dissolved with heating (about 70° C.). This solution was filtered through Kiriyama filter paper No. 5A while remaining hot. After the filtrate was dissolved in 3 liters of chloroform, 1 liter of methanol was added to it to gelatinize the filtrate. After this gel was filtered through Kiriyama filter paper No. 5A while remaining hot, it was dispersed in 3 liters of methanol. A powder obtained by filtering this dispersion was vacuum-dried at 70° C. for 15 hours or longer to yield purified polyamide 66.

100 parts of the purified polyamide 66 (crystalline resin) and 10 to 30 parts (10 parts, unless otherwise specified) of the nucleating-effect-suppressor of the present invention (example compounds shown in the individual tables below) or a comparative example compound were dissolved in 2,2,2-trifluoroethanol with heating. This was placed in a petri dish, allowed to stand at room temperature to evaporate the 2,2,2-trifluoroethanol, and then it was dried using a vacuum dryer at 70° C. for 15 hours or longer to yield a measuring sample. In the case of example compounds or comparative example compounds that do not dissolve in 2,2,2-trifluoroethanol with heating, samples for measuring were prepared as described below.

100 parts of the purified polyamide 66 and 10 to 30 parts of an example compound or a comparative example compound were added to 2,2,2-trifluoroethanol and heated to dissolve the polyamide 66. Said compound was dispersed using ultrasonic wave, tetrahydrofuran was then added to make a gel-like dispersion, and this dispersion was placed in a petri dish and allowed to stand at room temperature to evaporate the 2,2,2-trifluoroethanol and tetrahydrofuran. Subsequently, the dispersion was dried using a vacuum dryer at 70° C. for 15 hours or longer to yield a measuring sample.

For control, the purified polyamide 66 alone was dissolved in 2,2,2-trifluoroethanol with heating and thereafter placed in a petri dish and allowed to stand at room temperature. After the 2,2,2-trifluoroethanol was evaporated, the obtained solid was dried using a vacuum dryer at 70° C. for 15 hours or longer to yield a control sample.

In the present specification, the above-described sample preparation treatment is referred to as the cast method; in the Examples and Comparative Examples below, samples were prepared using this method.

For each measuring sample and control sample, the crystallization temperature (T_{CP}), extrapolated crystallization initiation temperature (T_{CIP}) and extrapolated crystallization end temperature (T_{CEP}) were measured using a differential scanning calorimeter (manufactured by SEIKO INSTRUMENTS INC., trade name: DSC6200, COOLING CONTROLLER). In this thermal analysis, a cycle of heating from 20° C. to 300° C. at 20° C./min, maintaining 300° C. for 3 minutes, and then cooling from 300° C. to 20° C. at 10° C./min, was repeated five times. From the measurement data of extrapolated crystallization initiation temperature (T_{CIP}) and extrapolated crystallization end temperature (T_{CEP}) obtained for each measuring sample, the crystallization temperature range (ΔT_{C}) [difference between extrapolated crystallization end temperature and extrapolated crystallization initiation temperature] was calculated. Measurement results (for all numerical values, the unit is ° C.) are shown in Table 1 to Table 20. The measured values of T_{CP}, T_{CIP}, T_{CEP} and ΔT_{C} for each example compound and each comparative example compound, shown in Table 1 to Table 20, were obtained as described above.

Likewise, for the control sample, the crystallization temperature (T⁰_{CP}), extrapolated crystallization initiation temperature (T⁰_{CIP}) and extrapolated crystallization end temperature (T⁰_{CEP}) were measured, and the crystallization temperature range (ΔT⁰_{C}) was calculated.

Crystallization temperature falls were judged by ΔT_{CP} (ΔT_{CP}=T⁰_{CP}−T_{CP}) and crystallization rate falls were judged by comparing ΔT_{C} and ΔT⁰_{C} (ΔΔT_{C}=T_{C}−T⁰_{C}).

The crystallization temperature (T_{CP}) was determined using the mean of four values from the second to fifth measurements, out of measured values obtained by repeating heating and cooling using the differential scanning calorimeter. The extrapolated crystallization initiation temperature (T_{CIP}) and extrapolated crystallization end temperature (T_{CEP}) were determined using the mean of values from the aforementioned second to fifth measurements at the time of each cooling measurement.

For the control sample, the crystallization temperature (T⁰_{CP}), extrapolated crystallization initiation temperature (T⁰_{CIP}) and extrapolated crystallization end temperature (T⁰_{CEP}) were determined in the same manner as the aforementioned one, as described below.
T⁰_{CP}=232.8° C.
T⁰_{CIP}=236.0° C.
T⁰_{CEP}=226.5° C.
ΔT⁰_{C}=9.5° C.

Examples 1 to 56 pertain to Example Compounds 1 to 56, and Example Compounds 1 to 56 contain a molecular structure similar to the molecular structures of Comparative Example Compounds 1 to 20 in Comparative Examples 1 to 20. Comparison between these example compounds and comparative example compounds in terms of falls in crystallization temperature and crystallization rate demonstrates the effectiveness of the nucleating-effect-suppressor of the present invention.

### Examples 1 to 20 and Comparative Examples 1 and 2

By Examples 1 to 20 and Comparative Examples 1 and 2, aminonaphthalene structures were comparatively investigated. The structures of the individual example compounds and the individual comparative example compounds are as follows.

TABLE 1

| Example | Example Compound | Basic Structure | T_{CP} | Δ T_{CP} | T_{CIP} | T_{CEP} | Δ T_{C} | Δ Δ T_{C} |
|---|---|---|---|---|---|---|---|---|
| Comparative | Comparative Example | | 232.2 | 0.6 | 235.2 | 226.8 | 8.4 | −1.1 |
| Example 1 | Compound1 | | | | | | | |
| Example 1 | Example Compound1 | Basic Structure24 | 218.5 | 14.3 | 225.2 | 211.6 | 13.6 | 4.1 |
| Example 2 | Example Compound2 | Basic Structure61 | 218.6 | 14.2 | 227.3 | 211.5 | 15.8 | 6.3 |
| Example 3 | Example Compound3 | Basic Structure76 | 223.6 | 9.2 | 230.2 | 217.7 | 12.5 | 3.0 |
| Example 4 | Example Compound4 | Basic Structure85 | 225.6 | 7.2 | 231.6 | 219.8 | 11.8 | 2.3 |
| Comparative | Comparative Example | | 232.0 | 0.8 | 235.4 | 227.2 | 8.2 | −1.3 |
| Example 2 | Compound2 | | | | | | | |
| Example 5 | Example Compound5 | Basic Structure1 | 227.7 | 5.1 | 232.3 | 220.6 | 11.7 | 2.2 |
| Example 6 | Example Compound6 | Basic Structure9 | 227.3 | 5.5 | 233.0 | 221.4 | 11.6 | 2.1 |
| Example 7 | Example Compound7 | Basic Structure10 | 227.6 | 5.2 | 232.1 | 220.2 | 11.9 | 2.4 |
| Example 8 | Example Compound8 | Basic Structure11 | 227.5 | 5.3 | 232.4 | 220.8 | 11.6 | 2.1 |
| Example 9 | Example Compound9 | Basic Structure24 | 219.3 | 13.5 | 226.7 | 211.0 | 15.7 | 6.2 |
| Example 10 | Example Compound10 | Basic Structure41 | 218.4 | 14.4 | 227.1 | 211.8 | 15.3 | 5.8 |
| Example 11 | Example Compound11 | Basic Structure90 | 224.7 | 8.1 | 230.1 | 217.0 | 13.1 | 3.6 |
| Example 12 | Example Compound12 | Basic Structure91 | 223.9 | 8.9 | 229.1 | 216.7 | 12.4 | 2.9 |
| Example 13 | Example Compound13 | Basic Structure64 | 224.3 | 8.5 | 229.7 | 216.3 | 13.4 | 3.9 |
| Example 14 | Example Compound14 | Basic Structure70 | 216.8 | 16.0 | 225.4 | 209.2 | 16.2 | 6.7 |
| Example 15 | Example Compound15 | Basic Structure76 | 219.9 | 12.9 | 229.1 | 212.9 | 16.2 | 6.7 |
| Example 16 | Example Compound16 | Basic Structure84 | 222.3 | 10.5 | 232.0 | 215.9 | 16.1 | 6.6 |
| Example 17 | Example Compound17 | Basic Structure79 | 221.6 | 11.2 | 228.0 | 215.4 | 12.6 | 3.1 |
| Example 18 | Example Compound18 | Basic Structure82 | 222.2 | 10.6 | 228.3 | 215.2 | 13.1 | 3.6 |
| Example 19 | Example Compound19 | Basic Structure91 | 225.1 | 7.7 | 231.6 | 219.3 | 12.3 | 2.8 |
| Example 20 | Example Compound20 | Basic Structure93 | 223.2 | 9.6 | 229.1 | 216.4 | 12.7 | 3.2 |

Unit: ° C.

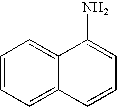

(Comparative Example Compound 1)

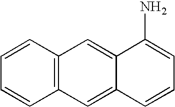

(Example Compound 1)

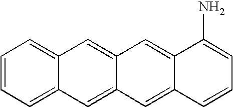

(Example Compound 2)

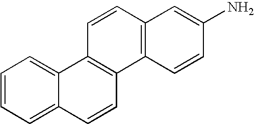

(Example Compound 3)

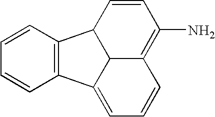

(Example Compound 4)

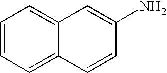

(Comparative Example Compound 2)

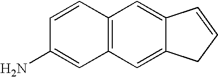

(Example Compound 5)

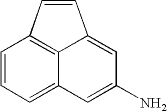

(Example Compound 6)

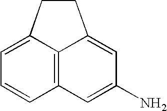

(Example Compound 7)

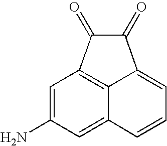

(Example Compound 8)

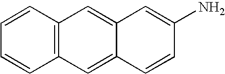

(Example Compound 9)

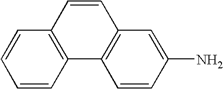

(Example Compound 10)

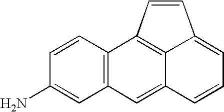

(Example Compound 11)

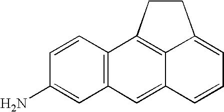

(Example Compound 12)

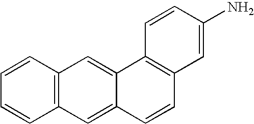

(Example Compound 13)

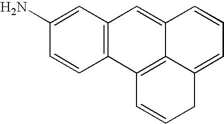

(Example Compound 14)

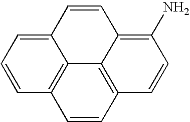

(Example Compound 15)

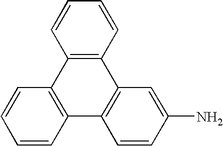

(Example Compound 16)

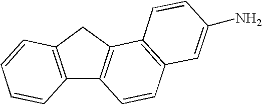

(Example Compound 17)

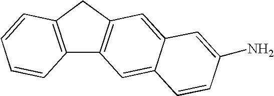

(Example Compound 18)

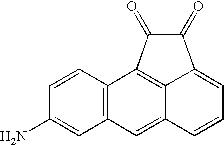

(Example Compound 19)

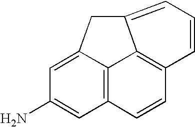

(Example Compound 20)

### Comparative Investigation of Examples 1 to 4 and Comparative Example 1

Examples 1 to 4 are compounds having a polycyclic structure wherein a total of three or four 6-membered rings or 5-membered and 6-membered rings are condensed to form condensed ring, and containing a 1-aminonaphthalene structure in a portion thereof.

The crystallization temperature (T⁰_{CP}) of polyamide 66 (control: original crystalline resin) is 232.8° C., and the crystallization temperature falls (ΔT_{CP}) in Examples 1 to 4 are +7.2 to +14.3° C.; significant falls in the crystallization temperature are observed.

Also, the crystallization temperature ranges (ΔT_{C}) of Examples 1 to 4 expanded by +2.3 to +6.3° C. compared to the crystallization temperature range (ΔT⁰_{C}) of 9.5° C. of polyamide 66 (control: original crystalline resin), showing that the crystallization rate fell. It is also shown that the extrapolated crystallization initiation temperature (T_{CIP}) is lower than that of the original crystalline resin, and that the nucleus induction period lengthened very much. Therefore, the compounds of Examples 1 to 4 possess a remarkable function as a nucleating-effect-suppressor.

On the other hand, the crystallization temperature fall (ΔT_{CP}) of Comparative Example 1 is +0.6° C.; there is almost no change in crystallization temperature. The crystallization temperature range (ΔT_{C}) is −1.1° C. compared to the control (original crystalline resin), and the crystallization rate rose slightly. Therefore, the compound of Comparative Example 1 does not possess a function as a nucleating-effect-suppressor, and rather works as a nucleating agent.

As stated above, it is found that the compounds having a polycyclic structure wherein a total of three or four 6-membered rings or 5-membered and 6-membered rings are condensed to form condensed ring possess a function of nucleation suppressing effect, and that the compounds wherein a total of two 6-membered rings are condensed to form condensed ring do not possess a function of a nucleating-effect-suppressor.

### Comparative Investigation of Examples 5 to 20 and Comparative Example 2

Examples 5 to 20 are compounds having a polycyclic structure wherein a total of three or four 6-membered rings or 5-membered and 6-membered rings are condensed to form condensed ring, and containing a 2-aminonaphthalene structure in a portion thereof.

The crystallization temperature (T⁰_{CP}) of polyamide 66 (control: original crystalline resin) is 232.8° C., and the crystallization temperature falls (ΔT_{CP}) in Examples 5 to 20 are +5.1 to +16.0° C.; the crystallization temperature fell significantly.

Also, the crystallization temperature ranges (ΔT_{C}) of Examples 5 to 20 expanded by +2.1 to +6.7° C. (ΔΔT_{C}) compared to the crystallization temperature range (ΔT⁰_{C}) of 9.5° C. of polyamide 66 (control: original crystalline resin), showing that the crystallization rate fell. It is also shown that the extrapolated crystallization initiation temperature (T_{CIP}) is lower than that of the original crystalline resin, and that the nucleus induction period lengthened very much. Therefore, the compounds of Examples 5 to 20 possess a remarkable function as a nucleating-effect-suppressor.

On the other hand, the crystallization temperature fall (ΔT_{CP}) of Comparative Example 2 is +0.8° C.; there is almost no change in crystallization temperature. The crystallization temperature range (ΔT_{C}) is −1.3° C. (ΔΔT_{C}) compared to the control (original crystalline resin), and the crystallization rate rose slightly. Therefore, the compound of Comparative Example 2 does not possess a function as a nucleating-effect-suppressor, and rather works as a nucleating agent.

As stated above, the compounds having a polycyclic structure wherein a total of three or four 6-membered rings or 5-membered and 6-membered rings are condensed to form condensed ring possess a function of nucleation suppressing effect, and the compounds wherein a total of two 6-membered rings are condensed to form condensed ring do not possess a function of a nucleating-effect-suppressor.

### Examples 21 and 22 and Comparative Examples 3 and 4

By Examples 21 and 22 and Comparative Examples 3 and 4, methylcarbonaphthalene structures were comparatively investigated. The structures of the individual example compounds and the individual comparative example compounds are as follows.

TABLE 2

| Example | Example Compound | Basic Structure | T_{CP} | Δ T_{CP} | T_{CIP} | T_{CEP} | Δ T_{C} | Δ Δ T_{C} |
|---|---|---|---|---|---|---|---|---|
| Comparative | Comparative Example | | 231.7 | 1.8 | 235.6 | 225.6 | 9.0 | −0.5 |
| Example 3 | Compound3 | | | | | | | |
| Comparative | Comparative Example | | 231.8 | 1.0 | 234.7 | 226.2 | 8.5 | −1.0 |
| Example 4 | Compound4 | | | | | | | |
| Example 21 | Example Compound21 | Basic Structure39 | 223.7 | 9.2 | 229.1 | 215.6 | 13.5 | 4.0 |
| Example 22 | Example Compound22 | Basic Structure76 | 214.7 | 18.1 | 230.1 | 215.7 | 14.5 | 5.0 |

Unit: ° C.

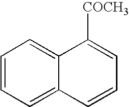

(Comparative Example Compound 3)

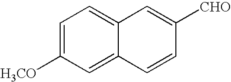

(Comparative Example Compound 4)

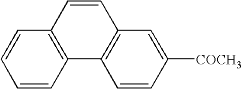

(Example Compound 21)

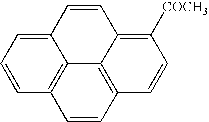

(Example Compound 22)

Examples 21 and 22 are compounds having a polycyclic structure wherein a total of three or four 6-membered rings are condensed to form condensed ring, and containing a methylcarbonaphthalene structure in a portion thereof.

The crystallization temperature (T⁰_{CP}) of polyamide 66 (control: original crystalline resin) is 232.8° C., and the crystallization temperature falls (ΔT_{CP}) in Examples 21 and 22 are +9.2 and +18.1° C.; the crystallization temperature fell significantly.

Also, the crystallization temperature ranges (ΔT_{C}) of Examples 21 and 22 expanded by +4.0 and +5.0° C. (ΔΔT_{C}) compared to the crystallization temperature range (ΔT⁰_{C}) of 9.5° C. of polyamide 66 (control: original crystalline resin), showing that the crystallization rate fell. It is also shown that the extrapolated crystallization initiation temperature (T_{CIP}) is lower than that of the original crystalline resin, and that the nucleus induction period lengthened very much. Therefore, the compounds of Examples 21 and 22 possess a remarkable function as a nucleating-effect-suppressor.

On the other hand, the crystallization temperature falls (ΔT_{CP}) of Comparative Examples 3 and 4 are +1.8 and +1.0° C.; there is almost no change in crystallization temperature. The crystallization temperature ranges (ΔT_{C}) are −0.5 and −1.0° C. (ΔΔT_{C}) compared to the control (original crystalline resin), and the crystallization rate rose slightly. Therefore, the compounds of Comparative Examples 3 and 4 do not possess a function as a nucleating-effect-suppressor, and rather work as a nucleating agent.

As stated above, the compounds having a polycyclic structure wherein a total of three or four 6-membered rings are condensed to form condensed ring possess a function of nucleation suppressing effect, whereas the compounds wherein a total of two 6-membered rings are condensed to form condensed ring do not possess a function of a nucleating-effect-suppressor.

### Examples 23 to 29 and Comparative Examples 5 to 7

By Examples 23 to 29 and Comparative Examples 5 to 7, chromone (1-benzopyran-4(4H)-one) structures were comparatively investigated. The structures of the individual example compounds and the individual comparative example compounds are as follows.

TABLE 3

| Example | Example Compound | Basic Structure | T_{CP} | Δ T_{CP} | T_{CIP} | T_{CEP} | Δ T_{C} | Δ Δ T_{C} |
|---|---|---|---|---|---|---|---|---|
| Comparative | Comparative Example | | 231.1 | 1.7 | 234.3 | 225.1 | 9.2 | −0.3 |
| Example 5 | Compound5 | | | | | | | |
| Comparative | Comparative Example | | 230.9 | 2.0 | 233.7 | 223.7 | 10.0 | 0.5 |
| Example 6 | Compound6 | | | | | | | |
| Comparative | Comparative Example | | 230.8 | 2.0 | 234.5 | 224.6 | 9.9 | 0.4 |
| Example 7 | Compound7 | | | | | | | |
| Example 23 | Example Compound23 | Basic Structure2 | 227.4 | 5.4 | 232.6 | 219.7 | 12.9 | 3.4 |
| Example 24 | Example Compound24 | Basic Structure25 | 224.7 | 8.1 | 228.9 | 216.5 | 12.4 | 2.9 |
| Example 25 | Example Compound25 | Basic Structure25 | 227.0 | 5.8 | 231.2 | 219.1 | 12.1 | 2.6 |
| Example 26 | Example Compound26 | Basic Structure29 | 227.0 | 5.8 | 231.8 | 219.9 | 11.9 | 2.4 |
| Example 27 | Example Compound27 | Basic Structure41 | 224.2 | 8.6 | 230.7 | 218.4 | 12.3 | 2.8 |
| Example 28 | Example Compound28 | Basic Structure42 | 227.7 | 5.1 | 232.2 | 220.7 | 11.5 | 2.0 |
| Example 29 | Example Compound29 | Basic Structure42 | 220.9 | 11.9 | 229.5 | 213.4 | 16.1 | 6.6 |

Unit: ° C.

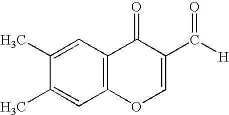

(Comparative Example Compound 5)

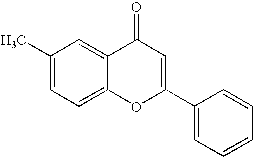

(Comparative Example Compound 6)

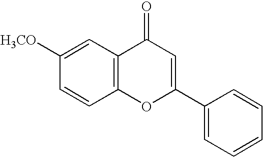

(Comparative Example Compound 7)

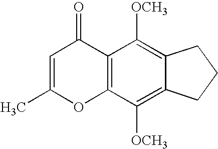

(Example Compound 23)

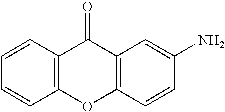

(Example Compound 24)

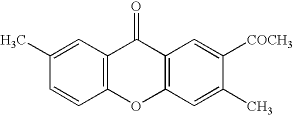

(Example Compound 25)

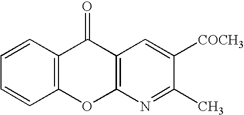

(Example Compound 26)

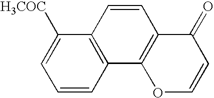

(Example Compound 27)

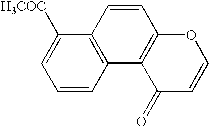

(Example Compound 28)

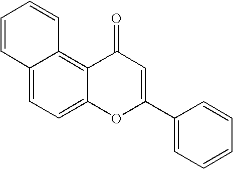

(Example Compound 29)

Examples 23 to 29 are compounds having a polycyclic structure wherein a total of three 6-membered rings or 5-membered and 6-membered rings are condensed to form condensed ring, and containing a chromone (1-benzopyran-4(4H)-one) structure in a portion thereof.

The crystallization temperature (T⁰_{CP}) of polyamide 66 (control: original crystalline resin) is 232.8° C., and the crystallization temperature falls (ΔT_{CP}) in Examples 23 to 29 are +5.1 to +11.9° C.; the crystallization temperature fell significantly.

Also, the crystallization temperature ranges (ΔT_{C}) of Examples 23 to 29 expanded by +2.0 to +6.6° C. (ΔΔT_{C}) compared to the crystallization temperature range (ΔT⁰_{C}) of 9.5° C. of polyamide 66 (control: original crystalline resin), showing that the crystallization rate fell significantly. It is also shown that the extrapolated crystallization initiation temperature (T_{CIP}) is lower than that of the original crystalline resin, and that the nucleus induction period lengthened very much. Therefore, the compounds of Examples 23 to 29 possess a remarkable function as a nucleating-effect-suppressor.

On the other hand, the crystallization temperature falls (ΔT_{CP}) of Comparative Examples 5 to 7 are +2.0 to +1.7° C.; there is almost no change in crystallization temperature. The crystallization temperature ranges (ΔT_{C}) are −0.3 to +0.5° C. (ΔΔT_{C}) compared to the control (original crystalline resin), and the crystallization rate remained almost unchanged or rose slightly. Therefore, the compounds of Comparative Examples 5 to 7 do not possess a function as a nucleating-effect-suppressor, and rather work as a nucleating agent.

As stated above, the compounds having a polycyclic structure wherein a total of three 6-membered rings or 5-membered and 6-membered rings are condensed to form condensed ring possess a function of nucleation suppressing effect, and the compounds wherein a total of two 6-membered rings are condensed to form condensed ring do not possess a function of a nucleating-effect-suppressor.

### Comparative Examples 8 to 10 and Examples 30 to 33

By Examples 1 to 20 and Comparative Examples 8 to 10 and 2, coumarin structures were comparatively investigated. The structures of the individual example compounds and the individual comparative example compounds are as follows.

TABLE 4

| Example | Example Compound | Basic Structure | T_{CP} | Δ T_{CP} | T_{CIP} | T_{CEP} | Δ T_{C} | Δ Δ T_{C} |
|---|---|---|---|---|---|---|---|---|
| Comparative | Comparative Example | | 231.7 | 1.1 | 235.0 | 226.1 | 8.9 | −0.6 |
| Example 8 | Compound8 | | | | | | | |
| Comparative | Comparative Example | | 230.9 | 1.9 | 234.0 | 224.7 | 9.3 | −0.2 |
| Example 9 | Compound9 | | | | | | | |
| Comparative | Comparative Example | | 230.7 | 2.1 | 233.9 | 224.0 | 10.0 | 0.5 |
| Example 10 | Compound10 | | | | | | | |
| Example 30 | Example Compound30 | Basic Structure3 | 226.3 | 6.5 | 230.4 | 218.2 | 12.2 | 2.7 |
| Example 31 | Example Compound31 | | 224.0 | 8.8 | 230.8 | 219.0 | 11.8 | 2.3 |
| Example 32 | Example Compound32 | Basic Structure43 | 223.5 | 9.3 | 231.3 | 218.2 | 13.1 | 3.6 |
| Example 33 | Example Compound33 | Basic Structure73 | 224.0 | 8.8 | 230.6 | 218.0 | 12.6 | 3.1 |

Unit: ° C.

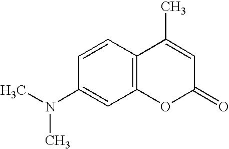

(Comparative Example Compound 8)

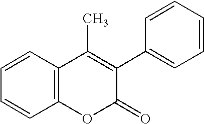

(Comparative Example Compound 9)

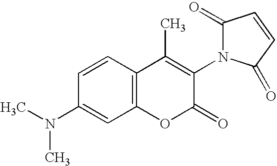

(Comparative Example Compound 10)

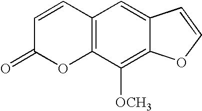

(Example Compound 30)

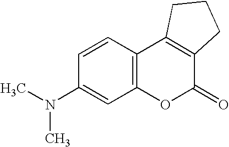

(Example Compound 31)

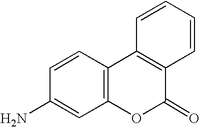

(Example Compound 32)

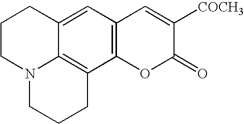

(Example Compound 33)

Examples 30 to 33 are compounds having a polycyclic structure wherein a total of three or four 6-membered rings or 5-membered and 6-membered rings are condensed to form condensed ring, and containing a coumarin structure in a portion thereof.

The crystallization temperature (T⁰_{CP}) of polyamide 66 (control: original crystalline resin) is 232.8° C., and the crystallization temperature falls (ΔT_{CP}) in Examples 30 to 33 are +9.3 to +6.5° C.; the crystallization temperature fell significantly.

Also, the crystallization temperature ranges (ΔT_{C}) of Examples 30 to 33 expanded by +2.3 to +3.6° C. (ΔΔT_{C}) compared to the crystallization temperature range (ΔT⁰_{C}) of 9.5° C. of polyamide 66 (control: original crystalline resin), showing that the crystallization rate fell significantly. It is also shown that the extrapolated crystallization initiation temperature (T_{CIP}) is lower than that of the original crystalline resin, and that the nucleus induction period lengthened very much. Therefore, the compounds of Examples 30 to 33 possess a remarkable function as a nucleating-effect-suppressor.

On the other hand, the crystallization temperature fall (ΔT_{CP}) of Comparative Example 8 is +1.1° C.; there is almost no change in crystallization temperature. The crystallization temperature range (ΔT_{C}) is −0.6° C. compared to the control (original crystalline resin), and the crystallization rate rose slightly. Therefore, the compound of Comparative Example 8 does not possess a function as a nucleating-effect-suppressor, and rather works as a nucleating agent.

As stated above, the compounds having a polycyclic structure wherein a total of three or four 6-membered rings or 5-membered and 6-membered rings are condensed to form condensed ring possess a function of nucleation suppressing effect, and the compounds having a polycyclic structure wherein a total of two 6-membered rings are condensed to form condensed ring do not possess a function of a nucleating-effect-suppressor.

Also, Comparative Examples 9 and 10 are compounds wherein 5-membered rings or 6-membered rings are linked to coumarin via single bonds.

The crystallization temperature falls (ΔT_{CP}) of Comparative Examples 9 and 10 are +1.9 and +2.1° C.; there is almost no change in crystallization temperature. The crystallization temperature ranges (ΔT_{C}) are −0.2 and +0.5° C. (ΔΔT_{C}) compared to the control (original crystalline resin), there is almost no change in crystallization rate. Therefore, the compounds of Comparative Examples 9 and 10 do not possess a function as a nucleating-effect-suppressor.

As stated above, it is found that even when the total number of 5-membered or higher rings is three, the compounds wherein the total number of rings has become three as rings such as aromatic rings or heterocyclic rings, for example, are linked via single bonds, like Comparative Examples 9 and 10, do not possess a function as a nucleating-effect-suppressor.

Also, as shown in Examples 31 and 33, even compounds having an alicyclic structure in the structures thereof possess a function as a nucleating-effect-suppressor.

### Examples 34 to 45 and Comparative Examples 11 to 13

By Examples 34 to 45 and Comparative Examples 11 to 13, quinoline structures were comparatively investigated. The structures of the individual example compounds and the individual comparative example compounds are as follows.

TABLE 5

| Example | Example Compound | Basic Structure | T_{CP} | Δ T_{CP} | T_{CIP} | T_{CEP} | Δ T_{C} | Δ Δ T_{C} |
|---|---|---|---|---|---|---|---|---|
| Comparative | Comparative Example | | 230.9 | 1.9 | 234.2 | 225.5 | 8.7 | −0.8 |
| Example 11 | Compound11 | | | | | | | |
| Example 34 | Example Compound34 | Basic Structure34 | 219.7 | 13.1 | 228.7 | 212.7 | 16.0 | 6.5 |
| Example 35 | Example Compound35 | Basic Structure46 | 222.5 | 10.3 | 228.3 | 215.1 | 13.2 | 3.7 |
| Comparative | Comparative Example | | 231.6 | 1.2 | 235.2 | 225.8 | 9.4 | −0.1 |
| Example 12 | Compound12 | | | | | | | |
| Example 36 | Example Compound36 | Basic Structure47 | 213.2 | 19.7 | 225.4 | 204.9 | 20.5 | 11.0 |
| Example 37 | Example Compound37 | Basic Structure47 | 225.5 | 7.3 | 230.8 | 218.4 | 12.4 | 2.9 |
| Example 38 | Example Compound38 | Basic Structure47 | 228.6 | 4.3 | 233.1 | 221.2 | 11.9 | 2.4 |
| Example 39 | Example Compound39 | Basic Structure47 | 225.7 | 7.1 | 231.9 | 218.5 | 13.4 | 3.9 |
| Example 40 | Example Compound40 | Basic Structure47 | 221.1 | 11.8 | 229.0 | 212.1 | 17.0 | 7.5 |
| Example 41 | Example Compound41 | Basic Structure47 | 215.9 | 16.9 | 225.8 | 207.8 | 18.0 | 8.5 |
| Example 42 | Example Compound42 | Basic Structure48 | 225.6 | 7.2 | 230.5 | 218.5 | 12.0 | 2.5 |
| Example 43 | Example Compound43 | Basic Structure49 | 223.4 | 9.4 | 229.7 | 215.6 | 14.1 | 4.6 |
| Example 44 | Example Compound44 | Basic Structure69 | 218.3 | 14.5 | 226.8 | 211.8 | 15.0 | 5.5 |
| Comparative | Comparative Example | | 231.9 | 0.9 | 235.2 | 225.5 | 9.8 | 0.3 |
| Example 13 | Compound13 | | | | | | | |
| Example 45 | Example Compound45 | Basic Structure111 | 224.7 | 8.1 | 231.1 | 215.5 | 15.6 | 6.1 |

Unit: ° C.

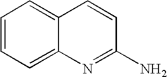

(Comparative Example Compound 11)

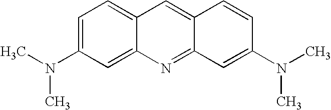

(Example Compound 34)

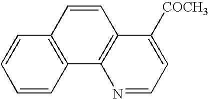

(Example Compound 35)

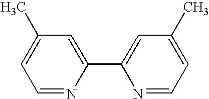

(Comparative Example Compound 12)

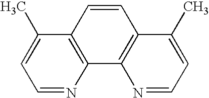

(Example Compound 36)

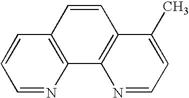

(Example Compound 37)

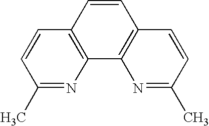

(Example Compound 38)

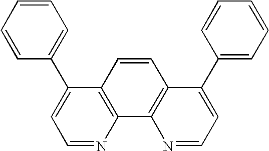

(Example Compound 39)

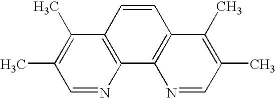

(Example Compound 40)

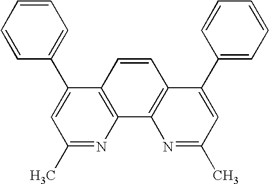

(Example Compound 41)

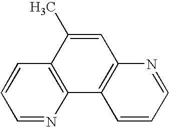

(Example Compound 42)

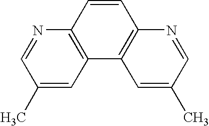

(Example Compound 43)

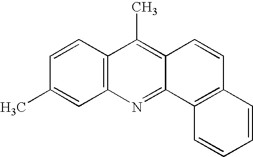

(Example Compound 44)

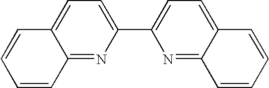

(Comparative Example Compound 13)

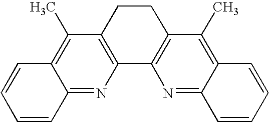

(Example Compound 45)

Examples 34 to 45 are compounds having a polycyclic structure wherein a total of three, four or five 6-membered rings are condensed to form condensed ring, and containing a quinoline structure in a portion thereof.

The crystallization temperature (T⁰_{CP}) of polyamide 66 (control: original crystalline resin) is 232.8° C., and the crystallization temperature falls (ΔT_{CP}) in Examples 34 to 45 are +4.3 to +19.7° C.; significant crystallization temperature falls are observed.

Also, the crystallization temperature ranges (ΔT_{C}) of Examples 34 to 45 expanded by +2.5 to +11.0° C. (ΔΔT_{C}) compared to the crystallization temperature range (ΔT⁰_{C}) of 9.5° C. of polyamide 66 (control: original crystalline resin), showing that the crystallization rate fell significantly. It is also shown that the extrapolated crystallization initiation temperature (T_{CIP}) is lower than that of the original crystalline resin, and that the nucleus induction period lengthened very much. Therefore, the compounds of Examples 34 to 45 possess a remarkable function as a nucleating-effect-suppressor.

On the other hand, the crystallization temperature fall (ΔT_{CP}) of Comparative Example 11 is +1.9° C.; there is almost no change in crystallization temperature. The crystallization temperature range (ΔT_{C}) is −0.8, (ΔΔT_{C}) compared to the control (original crystalline resin); the crystallization rate rose slightly. Therefore, the compound of Comparative Example 11 does not possess a function as a nucleating-effect-suppressor, and rather works as a nucleating agent.

As stated above, the compounds having a polycyclic structure wherein a total of three, four or five 6-membered rings are condensed to form condensed ring possess a function of nucleation suppressing effect, whereas the compounds wherein a total of two 6-membered rings are condensed to form condensed ring do not possess a function of a nucleating-effect-suppressor.

The crystallization temperature fall (ΔT_{CP}) of Comparative Example 12 is +1.2° C.; there is almost no change in crystallization temperature. The crystallization temperature range (ΔT_{C}) differed by −0.1° C. (ΔΔT_{C}) from the control (original crystalline resin), and there is no change in crystallization rate. Therefore, the compound of Comparative Example 12 does not possess a function as a nucleating-effect-suppressor.

On the other hand, the compound of Example 36 is a phenanthrolin structure having a polycyclic structure wherein the portion containing the single bond that links two single rings in the compound of Comparative Example 12 is cyclized, and this compound of Example 36 possessed a remarkable function as a nucleating-effect-suppressor. (Example 36 ΔT_{CP}: +19.7° C., ΔΔT_{C}: +11.0° C.; Comparative Example 12ΔT_{CP}: +1.2° C., ΔΔT_{C}: −0.1° C.)

Likewise, the crystallization temperature fall (ΔT_{CP}) of the compound of Comparative Example 13 (2,2′-biquinoline) is +0.9° C.; there is almost no change in crystallization temperature. The crystallization temperature range (ΔT_{C}) is +0.3° C. (ΔΔT_{C}) compared to the control (original crystalline resin), and the crystallization rates are nearly equal. Therefore, the compound of Comparative Example 13 does not possess a function as a nucleating-effect-suppressor.

The compound of Example 45 has a structure wherein the portion containing the single bond that links two ring structures with two 6-membered rings condensed to form condensed ring in the compound of Comparative Example 13 is cyclized, and this compound of Example 45 possessed a function as a nucleating-effect-suppressor. (Example 45ΔT_{CP}: +8.1° C., ΔΔT_{C}: +6.1° C.; Comparative Example 13ΔT_{CP}: +0.9° C., A ΔT_{C}: 0.3° C.)

### Examples 46 to 50 and Comparative Examples 14 to 17

By Examples 46 to 50 and Comparative Examples 14 to 17, maleic anhydride structures were comparatively investigated. The structures of the individual example compounds and the individual comparative example compounds are as follows.

TABLE 6

| Example | Example Compound | Basic Structure | T_{CP} | Δ T_{CP} | T_{CIP} | T_{CEP} | Δ T_{C} | Δ Δ T_{C} |
|---|---|---|---|---|---|---|---|---|
| Comparative | Comparative Example | | 232.3 | 0.5 | 234.6 | 225.0 | 9.6 | 0.1 |
| Example 14 | Compound14 | | | | | | | |
| Comparative | Comparative Example | | 231.0 | 1.8 | 233.8 | 224.2 | 9.6 | 0.1 |
| Example 15 | Compound15 | | | | | | | |
| Example 46 | Example Compound46 | Basic Structure52 | 226.5 | 6.3 | 231.4 | 219.3 | 12.1 | 2.6 |
| Example 47 | Example Compound47 | Basic Structure4 | 227.4 | 5.4 | 232.1 | 220.4 | 11.7 | 2.2 |
| Comparative | Comparative Example | | 233.1 | −0.3 | 235.9 | 227.0 | 8.9 | −0.6 |
| Example 16 | Compound16 | | | | | | | |
| Example 48 | Example Compound48 | Basic Structure53 | 226.9 | 5.9 | 231.1 | 219.5 | 11.6 | 2.1 |
| Example 49 | Example Compound49 | Basic Structure6 | 227.7 | 5.1 | 231.8 | 220.1 | 11.7 | 2.2 |
| Comparative | Comparative Example | | 233.5 | −0.7 | 236.9 | 227.1 | 9.8 | 0.3 |
| Example 17 | Compound17 | | | | | | | |
| Example 50 | Example Compound50 | Basic Structure7 | 227.4 | 5.4 | 232.7 | 220.7 | 12.0 | 2.5 |

Unit: ° C.

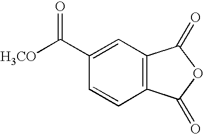

(Comparative Example Compound 14)

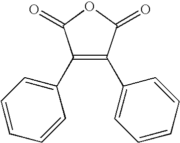

(Comparative Example Compound 15)

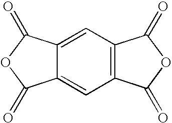

(Example Compound 46)

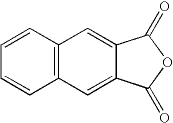

(Example Compound 47)

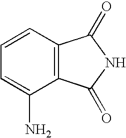

(Comparative Example Compound 16)

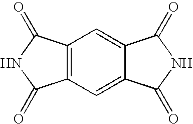

(Example Compound 48)

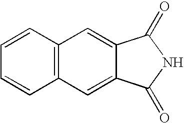

(Example Compound 49)

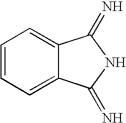

(Comparative Example Compound 17)

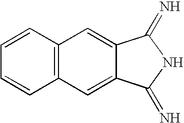

(Example Compound 50)

### Comparative Investigation of Examples 46 and 47 and Comparative Examples 14 and 15

Examples 46 and 47 are compounds having a polycyclic structure wherein a total of three 5-membered and 6-membered rings are condensed to form condensed ring, and containing a maleic anhydride structure in a portion thereof.

The crystallization temperature (T⁰_{CP}) of polyamide 66 (control: original crystalline resin) is 232.8° C., and the crystallization temperature falls (ΔT_{CP}) in Examples 46 and 47 are +6.3 and +5.4° C. (ΔΔT_{C}); the crystallization temperature fell significantly.

Also, the crystallization temperature ranges (ΔT_{C}) of Examples 46 and 47 expanded by +2.6 and +2.2° C. (ΔΔT_{C}) compared to the crystallization temperature range (ΔT⁰_{C}) of 9.5° C. of polyamide 66 (control: original crystalline resin), showing that the crystallization rate fell significantly. It is also shown that the extrapolated crystallization initiation temperature (T_{CIP}) is lower than that of the original crystalline resin, and that the nucleus induction period lengthened very much. Therefore, the compounds of Examples 46 and 47 possess a remarkable function as a nucleating-effect-suppressor.

On the other hand, the crystallization temperature fall (ΔT_{CP}) of Comparative Example 14 is +0.5° C.; there is almost no change in crystallization temperature. The crystallization temperature range (ΔT_{C}) is +0.1° C. (ΔΔT_{C}) compared to the control (original crystalline resin), and crystallization rate remains almost unchanged. Therefore, the compound of Comparative Example 14 does not possess a function as a nucleating-effect-suppressor.

As stated above, the compounds having a polycyclic structure wherein a total of three 5-membered and 6-membered rings are condensed to form condensed ring possess a function of nucleation suppressing effect, whereas the compounds wherein a total of two 5-membered and 6-membered rings are condensed to form condensed ring do not possess a function of a nucleating-effect-suppressor.

Also, Comparative Example 15 is a compound wherein two aromatic rings are linked to maleic anhydride via single bonds. The crystallization temperature fall (ΔT_{CP}) of this Comparative Example 15 is +1.8° C.; there is almost no change in crystallization temperature. The crystallization temperature range (ΔT_{C}) is +0.1° C. (ΔΔT_{C}) compared to the control (original crystalline resin), and the crystallization rate remains almost unchanged. Therefore, the compound of Comparative Example 15 does not possess a function as a nucleating-effect-suppressor.

As stated above, the compounds having a polycyclic structure wherein a total of three 5-membered and 6-membered rings are condensed to form condensed ring possess a function of nucleation suppressing effect, whereas the compounds having a total of three 5-membered or higher rings, one of which, however, is linked to any other ring via a single bond, like Comparative Example 15, do not possess a function of a nucleating-effect-suppressor.

### Comparative Investigation of Examples 48 and 49 and Comparative Example 16

Examples 48 and 49 are compounds having a polycyclic structure wherein a total of three 5-membered and 6-membered rings are condensed to form condensed ring.

The crystallization temperature (T⁰_{CP}) of polyamide 66 (control: original crystalline resin) is 232.8° C., and the crystallization temperature falls (ΔT_{CP}) in Examples 48 and 49 are +5.9 and +5.1° C.; the crystallization temperature fell significantly.

Also, the crystallization temperature range (ΔT_{C}) of Examples 48 and 49 expanded by +2.1 and +2.2° C. compared to the crystallization temperature range (ΔT⁰_{C}) of 9.5° C. of polyamide 66 (control: original crystalline resin), showing that the crystallization rate fell significantly. It is also shown that the extrapolated crystallization initiation temperature (T_{CIP}) is lower than that of the original crystalline resin, and that the nucleus induction period lengthened very much. Therefore, the compounds of Examples 48 and 49 possess a remarkable function as a nucleating-effect-suppressor.

On the other hand, the crystallization temperature fall (ΔT_{CP}) of Comparative Example 16 is −0.3° C.; there is almost no change in crystallization temperature. The crystallization temperature range (ΔT_{C}) is −0.6° C. (ΔΔT_{C}) compared to the control (original crystalline resin), and the crystallization rate rose slightly. Therefore, the compound of Comparative Example 16 does not possess a function as a nucleating-effect-suppressor, and rather works as a nucleating agent.

As stated above, the compounds having a polycyclic structure wherein a total of three 5-membered and 6-membered rings are condensed to form condensed ring have a function of nucleation suppressing effect, whereas the compounds wherein a total of two 5-membered and 6-membered rings are condensed to form condensed ring, like Comparative Example 16, do not possess a function of a nucleating-effect-suppressor.

Comparative Investigation of Example 50 and Comparative Example 17

Example 50 is a compound having a polycyclic structure wherein a total of three 5-membered and 6-membered rings are condensed to form condensed ring.

The crystallization temperature (T⁰_{CP}) of polyamide 66 (control: original crystalline resin) is 232.8° C., and the crystallization temperature fall (ΔT_{CP}) in Example 50 is +5.4° C.; the crystallization temperature fell.

Also, the crystallization temperature range (ΔT_{C}) of Example 50 expanded by +2.5° C. (ΔΔT_{C}) compared to the crystallization temperature range (ΔT⁰_{C}) of 9.5° C. of polyamide 66 (control: original crystalline resin), showing that the crystallization rate fell significantly. It is also shown that the extrapolated crystallization initiation temperature (T_{CIP}) is lower than that of the original crystalline resin, and that the nucleus induction period lengthened very much. Therefore, the compound of Example 50 possesses a remarkable function as a nucleating-effect-suppressor.

On the other hand, the crystallization temperature fall (ΔT_{CP}) of Comparative Example 17 is −0.7° C.; there is almost no change in crystallization temperature. The crystallization temperature range (ΔT_{C}) is +0.3° C. (ΔΔT_{C}) compared to the control (original crystalline resin), and the crystallization rate rose slightly. Therefore, the compound of Comparative Example 17 does not possess a function as a nucleating-effect-suppressor.

As stated above, the compounds having a polycyclic structure wherein a total of three 5-membered and 6-membered rings are condensed to form condensed ring possess a function of nucleation suppressing effect, whereas the compounds wherein a total of two 5-membered and 6-membered rings are condensed to form condensed ring do not possess a function of a nucleating-effect-suppressor.

### Example 51 and Comparative Examples 18 to 20

By Example 51 and Comparative Examples 18 to 20, benzothiazole structures were comparatively investigated. The structures of the individual example compounds and the individual comparative example compounds are as follows.

TABLE 7

| Example | Example Compound | Basic Structure | T_{CP} | Δ T_{CP} | T_{CIP} | T_{CEP} | Δ T_{C} | Δ Δ T_{C} |
|---|---|---|---|---|---|---|---|---|
| Comparative | Comparative Example | | 232.1 | 0.7 | 235.4 | 226.4 | 9.0 | −0.5 |
| Example 18 | Compound18 | | | | | | | |
| Comparative | Comparative Example | | 232.4 | 0.4 | 235.1 | 226.0 | 9.1 | −0.4 |
| Example 19 | Compound19 | | | | | | | |
| Comparative | Comparative Example | | 233.3 | −0.5 | 236.0 | 227.1 | 8.9 | −0.6 |
| Example 20 | Compound20 | | | | | | | |
| Example 51 | Example Compound51 | Basic Structure5 | 227.6 | 5.2 | 232.8 | 220.2 | 12.6 | 3.1 |

Unit: ° C.

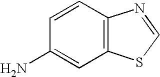

(Comparative Example Compound 18)

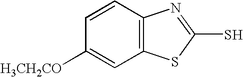

(Comparative Example Compound 19)

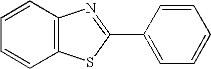

(Comparative Example Compound 20)

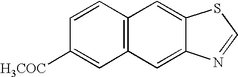

(Example Compound 51)

Example 51 is a compound having a polycyclic structure wherein a total of three 5-membered and 6-membered rings are condensed to form condensed ring, and containing a benzothiazole structure in a portion thereof.

The crystallization temperature (T⁰_{CP}) of polyamide 66 (control: original crystalline resin) is 232.8° C., and the crystallization temperature fall (ΔT_{CP}) in Example 51 is +5.2° C.; the crystallization temperature fell significantly.

Also, the crystallization temperature range (ΔT_{C}) of Example 51 expanded by +3.11° C. (ΔΔT_{C}) compared to the crystallization temperature range (ΔT⁰_{C}) of 9.5° C. of polyamide 66 (control: original crystalline resin), showing that the crystallization rate fell significantly. It is also shown that the extrapolated crystallization initiation temperature (T_{CIP}) is lower than that of the original crystalline resin, and that the nucleus induction period lengthened very much. Therefore, the compound of Example 51 possesses a remarkable function as a nucleating-effect-suppressor.

On the other hand, the crystallization temperature falls (ΔT_{CP}) of Comparative Examples 18 and 19 are +0.7 and +0.4° C.; there is almost no change in crystallization temperature. The crystallization temperature ranges (ΔT_{C}) are −0.5 and −0.4° C. compared to the control (original crystalline resin), and the crystallization rate remained almost unchanged or rose slightly. Therefore, the compounds of Comparative Examples 18 and 19 do not possess a function as a nucleating-effect-suppressor, and rather work as a nucleating agent.

As stated above, the compounds having a polycyclic structure wherein a total of three 5-membered and 6-membered rings are condensed to form condensed ring possess a function of nucleation suppressing effect, whereas the compounds wherein a total of two 5-membered and 6-membered rings are condensed to form condensed ring do not possess a function of a nucleating-effect-suppressor.

Also, Comparative Example 20 is a compound wherein aromatic rings are linked to benzothiazole via single bonds (the total number of rings is three). The crystallization temperature fall (ΔT_{CP}) of this Comparative Example 20 is −0.5° C.; there is almost no change in crystallization temperature. The crystallization temperature range (ΔT_{C}) is −0.6° C. (ΔΔT_{C}) compared to the control (original crystalline resin), and the crystallization rate rose slightly. Therefore, the compound of Comparative Example 20 does not possess a function as a nucleating-effect-suppressor, and rather works as a nucleating agent.

As stated above, the compounds having a total of three 5-membered or higher rings, one of which, however, is linked to any other ring via a single bond, do not possess a function as a nucleating-effect-suppressor.

### Examples 52 to 56 and Comparative Examples 21 and 22

By Examples 52 to 56 and Comparative Examples 21 and 22, indene structures were comparatively investigated. The structures of the individual example compounds and the individual comparative example compounds are as follows.

TABLE 8

| Example | Example Compound | Basic Structure | T_{CP} | Δ T_{CP} | T_{CIP} | T_{CEP} | Δ T_{C} | Δ Δ T_{C} |
|---|---|---|---|---|---|---|---|---|
| Comparative | Comparative Example | | 232.1 | 0.7 | 235.1 | 227.0 | 8.1 | −1.4 |
| Example 21 | Compound21 | | | | | | | |
| Comparative | Comparative Example | | 232.4 | 0.4 | 234.7 | 227.2 | 7.5 | −2.0 |
| Example 22 | Compound22 | | | | | | | |
| Example 52 | Example Compound52 | Basic Structure18 | 220.7 | 12.1 | 228.9 | 213.1 | 15.8 | 6.3 |
| Example 53 | Example Compound53 | Basic Structure18 | 229.5 | 3.3 | 228.1 | 211.9 | 16.2 | 6.7 |
| Example 54 | Example Compound54 | Basic Structure18 | 222.7 | 10.1 | 229.8 | 215.0 | 14.8 | 5.3 |
| Example 55 | Example Compound55 | Basic Structure51 | 223.3 | 9.5 | 230.1 | 217.3 | 12.8 | 3.3 |
| Example 56 | Example Compound56 | Basic Structure57 | 222.1 | 10.7 | 228.4 | 215.7 | 12.7 | 3.2 |

Unit: ° C.

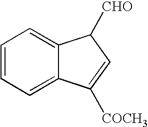

(Comparative Example Compound 21)

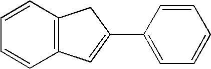

(Comparative Example Compound 22)

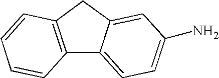

(Example Compound 52)

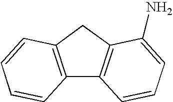

(Example Compound 53)

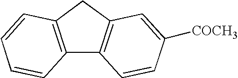

(Example Compound 54)

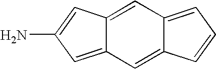

(Example Compound 55)

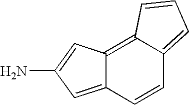

(Example Compound 56)

Examples 52 to 56 are compounds having a polycyclic structure wherein a total of three 5-membered and 6-membered rings are condensed to form condensed ring, and containing an indene structure in a portion thereof.

The crystallization temperature (T⁰_{CP}) of polyamide 66 (control: original crystalline resin) is 232.8° C., and the crystallization temperature falls (ΔT_{CP}) in Examples 52 to 56 are +9.5 to +12.1° C.; the crystallization temperature fell significantly.

Also, the crystallization temperature ranges (ΔT_{C}) of Examples 52 to 56 expanded by +3.2 to +6.7° C. (ΔΔT_{C}) compared to the crystallization temperature range (ΔT⁰_{C}) of 9.5° C. of polyamide 66 (control: original crystalline resin), showing that the crystallization rate fell significantly. It is also shown that the extrapolated crystallization initiation temperature (T_{CIP}) is lower than that of the original crystalline resin, and that the nucleus induction period lengthened very much. Therefore, the compounds of Examples 52 to 56 possess a remarkable function as a nucleating-effect-suppressor.

On the other hand, the crystallization temperature fall (ΔT_{CP}) of Comparative Example 21 is +0.7° C.; there is almost no change in crystallization temperature. The crystallization temperature range (ΔT_{C}) is −1.4° C. (ΔΔT_{C}) compared to the control (original crystalline resin), and the crystallization rate rose slightly. Therefore, the compound of Comparative Example 21 does not possess a function as a nucleating-effect-suppressor.

As stated above, the compounds having a polycyclic structure wherein a total of three 5-membered and 6-membered rings are condensed to form condensed ring possess a function of nucleation suppressing effect, whereas the compounds wherein a total of two 5-membered and 6-membered rings are condensed to form condensed ring do not possess a function of a nucleating-effect-suppressor.

Comparative Example 22 is a compound wherein aromatic rings are linked to indene via single bonds (the total number of rings is three). The crystallization temperature fall (ΔT_{CP}) of this Comparative Example 22 is +0.4° C.; there is almost no change in crystallization temperature. The crystallization temperature range (ΔT_{C}) is −2.0° C. (ΔΔT_{C}) compared to the control (original crystalline resin), and the crystallization rate rose slightly. Therefore, the compound of Comparative Example 22 does not possess a function as a nucleating-effect-suppressor, and rather works as a nucleating agent.

As stated above, the compounds having a total of three 5-membered or higher rings, one of which, however, is linked to any other ring via a single bond, like Comparative Example 22, do not possess a function of a nucleating-effect-suppressor.

### Examples 57 to 98

Examples 57 to 98 pertain to Example Compounds 57 to 98, which have a polycyclic structure wherein three 5-membered or higher cyclic structures are condensed to form condensed ring. The structures of the individual example compounds are as follows.

TABLE 9

| Example | Example Compound | Basic Structure | T_{CP} | Δ T_{CP} | T_{CIP} | T_{CEP} | Δ T_{C} | Δ Δ T_{C} |
|---|---|---|---|---|---|---|---|---|
| Example 57 | Example Compound57 | | 227.5 | 5.3 | 233.4 | 221.2 | 12.2 | 2.7 |
| Example 58 | Example Compound58 | | 223.6 | 9.2 | 229.7 | 216.0 | 13.7 | 4.2 |
| Example 59 | Example Compound59 | Basic Structure19 | 227.4 | 5.4 | 233.2 | 221.6 | 11.6 | 2.1 |
| Example 60 | Example Compound60 | Basic Structure20 | 224.1 | 8.7 | 230.2 | 218.1 | 12.1 | 2.6 |
| Example 61 | Example Compound61 | Basic Structure20 | 225.6 | 7.2 | 231.6 | 218.9 | 12.7 | 3.2 |
| Example 62 | Example Compound62 | Basic Structure20 | 226.6 | 6.2 | 231.1 | 219.3 | 11.8 | 2.3 |
| Example 63 | Example Compound63 | Basic Structure21 | 226.4 | 6.4 | 232.6 | 220.7 | 11.9 | 2.4 |
| Example 64 | Example Compound64 | Basic Structure21 | 227.7 | 5.1 | 233.9 | 221.5 | 12.4 | 2.9 |
| Example 65 | Example Compound65 | Basic Structure21 | 227.0 | 5.8 | 233.1 | 221.0 | 12.1 | 2.6 |
| Example 66 | Example Compound66 | Basic Structure22 | 225.6 | 7.2 | 230.9 | 218.6 | 12.3 | 2.8 |
| Example 67 | Example Compound67 | Basic Structure23 | 227.1 | 5.7 | 232.6 | 221.1 | 11.5 | 2.0 |
| Example 68 | Example Compound68 | Basic Structure23 | 227.8 | 5.0 | 232.7 | 220.1 | 12.6 | 3.1 |
| Example 69 | Example Compound69 | | 227.7 | 5.1 | 232.7 | 220.1 | 12.6 | 3.1 |
| Example 70 | Example Compound70 | Basic Structure26 | 225.6 | 7.2 | 231.0 | 219.3 | 11.7 | 2.2 |
| Example 71 | Example Compound71 | Basic Structure27 | 224.1 | 8.8 | 232.6 | 214.6 | 18.0 | 8.5 |
| Example 72 | Example Compound72 | Basic Structure27 | 218.9 | 14.0 | 226.3 | 212.2 | 14.1 | 4.6 |
| Example 73 | Example Compound73 | Basic Structure27 | 227.7 | 5.1 | 233.0 | 221.2 | 11.8 | 2.3 |
| Example 74 | Example Compound74 | Basic Structure28 | 220.6 | 12.2 | 227.8 | 212.7 | 15.1 | 5.6 |
| Example 75 | Example Compound75 | Basic Structure30 | 226.6 | 6.2 | 231.7 | 219.0 | 12.7 | 3.2 |
| Example 76 | Example Compound76 | Basic Structure32 | 219.5 | 13.3 | 227.2 | 210.5 | 16.7 | 7.2 |
| Example 77 | Example Compound77 | Basic Structure33 | 218.9 | 13.9 | 227.0 | 211.5 | 15.5 | 6.0 |
| Example 78 | Example Compound78 | Basic Structure33 | 219.5 | 13.3 | 227.1 | 213.8 | 13.3 | 3.8 |
| Example 79 | Example Compound79 | Basic Structure33 | 224.3 | 8.5 | 230.5 | 217.5 | 13.0 | 3.5 |
| Example 80 | Example Compound81 | Basic Structure35 | 223.3 | 9.5 | 229.5 | 216.5 | 13.0 | 3.5 |
| Example 81 | Example Compound81 | Basic Structure37 | 223.7 | 9.1 | 228.4 | 214.2 | 14.2 | 4.7 |
| Example 82 | Example Compound82 | Basic Structure37 | 227.4 | 5.4 | 233.3 | 219.8 | 13.5 | 4.0 |
| Example 83 | Example Compound83 | Basic Structure38 | 219.6 | 13.2 | 228.1 | 212.3 | 15.8 | 6.3 |
| Example 84 | Example Compound84 | Basic Structure38 | 217.1 | 15.7 | 226.5 | 210.2 | 16.3 | 6.8 |
| Example 85 | Example Compound85 | Basic Structure38 | 221.8 | 11.0 | 226.7 | 211.9 | 14.8 | 5.3 |
| Example 86 | Example Compound86 | | 219.6 | 13.2 | 227.3 | 212.7 | 14.6 | 5.1 |
| Example 87 | Example Compound87 | | 221.4 | 11.4 | 228.1 | 215.0 | 13.1 | 3.6 |
| Example 88 | Example Compound89 | Basic Structure36 | 223.9 | 8.9 | 229.9 | 217.2 | 12.7 | 3.2 |
| Example 89 | Example Compound89 | Basic Structure41 | 226.9 | 5.9 | 231.5 | 219.6 | 11.9 | 2.4 |
| Example 90 | Example Compound90 | | 225.9 | 6.9 | 230.9 | 219.4 | 11.5 | 2.0 |
| Example 91 | Example Compound91 | Basic Structure45 | 226.6 | 6.2 | 231.7 | 217.3 | 14.4 | 4.9 |
| Example 92 | Example Compound92 | Basic Structure54 | 227.4 | 5.4 | 232.2 | 219.4 | 12.8 | 3.3 |
| Example 93 | Example Compound93 | Basic Structure55 | 227.6 | 5.2 | 232.2 | 219.8 | 12.4 | 2.9 |
| Example 94 | Example Compound94 | | 226.9 | 5.9 | 232.0 | 220.1 | 11.9 | 2.4 |
| Example 95 | Example Compound95 | Basic Structure58 | 226.7 | 6.1 | 233.1 | 221.0 | 12.1 | 2.6 |
| Example 96 | Example Compound96 | | 225.6 | 7.2 | 231.1 | 218.3 | 12.8 | 3.3 |
| Example 97 | Example Compound97 | | 224.9 | 7.9 | 230.8 | 218.6 | 12.2 | 2.7 |
| Example 98 | Example Compound98 | | 227.8 | 5.0 | 232.7 | 220.6 | 12.1 | 2.6 |

Unit: ° C.

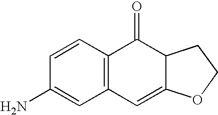

(Example Compound 57)

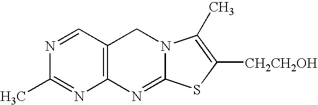

(Example Compound 58)

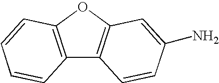

(Example Compound 59)

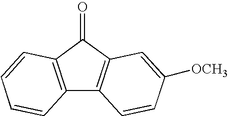

(Example Compound 60)

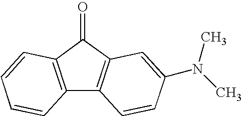

(Example Compound 61)

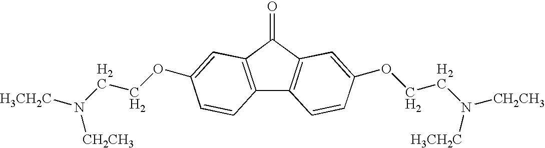

(Example Compound 62)

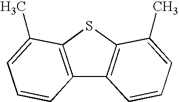

(Example Compound 63)

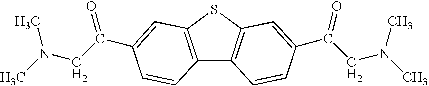

(Example Compound 64)

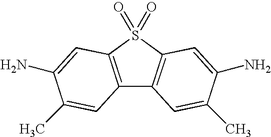

(Example Compound 65)

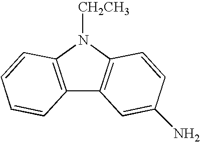

(Example Compound 66)

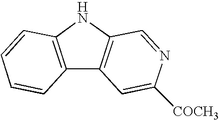

(Example Compound 67)

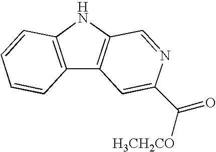

(Example Compound 68)

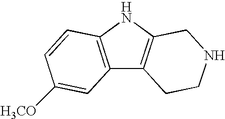

(Example Compound 69)

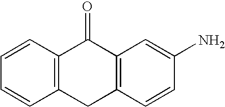

(Example Compound 70)

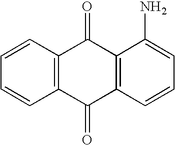

(Example Compound 71)

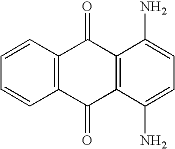

(Example Compound 72)

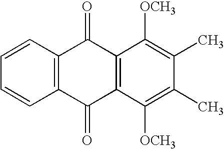

(Example Compound 73)

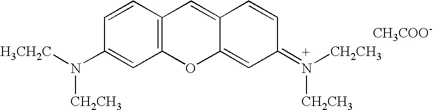

(Example Compound 74)

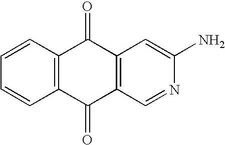

(Example Compound 75)

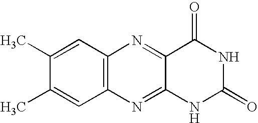

(Example Compound 76)

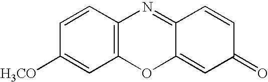

(Example Compound 77)

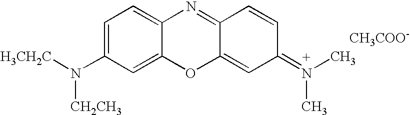

(Example Compound 78)

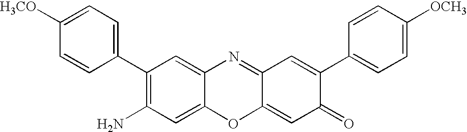

(Example Compound 79)

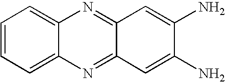

(Example Compound 80)

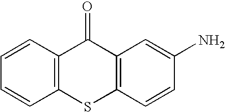

(Example Compound 81)

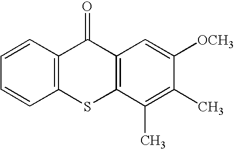

(Example Compound 82)

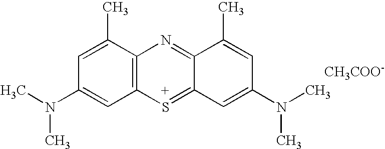

(Example Compound 83)

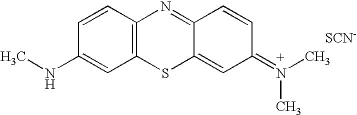

(Example Compound 84)

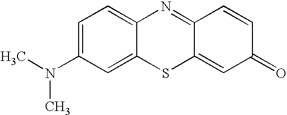

(Example Compound 85)

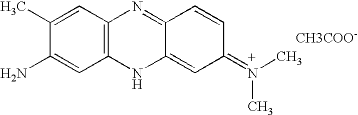

(Example Compound 86)

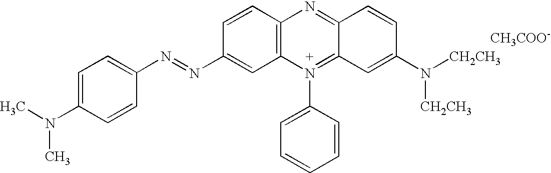

(Example Compound 87)

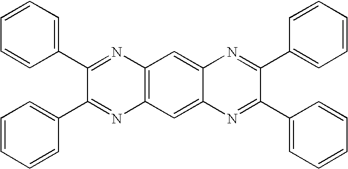

(Example Compound 88)

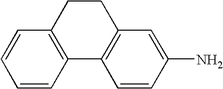

(Example Compound 89)

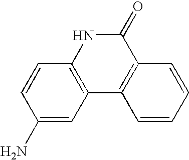

(Example Compound 90)

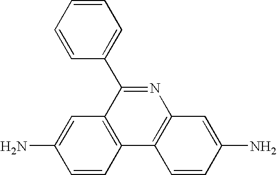

(Example Compound 91)

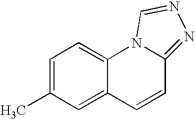

(Example Compound 92)

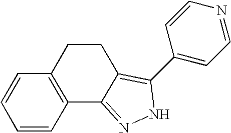

(Example Compound 93)

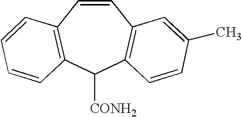

(Example Compound 94)

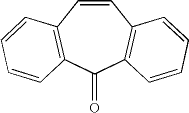

(Example Compound 95)

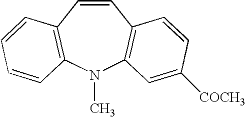

(Example Compound 96)

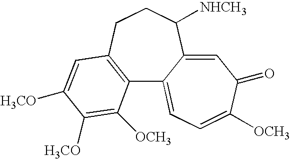

(Example Compound 97)

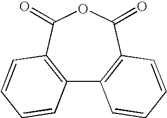

(Example Compound 98)

The crystallization temperature (T⁰_{CP}) of polyamide 66 (control: original crystalline resin) is 232.8° C., and the crystallization temperature falls (ΔT_{CP}) in Examples 57 to 98 are +5.0 to +15.7° C.; the crystallization temperature fell significantly.

Also, the crystallization temperature ranges (ΔT_{C}) of Examples 57 to 98 expanded by +2.0 to +8.5° C. (ΔΔT_{C}) compared to the crystallization temperature range (ΔT_{CP}) of 9.5° C. of polyamide 66 (control: original crystalline resin), showing that the crystallization temperatures fell significantly. It is also shown that the extrapolated crystallization initiation temperature (T_{CIP}) is lower than that of the original crystalline resin, and that the nucleus induction period lengthened very much. Therefore, the compounds of Examples 57 to 98 possess a remarkable function as a nucleating-effect-suppressor.

### Examples 99 and 100

Examples 99 and 100 pertain to Example Compounds 100 and 101, which have a polycyclic structure wherein three 4-membered or higher cyclic structures are condensed to form condensed ring. The structures of the individual example compounds are as follows.

TABLE 10

| Example | Example Compound | Basic Structure | T_{CP} | Δ T_{CP} | T_{CIP} | T_{CEP} | Δ T_{C} | Δ Δ T_{C} |
|---|---|---|---|---|---|---|---|---|
| Example 99 | Example Compound99 | Basic Structure50 | 226.0 | 6.8 | 232.6 | 221.1 | 11.5 | 2.0 |
| Example 100 | Example Compound100 | Basic Structure50 | 227.4 | 5.4 | 232.0 | 220.2 | 11.8 | 2.3 |

Unit: ° C.

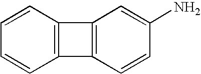

(Example Compound 99)

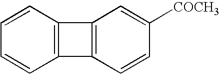

(Example Compound 100)

The crystallization temperature (T⁰_{CP}) of polyamide 66 (control: original crystalline resin) is 232.8° C., and the crystallization temperature falls (ΔT_{CP}) in Examples 99 and 100 are +6.8 and +5.4° C.; the crystallization temperature fell significantly.

Also, the crystallization temperature ranges (ΔT_{C}) of Examples 99 and 100 expanded by +2.0 and +2.3° C. (ΔΔT_{C}) compared to the crystallization temperature range (ΔT⁰_{C}) of 9.5° C. of polyamide 66 (control: original crystalline resin), showing that the crystallization rate fell significantly. It is also shown that the extrapolated crystallization initiation temperature (T_{CIP}) is lower than that of the original crystalline resin, and that the nucleus induction period lengthened very much. Therefore, these compounds possess a remarkable function as a nucleating-effect-suppressor.

### Comparative Examples 23 to 114

By Examples 1 to 100 and Comparative Examples 1 to 22, the influences of the number of rings condensed to form condensed ring on crystallization temperature and crystallization rate have been comparatively investigated on the basis of similarity in ring structure and substituent. As a result, when the number of rings condensed to form condensed ring was two, there was almost no effect in lowering the crystallization temperature and the crystallization rate, whereas when the number of rings condensed to form condensed ring exceeded three, a dramatically significant effect was observed.

To further confirm such differences in nucleation suppressing effect due to differences in the number of rings condensed to form condensed ring, the nucleation suppressing effects of compounds having a ring structure and a substituent that are similar to a ring structure and a substituent that were found in Examples 1 to 100 were examined in Comparative Examples 23 to 114. In Comparative Examples 23 to 32, structures having three rings, only two of which, however, are condensed to form condensed ring, are shown; in Comparative Examples 33 to 40, structures having three rings, none of which, however, are condensed to form condensed ring, are shown; in Comparative Examples 41 to 80, structures wherein two rings are condensed to form condensed ring are shown; in Comparative Examples 81 to 99, structures wherein two rings are not condensed to form condensed ring are shown; and in Comparative Examples 100 to 114, those having one ring is shown.

### Comparative Examples 23 to 40

Comparative Examples 23 to 40 pertain to compounds having a total of three or more 5-membered and 6-membered rings, which three or more rings are not condensed to form condensed ring, that is, compounds wherein a cyclic structure wherein a 5-membered ring and a 6-membered ring or two 6-membered rings are condensed to form condensed ring and a single ring are linked via a single bond (or are spiro-bound) or compounds wherein 5-membered or 6-membered rings are linked to each other via single bonds. The structures of the individual comparative example compounds are as follows.

TABLE 11

| Comparative Example | Comparative Example Compound | T_{CP} | Δ T_{CP} | T_{CIP} | T_{CEP} | Δ T_{C} | Δ Δ T_{C} |
|---|---|---|---|---|---|---|---|
| Comparative Example23 | Comparative Example Compound23 | 232.1 | 0.7 | 235.4 | 226.9 | 8.5 | 1.0 |
| Comparative Example24 | Comparative Example Compound24 | 233.1 | −0.3 | 236.2 | 228.3 | 7.9 | 1.6 |
| Comparative Example25 | Comparative Example Compound25 | 233.0 | −0.2 | 236.5 | 227.8 | 8.7 | 0.8 |
| Comparative Example26 | Comparative Example Compound26 | 232.9 | −0.1 | 236.2 | 228.3 | 7.9 | 1.6 |
| Comparative Example27 | Comparative Example Compound27 | 232.5 | 0.3 | 235.9 | 227.6 | 8.3 | 1.2 |
| Comparative Example28 | Comparative Example Compound28 | 231.0 | 1.8 | 233.9 | 224.9 | 9.0 | 0.5 |
| Comparative Example29 | Comparative Example Compound29 | 231.7 | 1.1 | 234.1 | 225.3 | 8.8 | 0.7 |
| Comparative Example30 | Comparative Example Compound30 | 232.0 | 0.8 | 235.3 | 226.9 | 8.4 | 1.1 |
| Comparative Example31 | Comparative Example Compound31 | 230.8 | 2.0 | 234.1 | 224.9 | 9.2 | 0.3 |
| Comparative Example32 | Comparative Example Compound32 | 230.8 | 2.0 | 233.6 | 223.8 | 9.8 | 0.3 |
| Comparative Example33 | Comparative Example Compound33 | 232.7 | 0.1 | 235.6 | 226.6 | 9.0 | 0.5 |
| Comparative Example34 | Comparative Example Compound34 | 231.2 | 1.6 | 234.8 | 225.0 | 9.8 | 0.3 |
| Comparative Example35 | Comparative Example Compound35 | 231.5 | 1.3 | 234.6 | 225.0 | 9.6 | 0.1 |
| Comparative Example36 | Comparative Example Compound36 | 231.0 | 1.8 | 234.7 | 224.7 | 10.0 | 0.5 |
| Comparative Example37 | Comparative Example Compound37 | 231.2 | 1.6 | 234.9 | 225.2 | 9.7 | 0.2 |
| Comparative Example38 | Comparative Example Compound38 | 231.4 | 1.4 | 234.9 | 225.1 | 9.8 | 0.3 |
| Comparative Example39 | Comparative Example Compound39 | 230.9 | 1.9 | 234.1 | 223.6 | 10.5 | 1.0 |
| Comparative Example40 | Comparative Example Compound40 | 232.7 | 0.1 | 235.4 | 226.6 | 8.8 | 0.7 |

Unit: ° C.

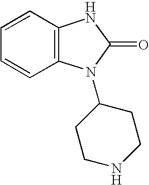

(Comparative Example Compound 23)

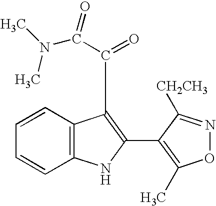

(Comparative Example Compound 24)

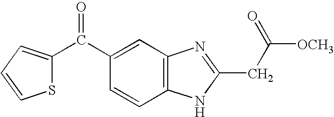

(Comparative Example Compound 25)

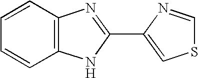

(Comparative Example Compound 26)

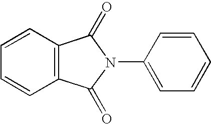

(Comparative Example Compound 27)

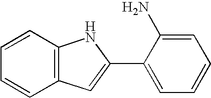

(Comparative Example Compound 28)

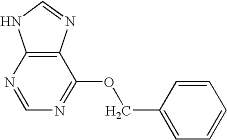

(Comparative Example Compound 29)

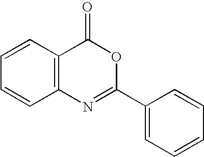

(Comparative Example Compound 30)

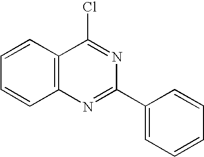

(Comparative Example Compound 31)

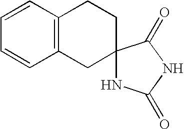

(Comparative Example Compound 32)

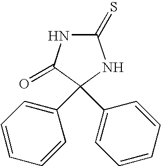

(Comparative Example Compound 33)

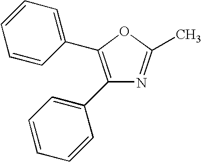

(Comparative Example Compound 34)

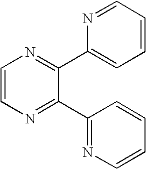

(Comparative Example Compound 35)

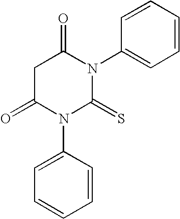

(Comparative Example Compound 36)

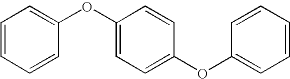

(Comparative Example Compound 37)

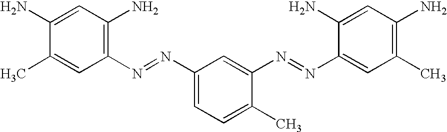

(Comparative Example Compound 38)

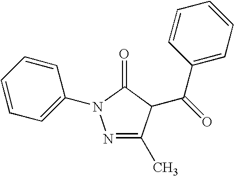

(Comparative Example Compound 39)

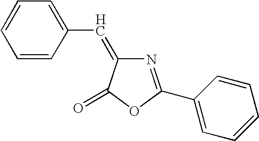

(Comparative Example Compound 40)

The crystallization temperature falls (ΔT_{CP}) of Comparative Examples 23 to 40 are −0.2 to +2.0° C.; there is almost no change or a slight fall in crystallization temperature. The crystallization temperature ranges (ΔT_{C}) are −1.6 to +1.0° C. (ΔΔT_{C}) compared to the control (original crystalline resin), and the crystallization rate remained almost unchanged or rose slightly. Therefore, the compounds of Comparative Examples 23 to 40 do not possess a function as a nucleating-effect-suppressor, and rather work as a nucleating agent.

From the results of Examples 57 to 98, the compounds having a polycyclic structure wherein three 5-membered or higher ring structures are condensed to form condensed ring possessed a function as a nucleating-effect-suppressor. On the other hand, the compounds having a cyclic structure having a total of three or more 5-membered or higher rings, only two of which, however, are condensed to form condensed ring, and the compounds having a structure having three rings, none of which, however, are condensed to form condensed ring, like Comparative Examples 23 to 40, do not possess a function of a nucleating-effect-suppressor.

### Comparative Examples 41 to 80

Comparative Examples 41 to 80 pertain to condensed ring compounds having a substituent or an aromatic ring that are contained in the structures of nucleating effect suppressing compounds described above, but configured with a 5-membered ring and a 6-membered ring or two 6-membered rings. The structures of the individual comparative example compounds are as follows.

TABLE 12

| Comparative Example | Comparative Example Compound | T_{CP} | Δ T_{CP} | T_{CIP} | T_{CEP} | Δ T_{C} | Δ Δ T_{C} |
|---|---|---|---|---|---|---|---|
| Comparative Example41 | Comparative Example Compound41 | 232.2 | 0.6 | 235.1 | 226.9 | 8.2 | 1.3 |
| Comparative Example42 | Comparative Example Compound42 | 232.8 | 0.0 | 235.8 | 227.7 | 8.1 | 1.4 |
| Comparative Example43 | Comparative Example Compound43 | 233.1 | −0.3 | 236.4 | 227.8 | 8.6 | 0.9 |
| Comparative Example44 | Comparative Example Compound44 | 233.7 | −0.9 | 236.4 | 228.3 | 8.1 | 1.4 |
| Comparative Example45 | Comparative Example Compound45 | 233.0 | −0.2 | 235.7 | 227.3 | 8.4 | 1.1 |
| Comparative Example46 | Comparative Example Compound46 | 232.9 | −0.1 | 235.8 | 226.6 | 9.2 | 0.3 |
| Comparative Example47 | Comparative Example Compound47 | 233.8 | −1.0 | 236.2 | 228.2 | 8.0 | 1.5 |
| Comparative Example48 | Comparative Example Compound48 | 231.6 | 1.2 | 234.7 | 224.8 | 9.9 | 0.4 |
| Comparative Example49 | Comparative Example Compound49 | 233.4 | −0.6 | 236.1 | 228.0 | 8.1 | 1.4 |
| Comparative Example50 | Comparative Example Compound50 | 232.7 | 0.1 | 234.9 | 225.1 | 9.8 | 0.3 |
| Comparative Example51 | Comparative Example Compound51 | 233.1 | −0.3 | 235.7 | 227.5 | 8.2 | 1.3 |
| Comparative Example52 | Comparative Example Compound52 | 232.6 | 0.2 | 235.6 | 226.1 | 9.5 | 0.0 |
| Comparative Example53 | Comparative Example Compound53 | 232.9 | −0.1 | 234.7 | 225.4 | 9.3 | 0.2 |
| Comparative Example54 | Comparative Example Compound54 | 233.3 | −0.5 | 236.4 | 227.4 | 9.0 | 0.5 |
| Comparative Example55 | Comparative Example Compound55 | 232.3 | 0.5 | 235.0 | 225.6 | 9.4 | 0.1 |
| Comparative Example56 | Comparative Example Compound56 | 234.0 | −1.2 | 236.4 | 228.6 | 7.8 | 1.7 |
| Comparative Example57 | Comparative Example Compound57 | 232.9 | −0.1 | 236.5 | 227.5 | 9.0 | 0.5 |
| Comparative Example58 | Comparative Example Compound58 | 231.8 | 1.0 | 235.8 | 225.7 | 10.1 | 0.6 |
| Comparative Example59 | Comparative Example Compound59 | 233.6 | −0.8 | 236.9 | 228.0 | 8.9 | 0.6 |
| Comparative Example60 | Comparative Example Compound60 | 232.3 | 0.5 | 235.1 | 225.6 | 9.5 | 0.0 |
| Comparative Example61 | Comparative Example Compound61 | 231.2 | 1.6 | 234.8 | 226.3 | 8.5 | 1.0 |
| Comparative Example62 | Comparative Example Compound62 | 232.2 | 0.6 | 235.6 | 225.8 | 9.8 | 0.3 |
| Comparative Example63 | Comparative Example Compound63 | 232.9 | −0.1 | 236.1 | 227.9 | 8.2 | 1.3 |
| Comparative Example64 | Comparative Example Compound64 | 233.6 | −0.8 | 236.8 | 227.9 | 8.9 | 0.6 |
| Comparative Example65 | Comparative Example Compound65 | 232.6 | 0.2 | 235.7 | 225.5 | 10.2 | 0.7 |
| Comparative Example66 | Comparative Example Compound66 | 232.6 | 0.2 | 235.8 | 227.2 | 8.6 | 0.9 |
| Comparative Example67 | Comparative Example Compound67 | 232.9 | −0.1 | 236.2 | 227.4 | 8.8 | 0.7 |
| Comparative Example68 | Comparative Example Compound68 | 231.9 | 0.9 | 235.1 | 226.0 | 9.1 | 0.4 |
| Comparative Example69 | Comparative Example Compound69 | 232.9 | −0.1 | 236.7 | 227.8 | 8.9 | 0.6 |
| Comparative Example70 | Comparative Example Compound70 | 232.2 | 0.6 | 235.4 | 225.5 | 9.9 | 0.4 |
| Comparative Example71 | Comparative Example Compound71 | 231.5 | 1.3 | 234.6 | 225.8 | 8.8 | 0.7 |
| Comparative Example72 | Comparative Example Compound72 | 231.4 | −1.4 | 235.3 | 225.4 | 9.9 | 0.4 |
| Comparative Example73 | Comparative Example Compound73 | 232.7 | −0.1 | 235.8 | 227.8 | 8.0 | 1.5 |
| Comparative Example74 | Comparative Example Compound74 | 231.0 | −1.8 | 233.8 | 224.7 | 9.1 | 0.4 |
| Comparative Example75 | Comparative Example Compound75 | 231.5 | −1.3 | 234.6 | 226.5 | 8.1 | 1.4 |
| Comparative Example76 | Comparative Example Compound76 | 232.2 | −0.6 | 235.7 | 226.9 | 8.8 | 0.7 |
| Comparative Example77 | Comparative Example Compound77 | 231.5 | −1.3 | 234.5 | 225.5 | 9.0 | 0.5 |
| Comparative Example78 | Comparative Example Compound78 | 231.5 | −1.3 | 234.8 | 225.2 | 9.6 | 0.1 |
| Comparative Example79 | Comparative Example Compound79 | 232.2 | −0.6 | 235.6 | 227.5 | 8.1 | 1.4 |
| Comparative Example80 | Comparative Example Compound80 | 231.7 | −1.1 | 233.9 | 225.4 | 8.5 | 1.0 |

Unit: ° C.

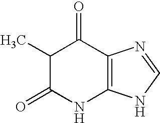

(Comparative Example Compound 41)

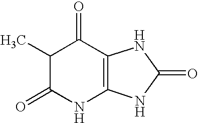

(Comparative Example Compound 42)

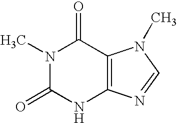

(Comparative Example Compound 43)

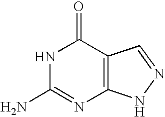

(Comparative Example Compound 44)

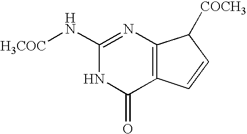

(Comparative Example Compound 45)

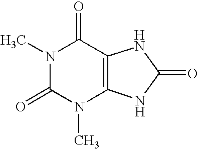

(Comparative Example Compound 46)

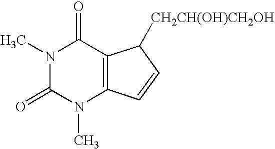

(Comparative Example Compound 47)

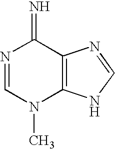

(Comparative Example Compound 48)

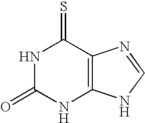

(Comparative Example Compound 49)

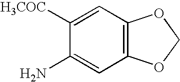

(Comparative Example Compound 50)

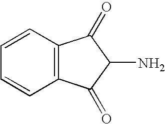

(Comparative Example Compound 51)

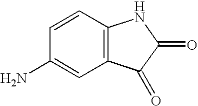

(Comparative Example Compound 52)

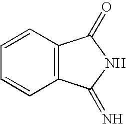

(Comparative Example Compound 53)

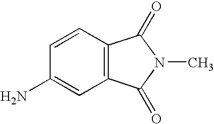

(Comparative Example Compound 54)

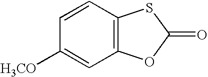

(Comparative Example Compound 55)

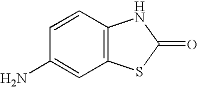

(Comparative Example Compound 56)

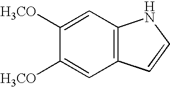

(Comparative Example Compound 57)

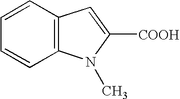

(Comparative Example Compound 58)

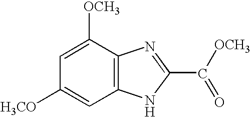

(Comparative Example Compound 59)

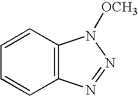

(Comparative Example Compound 60)

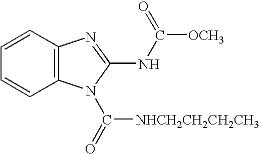

(Comparative Example Compound 61)

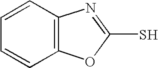

(Comparative Example Compound 62)

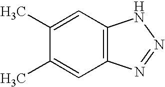

(Comparative Example Compound 63)

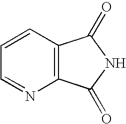

(Comparative Example Compound 64)

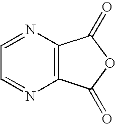

(Comparative Example Compound 65)

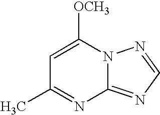

(Comparative Example Compound 66)

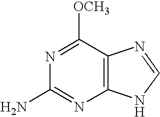

(Comparative Example Compound 67)

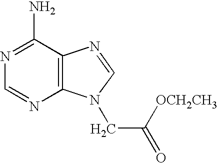

(Comparative Example Compound 68)

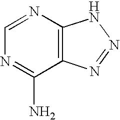

(Comparative Example Compound 69)

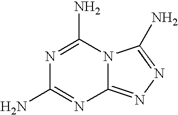

(Comparative Example Compound 70)

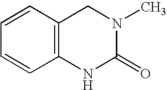

(Comparative Example Compound 71)

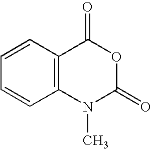

(Comparative Example Compound 72)

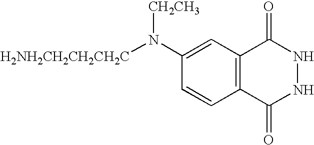

(Comparative Example Compound 73)

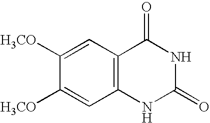

(Comparative Example Compound 74)

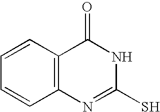

(Comparative Example Compound 75)

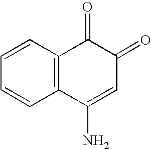

(Comparative Example Compound 76)

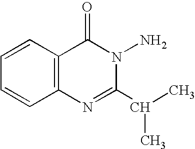

(Comparative Example Compound 77)

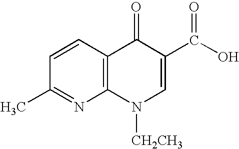

(Comparative Example Compound 78)

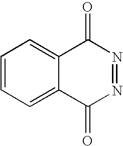

(Comparative Example Compound 79)

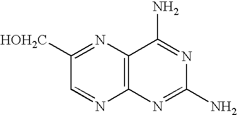

(Comparative Example Compound 80)

The crystallization temperature falls (ΔT_{CP}) of Comparative Examples 41 to 80 are −1.2 to +1.7° C.; there is almost no change or a slight fall in crystallization temperature. Also, the crystallization temperature ranges (ΔT_{C}) of Comparative Examples 41 to 80 are −1.7 to +0.7° C. (ΔΔT_{C}) compared to the control (original crystalline resin), and the crystallization rate remained almost unchanged or rose slightly. Therefore, the compounds of Comparative Examples 41 to 80 do not possess a function as a nucleating-effect-suppressor, and many of the compounds rather work as a nucleating agent.

From the results of Examples 57 to 98, the compounds having a polycyclic structure wherein three 5-membered or higher cyclic structures are condensed to form condensed ring possessed a function as a nucleating-effect-suppressor. On the other hand, from the results of Comparative Examples 41 to 80, it is found that the compounds having a cyclic structure wherein two 5-membered or higher ring structures are condensed to form condensed ring do not possess a function of a nucleating-effect-suppressor.

### Comparative Examples 81 to 114

Comparative Examples 81 to 99 pertain to compounds configured with two ring structures which, however, are not condensed to form condensed ring, like Comparative Examples 41 to 80; Comparative Examples 100 to 114 pertain to compounds comprising a single 5-membered ring or 6-membered ring.

TABLE 13

| Comparative Example | Comparative Example Compound | T_{CP} | Δ T_{CP} | T_{CIP} | T_{CEP} | Δ T_{C} | Δ Δ T_{C} |
|---|---|---|---|---|---|---|---|
| Comparative Example81 | Comparative Example Compound81 | 232.3 | 0.5 | 234.1 | 226.2 | 7.9 | −1.6 |
| Comparative Example82 | Comparative Example Compound82 | 231.3 | 1.5 | 234.6 | 224.8 | 9.8 | 0.3 |
| Comparative Example83 | Comparative Example Compound83 | 231.2 | 1.6 | 233.8 | 225.0 | 8.8 | −0.7 |
| Comparative Example84 | Comparative Example Compound84 | 232.3 | 0.5 | 234.4 | 226.3 | 8.1 | −1.4 |
| Comparative Example85 | Comparative Example Compound85 | 231.9 | 0.9 | 233.9 | 225.0 | 8.9 | −0.6 |
| Comparative Example86 | Comparative Example Compound86 | 231.7 | 1.1 | 235.0 | 225.6 | 9.4 | −0.1 |
| Comparative Example87 | Comparative Example Compound87 | 232.2 | 0.6 | 235.4 | 227.2 | 8.2 | −1.3 |
| Comparative Example88 | Comparative Example Compound88 | 231.9 | 0.9 | 234.2 | 225.6 | 8.6 | −0.9 |
| Comparative Example89 | Comparative Example Compound89 | 230.8 | 2.0 | 233.0 | 224.6 | 8.4 | −1.1 |
| Comparative Example90 | Comparative Example Compound90 | 232.5 | 0.3 | 235.5 | 226.4 | 9.1 | −0.4 |
| Comparative Example91 | Comparative Example Compound91 | 231.9 | 0.9 | 234.5 | 226.2 | 8.3 | −1.2 |
| Comparative Example92 | Comparative Example Compound92 | 232.2 | 0.6 | 235.1 | 226.4 | 8.7 | −0.8 |
| Comparative Example93 | Comparative Example Compound93 | 232.5 | 0.3 | 234.9 | 226.7 | 8.2 | −1.3 |
| Comparative Example94 | Comparative Example Compound94 | 231.2 | 1.6 | 234.4 | 224.8 | 9.6 | 0.1 |
| Comparative Example95 | Comparative Example Compound95 | 230.9 | 1.9 | 234.1 | 225.4 | 8.7 | −0.8 |
| Comparative Example96 | Comparative Example Compound96 | 231.6 | 1.2 | 234.8 | 225.6 | 9.2 | −0.3 |
| Comparative Example97 | Comparative Example Compound97 | 231.8 | 1.0 | 234.2 | 225.5 | 8.7 | −0.8 |
| Comparative Example98 | Comparative Example Compound98 | 232.4 | 0.4 | 235.4 | 225.1 | 10.3 | 0.8 |
| Comparative Example99 | Comparative Example Compound99 | 231.9 | 0.9 | 234.8 | 224.9 | 9.9 | 0.4 |
| Comparative Example100 | Comparative Example Compound100 | 233.2 | −0.4 | 236.1 | 227.6 | 8.5 | −1.0 |
| Comparative Example101 | Comparative Example Compound101 | 233.1 | −0.3 | 235.7 | 227.9 | 7.8 | −1.7 |
| Comparative Example102 | Comparative Example Compound102 | 230.8 | 2.0 | 234.8 | 226.7 | 8.1 | −1.4 |
| Comparative Example103 | Comparative Example Compound103 | 232.9 | −0.1 | 235.7 | 227.4 | 8.3 | −1.2 |
| Comparative Example104 | Comparative Example Compound104 | 231.7 | 1.1 | 234.1 | 224.4 | 9.7 | 0.2 |
| Comparative Example105 | Comparative Example Compound105 | 231.9 | 0.9 | 235.0 | 227.0 | 8.0 | −1.5 |
| Comparative Example106 | Comparative Example Compound106 | 231.8 | 1.0 | 234.5 | 225.9 | 8.6 | −0.9 |
| Comparative Example107 | Comparative Example Compound107 | 233.4 | −0.6 | 236.1 | 227.6 | 8.5 | −1.0 |
| Comparative Example108 | Comparative Example Compound108 | 233.5 | −0.7 | 236.4 | 227.6 | 8.8 | −0.7 |
| Comparative Example109 | Comparative Example Compound109 | 233.1 | −0.3 | 235.6 | 227.0 | 8.6 | −0.9 |
| Comparative Example110 | Comparative Example Compound110 | 232.7 | 0.1 | 234.9 | 226.1 | 8.8 | −0.7 |
| Comparative Example111 | Comparative Example Compound111 | 231.8 | 1.0 | 235.9 | 227.3 | 8.6 | −0.9 |
| Comparative Example112 | Comparative Example Compound112 | 232.1 | 0.7 | 235.4 | 226.3 | 9.1 | −0.4 |
| Comparative Example113 | Comparative Example Compound113 | 231.1 | 1.7 | 234.8 | 225.4 | 9.4 | −0.1 |
| Comparative Example114 | Comparative Example Compound114 | 231.1 | 1.7 | 233.8 | 225.2 | 8.6 | −0.9 |

Unit: ° C.

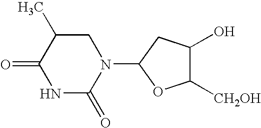

(Comparative Example Compound 81)

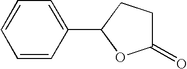

(Comparative Example Compound 82)

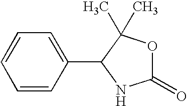

(Comparative Example Compound 83)

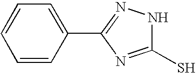

(Comparative Example Compound 84)

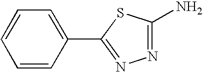

(Comparative Example Compound 85)

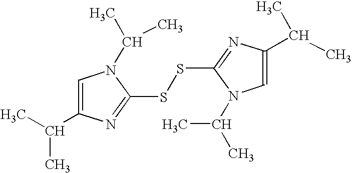

(Comparative Example Compound 86)

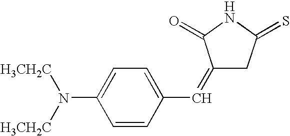

(Comparative Example Compound 87)

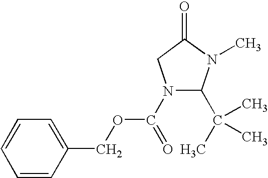

(Comparative Example Compound 88)

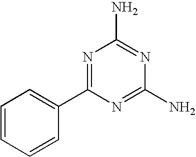

(Comparative Example Compound 89)

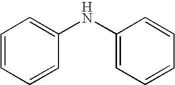

(Comparative Example Compound 90)

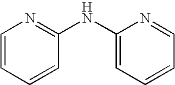

(Comparative Example Compound 91)

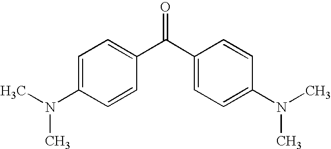

(Comparative Example Compound 92)

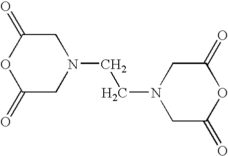

(Comparative Example Compound 93)

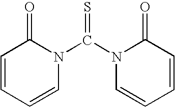

(Comparative Example Compound 94)

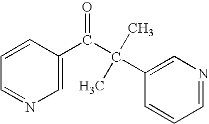

(Comparative Example Compound 95)

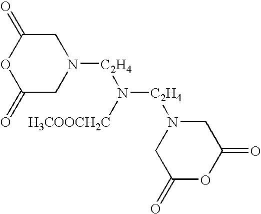

(Comparative Example Compound 96)

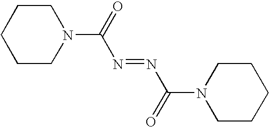

(Comparative Example Compound 97)

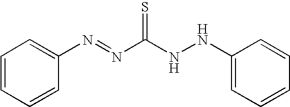

(Comparative Example Compound 98)

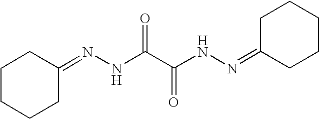

(Comparative Example Compound 99)

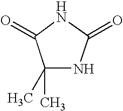

(Comparative Example Compound 100)

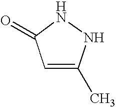

(Comparative Example Compound 101)

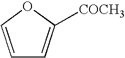

(Comparative Example Compound 102)

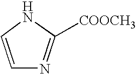

(Comparative Example Compound 103)

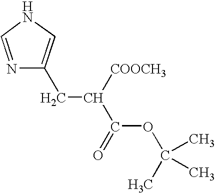

(Comparative Example Compound 104)

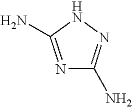

(Comparative Example Compound 105)

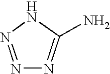

(Comparative Example Compound 106)

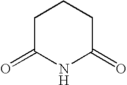

(Comparative Example Compound 107)

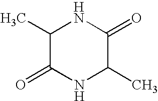

(Comparative Example Compound 108)

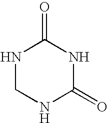

(Comparative Example Compound 109)

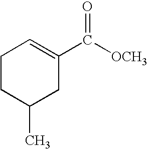

(Comparative Example Compound 110)

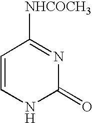

(Comparative Example Compound 111)

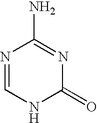

(Comparative Example Compound 112)

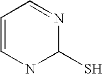

(Comparative Example Compound 113)

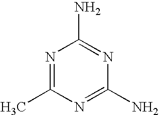

(Comparative Example Compound 114)

The crystallization temperature falls (ΔT_{CP}) of Comparative Examples 81 to 99 are +0.1 to +1.9° C.; there is almost no change or a slight fall in crystallization temperature. The crystallization temperature ranges (ΔT_{C}) are −1.5 to +0.8° C. (ΔΔT_{C}) compared to the control (original crystalline resin), and the crystallization rate remained almost unchanged or rose slightly. Therefore, the compounds of Comparative Examples 81 to 99, wherein single rings are linked to each other via single bonds, do not possess a function as a nucleating-effect-suppressor, rather work as a nucleating agent.

The crystallization temperature falls (ΔT_{CP}) of Comparative Examples 100 to 114 are −0.7 to +2.0° C.; there is almost no change or a slight fall in crystallization temperature. The crystallization temperature ranges (ΔT_{C}) are −1.7 to +0.2° C. compared to the control (original crystalline resin), and the crystallization rate remained almost unchanged or rose slightly. Therefore, the compounds of Comparative Examples 100 to 114, which comprise a single ring, do not possess a function as a nucleating-effect-suppressor, and rather work as a nucleating agent.

Summarizing the results of Comparative Examples 23 to 114, it was shown that the compounds having a polycyclic structure wherein three or more ring structures are condensed to form condensed ring have a major nucleation suppressing effect, whereas those having three rings, which, however, are not condensed to form condensed ring, and those having two or less rings have almost no nucleation suppressing effect.

### Examples 101 to 180

It has been found that the compounds having a polycyclic structure wherein three or more ring structures are condensed to form condensed ring have a major nucleation suppressing effect; in Examples 101 to 180, the results of an investigation of compounds having a polycyclic structure wherein four or more ring structures are condensed to form condensed ring are shown. However, Examples 156 and 157 pertain to compounds wherein polycyclic structures with three ring structures condensed to form condensed ring are double bound directly to each other.

### Examples 101 to 125

Examples 101 to 125 pertain to Example Compounds 101 to 125, which have a polycyclic structure wherein four 5-, 6- or 7-membered rings are condensed to form condensed ring. The structures of the individual example compounds are as follows.

TABLE 14

| | Example | | | | | | | |
|---|---|---|---|---|---|---|---|---|
| Example | Compound | Basic Structure | T_{CP} | Δ T_{CP} | T_{CIP} | T_{CEP} | Δ T_{C} | Δ Δ T_{C} |
| Example101 | Example | Basic Structure63 | 223.0 | 9.8 | 229.6 | 216.4 | 13.2 | 3.7 |
| | Compound101 | | | | | | | |
| Example102 | Example | Basic Structure66 | 217.2 | 15.6 | 225.5 | 209.3 | 16.2 | 6.7 |
| | Compound102 | | | | | | | |
| ExampIe103 | Example | Basic Structure65 | 225.9 | 6.9 | 230.7 | 219.1 | 11.6 | 2.1 |
| | Compound103 | | | | | | | |
| Example104 | Example | Basic Structure67 | 224.7 | 8.1 | 229.1 | 217.4 | 11.7 | 2.2 |
| | Compound104 | | | | | | | |
| Example105 | Example | Basic Structure67 | 218.0 | 14.8 | 226.5 | 210.8 | 15.7 | 6.2 |
| | Compound105 | | | | | | | |
| Example106 | Example | Basic Structure68 | 217.9 | 14.9 | 226.4 | 210.8 | 15.6 | 6.1 |
| | Compound106 | | | | | | | |
| Example107 | Example | Basic Structure71 | 221.7 | 11.1 | 228.3 | 216.2 | 12.1 | 2.6 |
| | Compound107 | | | | | | | |
| Example108 | Example | Basic Structure72 | 219.6 | 13.2 | 228.0 | 213.6 | 14.4 | 4.9 |
| | Compound108 | | | | | | | |
| Example109 | Example | Basic Structure75 | 222.5 | 10.3 | 229.6 | 215.9 | 13.7 | 4.2 |
| | Compound109 | | | | | | | |
| Example110 | Example | Basic Structure77 | 224.1 | 8.7 | 230.1 | 217.0 | 13.1 | 3.6 |
| | Compound110 | | | | | | | |
| Example111 | Example | Basic Structure78 | 218.9 | 13.9 | 229.7 | 211.5 | 18.2 | 8.7 |
| | Compound111 | | | | | | | |
| Example112 | Example | Basic Structure62 | 226.5 | 6.3 | 231.9 | 219.5 | 12.4 | 2.9 |
| | Compound112 | | | | | | | |
| Example113 | Example | | 227.6 | 5.2 | 233.1 | 221.2 | 11.9 | 2.4 |
| | Compound113 | | | | | | | |
| Example114 | Example | | 227.0 | 5.8 | 232.1 | 220.1 | 12.0 | 2.5 |
| | Compound114 | | | | | | | |
| Example115 | Example | Basic Structure80 | 225.0 | 7.8 | 229.9 | 218.3 | 11.6 | 2.1 |
| | Compound115 | | | | | | | |
| Example116 | Example | Basic Structure81 | 224.4 | 8.4 | 230.8 | 218.0 | 12.8 | 3.3 |
| | Compound116 | | | | | | | |
| Example117 | Example | Basic Structure83 | 227.6 | 5.2 | 232.3 | 219.6 | 12.7 | 3.2 |
| | Compound117 | | | | | | | |
| Example118 | Example | Basic Structure92 | 227.5 | 5.3 | 232.2 | 219.9 | 12.3 | 2.8 |
| | Compound118 | | | | | | | |
| Example119 | Example | | 227.6 | 5.2 | 232.5 | 218.9 | 13.6 | 4.1 |
| | Compound119 | | | | | | | |
| Example120 | Example | Basic Structure89 | 224.9 | 7.9 | 230.8 | 218.1 | 12.7 | 3.2 |
| | Compound120 | | | | | | | |
| Example121 | Example | Basic Structure89 | 225.5 | 7.3 | 230.3 | 217.6 | 12.7 | 3.2 |
| | Compound121 | | | | | | | |
| Example122 | Example | Basic Structure86 | 226.3 | 6.5 | 231.8 | 219.4 | 12.4 | 2.9 |
| | Compound122 | | | | | | | |
| Example123 | Example | Basic Structure87 | 226.6 | 6.2 | 232.1 | 219.8 | 12.3 | 2.8 |
| | Compound123 | | | | | | | |
| Example124 | Example | Basic Structure87 | 226.0 | 6.8 | 232.6 | 221.1 | 11.5 | 2.0 |
| | Compound124 | | | | | | | |
| Example125 | Example | Basic Structure88 | 225.3 | 7.5 | 231.4 | 218.9 | 12.5 | 3.0 |
| | Compound125 | | | | | | | |

Unit: ° C.

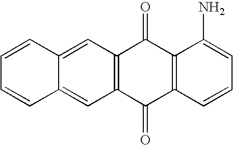

(Example Compound 101)

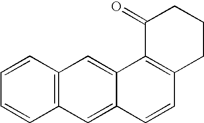

(Example Compound 102)

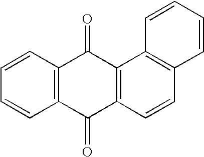

(Example Compound 103)

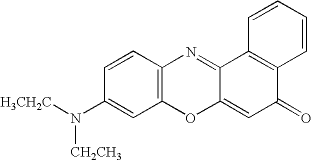

(Example Compound 104)

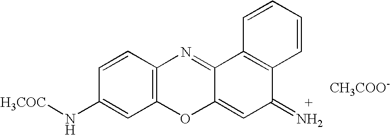

(Example Compound 105)

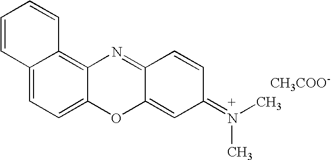

(Example Compound 106)

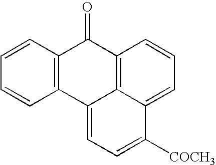

(Example Compound 107)

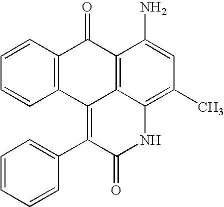

(Example Compound 108)

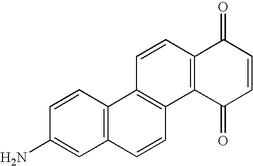

(Example Compound 109)

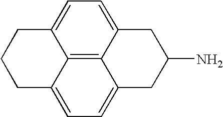

(Example Compound 110)

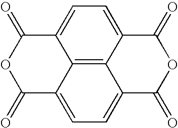

(Example Compound 111)

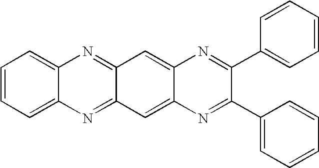

(Example Compound 112)

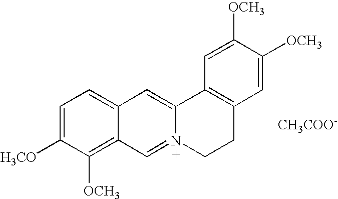

(Example Compound 113)

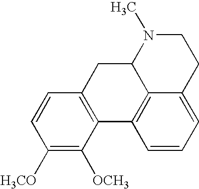

(Example Compound 114)

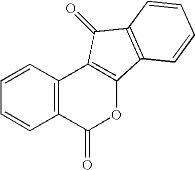

(Example Compound 115)

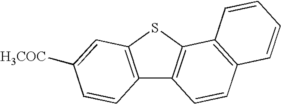

(Example Compound 116)

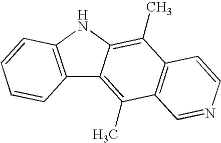

(Example Compound 117)

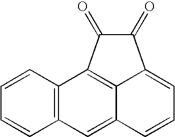

(Example Compound 118)

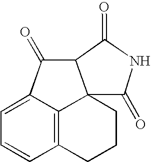

(Example Compound 119)

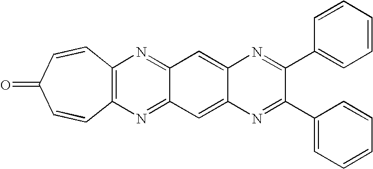

(Example Compound 120)

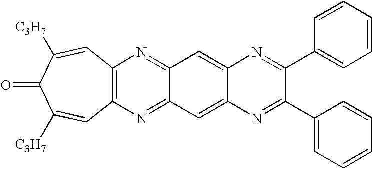

(Example Compound 121)

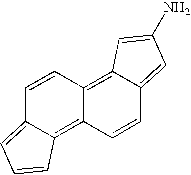

(Example Compound 122)

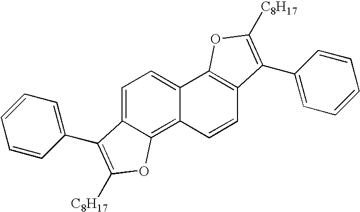

(Example Compound 123)

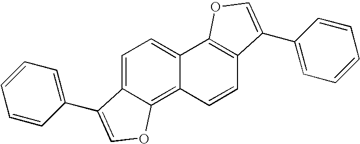

(Example Compound 124)

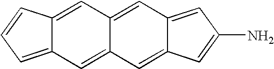

(Example Compound 125)

The crystallization temperature (T⁰_{CP}) of nylon 66 (control: original crystalline resin) is 232.8° C., and the crystallization temperature falls (ΔT_{CP}) in Examples 101 to 125 are +5.2 to +15.6° C.; the crystallization temperature fell significantly.

Also, the crystallization temperature ranges (ΔT_{C}) of Examples 101 to 125 expanded by +2.0 to +6.7° C. (ΔΔT_{C}) compared to the crystallization temperature range (ΔT⁰_{C}) of 9.5° C. of nylon 66 (control: original crystalline resin), showing that the crystallization rate fell significantly. Hence, the compounds of Examples 101 to 125 possess a remarkable function as a nucleating-effect-suppressor. That is, it was shown that the compounds having a polycyclic structure wherein four 5-, 6- or 7-membered rings are condensed to form condensed ring possess a function as a nucleating-effect-suppressor.

### Examples 126 to 148

Examples 126 to 148 pertain to Example Compounds 126 to 148, which have a polycyclic structure wherein five 5-membered or higher cyclic structures are condensed to form condensed ring. The structures of the individual example compounds are as follows.

TABLE 15

| Example | Example Compound | Basic Structure | T_{CP} | Δ T_{CP} | T_{CIP} | T_{CEP} | Δ T_{C} | Δ Δ T_{C} |
|---|---|---|---|---|---|---|---|---|
| Example 126 | Example Compound126 | Basic Structure94 | 227.3 | 5.5 | 232.0 | 220.1 | 11.9 | 2.4 |
| Example 127 | Example Compound127 | Basic Structure94 | 227.1 | 5.7 | 231.6 | 220.1 | 11.5 | 2.0 |
| Example 128 | Example Compound128 | Basic Structure96 | 225.7 | 7.1 | 230.8 | 218.1 | 12.7 | 3.2 |
| Example 129 | Example Compound129 | Basic Structure97 | 226.9 | 5.9 | 232.4 | 220.9 | 11.5 | 2.0 |
| Example 130 | Example Compound130 | Basic Structure98 | 226.5 | 6.3 | 231.7 | 219.7 | 12.0 | 2.5 |
| Example 131 | Example Compound131 | Basic Structure98 | 227.7 | 5.1 | 231.3 | 219.5 | 11.8 | 2.3 |
| Example 132 | Example Compound132 | Basic Structure98 | 225.4 | 7.4 | 231.6 | 219.2 | 12.4 | 2.9 |
| Example 133 | Example Compound133 | Basic Structure99 | 227.5 | 5.3 | 233.3 | 221.1 | 12.2 | 2.7 |
| Example 134 | Example Compound134 | Basic Structure100 | 227.4 | 5.4 | 232.4 | 220.7 | 11.7 | 2.2 |
| Example 135 | Example Compound135 | Basic Structure101 | 226.6 | 6.2 | 232.1 | 219.6 | 12.5 | 3.0 |
| Example 136 | Example Compound136 | Basic Structure102 | 227.6 | 5.2 | 232.9 | 221.0 | 11.9 | 2.4 |
| Example 137 | Example Compound137 | Basic Structure103 | 226.9 | 5.9 | 232.5 | 220.4 | 12.1 | 2.6 |
| Example 138 | Example Compound138 | Basic Structure105 | 223.6 | 9.2 | 229.4 | 215.1 | 14.3 | 4.8 |
| Example 139 | Example Compound139 | Basic Structure106 | 223.4 | 9.4 | 229.6 | 215.8 | 13.8 | 4.3 |
| Example 140 | Example Compound140 | Basic Structure107 | 225.6 | 7.2 | 229.7 | 217.6 | 12.1 | 2.6 |
| Example 141 | Example Compound141 | Basic Structure108 | 225.1 | 7.7 | 230.2 | 218.3 | 11.9 | 2.4 |
| Example 142 | Example Compound142 | Basic Structure109 | 223.6 | 9.2 | 228.6 | 215.5 | 13.1 | 3.6 |
| Example 143 | Example Compound143 | Basic Structure110 | 226.6 | 6.2 | 231.5 | 219.7 | 11.8 | 2.3 |
| Example 144 | Example Compound144 | Basic Structure112 | 226.0 | 6.8 | 230.3 | 218.0 | 12.3 | 2.8 |
| Example 145 | Example Compound145 | | 225.5 | 7.3 | 230.5 | 218.7 | 11.8 | 2.3 |
| Example 146 | Example Compound146 | | 227.7 | 5.1 | 232.8 | 220.6 | 12.2 | 2.7 |
| Example 147 | Example Compound147 | | 226.5 | 6.3 | 232.5 | 220.6 | 11.9 | 2.4 |
| Example 148 | Example Compound148 | Basic Structure104 | 223.6 | 9.2 | 229.9 | 216.5 | 13.4 | 3.9 |

Unit: ° C.

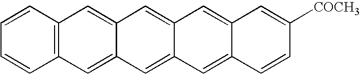

(Example Compound 126)

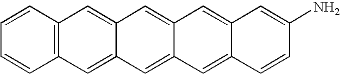

(Example Compound 127)

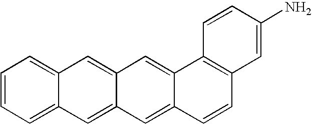

(Example Compound 128)

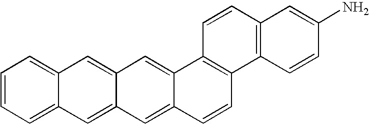

(Example Compound 129)

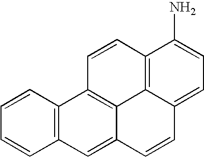

(Example Compound 130)

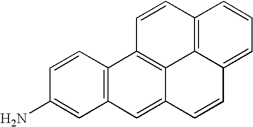

(Example Compound 131)

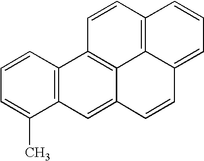

(Example Compound 132)

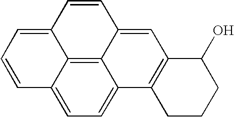

(Example Compound 133)

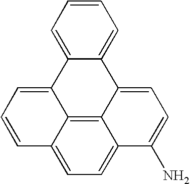

(Example Compound 134)

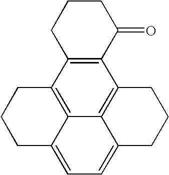

(Example Compound 135)

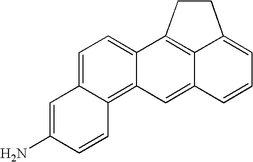

(Example Compound 136)

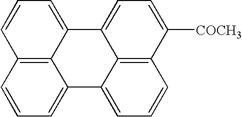

(Example Compound 137)

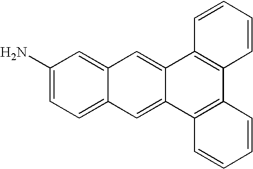

(Example Compound 138)

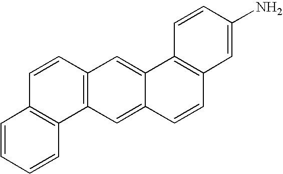

(Example Compound 139)

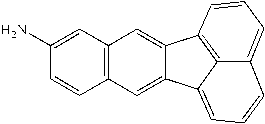

(Example Compound 140)

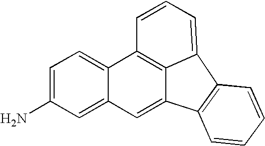

(Example Compound 141)

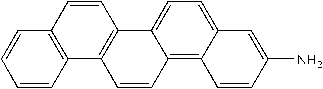

(Example Compound 142)

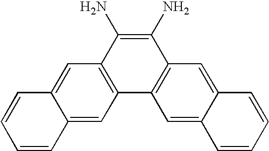

(Example Compound 143)

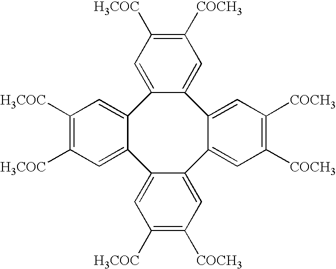

(Example Compound 144)

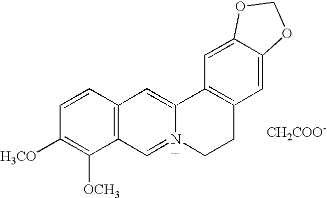

(Example Compound 145)

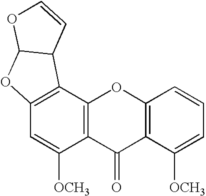

(Example Compound 146)

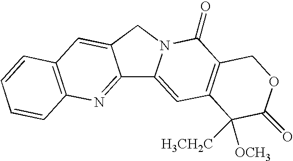

(Example Compound 147)

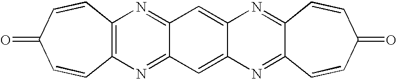

(Example Compound 148)

The crystallization temperature (T⁰_{CP}) of nylon 66 (control: original crystalline resin) is 232.8° C., and the crystallization temperature falls (ΔT_{CP}) in Examples 126 to 148 are +5.1 to +9.4° C.; the crystallization temperature fell significantly.

Also, the extrapolated crystallization temperature differences (ΔT_{C}) of Examples 126 to 148 expanded by +2.0 to +4.8° C. compared to the extrapolated crystallization temperature difference (ΔT⁰_{C}) of 9.5° C. of nylon 66 (control: original crystalline resin), showing that the crystallization rate fell significantly. Therefore, the compounds having a polycyclic structure wherein five 5-membered or higher cyclic structures are condensed to form condensed ring possess a remarkable function as a nucleating-effect-suppressor.

### Examples 149 to 180

Examples 149 to 180 pertain to Example Compounds 149 to 180, which have a polycyclic structure wherein six or more 5-membered or higher cyclic structures are condensed to form condensed ring. However, Examples 156 and 157 pertain to compounds wherein polycyclic structures with three ring structures condensed to form condensed ring are double bound directly to each other. The structures of the individual example compounds are as follows.

TABLE 16

| Example | Example Compound | Basic Structure | T_{CP} | Δ T_{CP} | T_{CIP} | T_{CEP} | Δ T_{C} | Δ Δ T_{C} |
|---|---|---|---|---|---|---|---|---|
| Example 149 | Example Compound149 | Basic Structure113 | 225.2 | 7.6 | 232.3 | 220.4 | 11.9 | 2.4 |
| Example 150 | Example Compound150 | Basic Structure114 | 27.2 | 5.6 | 233.1 | 220.5 | 12.6 | 3.1 |
| Example 151 | Example Compound151 | Basic Structure115 | 227.6 | 5.2 | 233.0 | 221.1 | 11.9 | 2.4 |
| Example 152 | Example Compound152 | Basic Structure123 | 227.7 | 5.1 | 232.7 | 220.2 | 12.5 | 3.0 |
| Example 153 | Example Compound153 | Basic Structure117 | 227.5 | 5.3 | 232.9 | 221.2 | 11.7 | 2.2 |
| Example 154 | Example Compound154 | Basic Structure124 | 227.0 | 5.8 | 232.1 | 220.1 | 12.0 | 2.5 |
| Example 155 | Example Compound155 | Basic Structure116 | 227.4 | 5.4 | 231.7 | 220.2 | 11.5 | 2.0 |
| Example 156 | Example Compound156 | | 223.3 | 9.5 | 230.3 | 214.2 | 16.1 | 6.6 |
| Example 157 | Example Compound157 | | 223.0 | 9.8 | 233.0 | 213.2 | 19.8 | 10.3 |
| Example 158 | Example Compound158 | | 226.2 | 6.6 | 231.3 | 219.4 | 11.9 | 2.4 |
| Example 159 | Example Compound159 | | 228.5 | 4.3 | 232.2 | 220.1 | 12.1 | 2.6 |
| Example 160 | Example Compound160 | | 227.6 | 5.2 | 231.6 | 219.8 | 11.8 | 2.3 |
| Example 161 | Example Compound161 | Basic Structure119 | 227.7 | 5.1 | 232.6 | 220.6 | 12.0 | 2.5 |
| Example 162 | Example Compound162 | Basic Structure118 | 227.6 | 5.2 | 233.0 | 220.7 | 12.3 | 2.8 |
| Example 163 | Example Compound163 | Basic Structure126 | 227.5 | 5.3 | 232.7 | 220.0 | 12.7 | 3.2 |
| Example 164 | Example Compound164 | Basic Structure125 | 227.7 | 5.1 | 232.6 | 221.1 | 11.5 | 2.0 |
| Example 165 | Example Compound165 | Basic Structure127 | 227.7 | 5.1 | 232.1 | 220.1 | 12.0 | 2.5 |
| Example 166 | Example Compound166 | Basic Structure128 | 227.4 | 5.4 | 232.5 | 220.8 | 11.7 | 2.2 |
| Example 167 | Example Compound167 | Basic Structure129 | 227.4 | 5.4 | 233.1 | 221.5 | 11.6 | 2.1 |
| Example 168 | Example Compound168 | Basic Structure120 | 226.0 | 6.8 | 232.0 | 219.9 | 12.1 | 2.6 |
| Example 169 | Example Compound169 | Basic Structure120 | 227.7 | 5.1 | 232.7 | 220.7 | 12.0 | 2.5 |
| Example 170 | Example Compound170 | Basic Structure121 | 227.7 | 5.1 | 232.4 | 220.6 | 11.8 | 2.3 |
| Example 171 | Example Compound171 | Basic Structure122 | 226.6 | 6.2 | 232.6 | 220.2 | 12.4 | 2.9 |
| Example 172 | Example Compound172 | Basic Structure122 | 226.1 | 6.7 | 233.0 | 221.4 | 11.6 | 2.1 |
| Example 173 | Example Compound173 | Basic Structure130 | 227.4 | 5.4 | 232.3 | 220.3 | 12.0 | 2.5 |
| Example 174 | Example Compound174 | Basic Structure131 | 227.7 | 5.1 | 232.1 | 219.9 | 12.2 | 2.7 |
| Example 175 | Example Compound175 | | 227.4 | 5.4 | 232.0 | 219.4 | 12.6 | 3.1 |
| Example 176 | Example Compound176 | | 227.0 | 5.8 | 231.6 | 219.9 | 11.7 | 2.2 |
| Example 177 | Example Compound177 | | 226.0 | 6.8 | 232.4 | 220.9 | 11.5 | 2.0 |
| Example 178 | Example Compound178 | | 225.6 | 7.2 | 231.6 | 219.5 | 12.1 | 2.6 |
| Example 179 | Example Compound179 | | 227.8 | 5.0 | 232.3 | 220.1 | 12.2 | 2.7 |
| Example 180 | Example Compound180 | | 227.8 | 5.0 | 232.7 | 221.2 | 11.5 | 2.0 |

Unit: ° C.

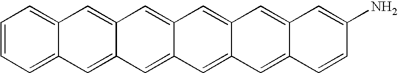

(Example Compound 149)

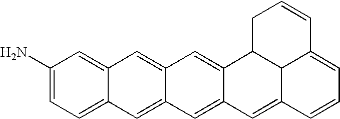

(Example Compound 150)

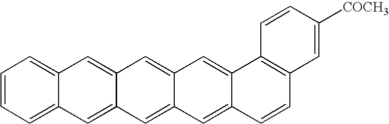

(Example Compound 151)

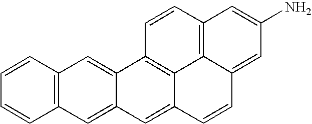

(Example Compound 152)

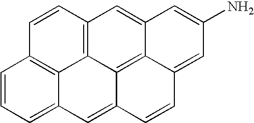

(Example Compound 153)

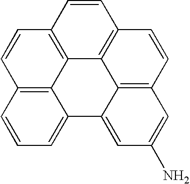

(Example Compound 154)

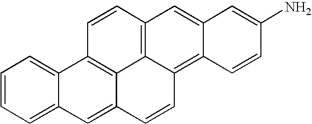

(Example Compound 155)

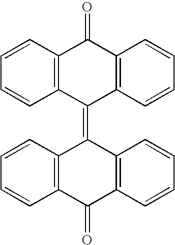

(Example Compound 156)

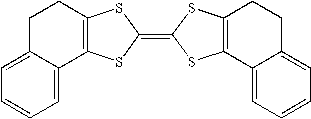

(Example Compound 157)

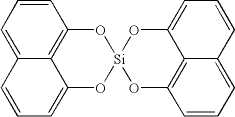

(Example Compound 158)

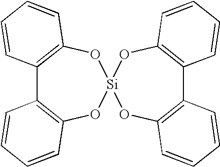

(Example Compound 159)

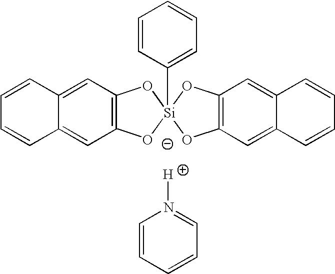

(Example Compound 160)

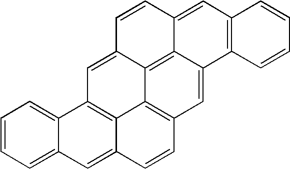

(Example Compound 161)

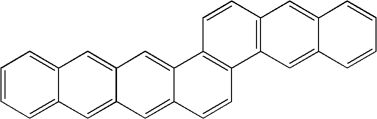

(Example Compound 162)

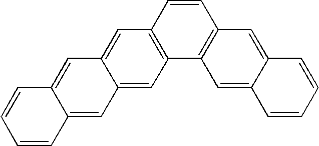

(Example Compound 163)

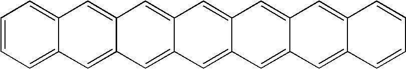

(Example Compound 164)

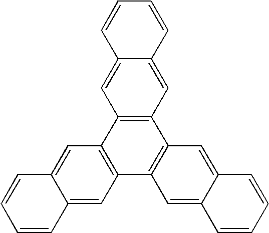

(Example Compound 165)

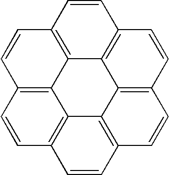

(Example Compound 166)

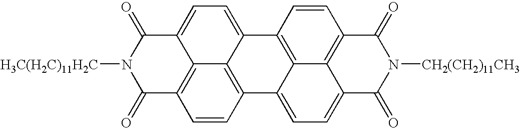

(Example Compound 167)

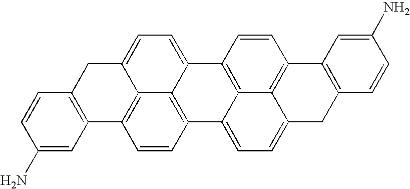

(Example Compound 168)

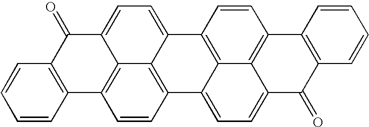

(Example Compound 169)

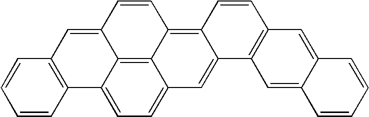

(Example Compound 170)

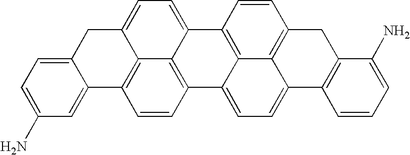

(Example Compound 171)

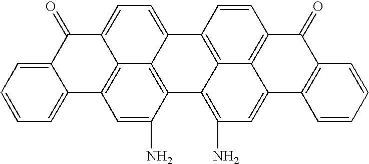

(Example Compound 172)

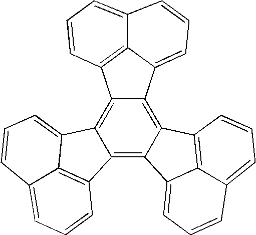

(Example Compound 173)

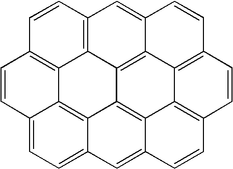

(Example Compound 174)

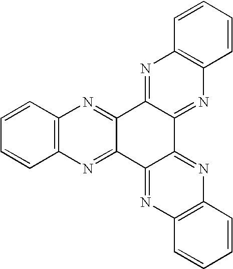

(Example Compound 175)

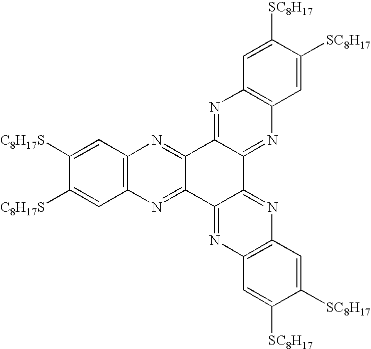

(Example Compound 176)

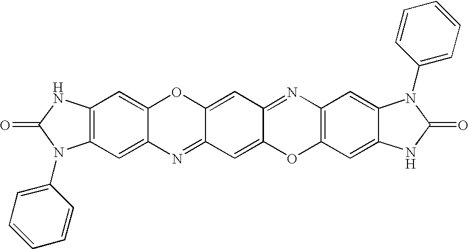

(Example Compound 177)

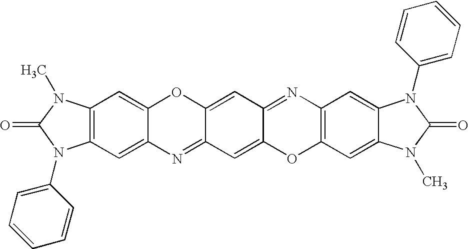

(Example Compound 178)

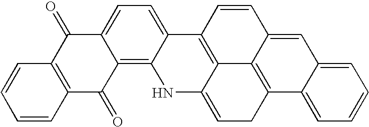

(Example Compound 179)

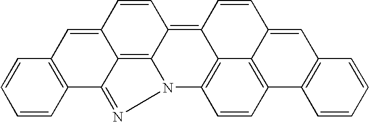

(Example Compound 180)

The crystallization temperature (T⁰_{CP}) of nylon 66 (control: original crystalline resin) is 232.8° C., and the crystallization temperature falls (ΔT_{CP}) in Examples 149 to 180 are +5.0 to +9.8° C.; the crystallization temperature fell significantly.

Also, the extrapolated crystallization temperature differences (ΔT_{C}) of Examples 149 to 180 expanded by +2.0 to +10.3° C. (ΔΔT_{C}) compared to the crystallization temperature range (ΔT⁰_{C}) of 9.5° C. of nylon 66 (control: original crystalline resin), showing that the crystallization rate fell significantly. Therefore, the compounds having a polycyclic structure wherein six or more 5-membered or higher cyclic structures are condensed to form condensed ring possess a remarkable function as a nucleating-effect-suppressor.

### Comparative Examples 115 and 116

In Examples 101 to 180, it has been shown that the compounds wherein four or more 5-membered or 6-membered rings are condensed to form condensed ring possess a remarkable function as a nucleating-effect-suppressor. On the other hand, a comparison is made by reference to compounds having four or more 5-membered or 6-membered rings and not having a polycyclic structure having three or more of them are condensed to form condensed ring, as comparative examples.

TABLE 17

| Comparative | Comparative Example | | | | | | |
|---|---|---|---|---|---|---|---|
| Example | Compound | T_{CP} | Δ T_{CP} | T_{CIP} | T_{CEP} | Δ T_{C} | Δ Δ T_{C} |
| Comparative | Comparative Example | 231.0 | 1.8 | 234.0 | 224.4 | 9.6 | 0.1 |
| Example 115 | Compound115 | | | | | | |
| Comparative | Comparative Example | 230.2 | 2.6 | 234.4 | 224.7 | 9.7 | 0.2 |
| Example 116 | Compound116 | | | | | | |

Unit: ° C.

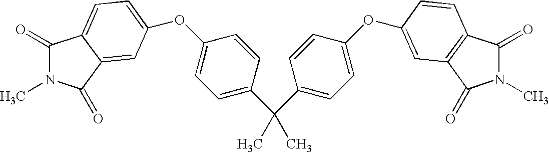

(Comparative Example Compound 115)

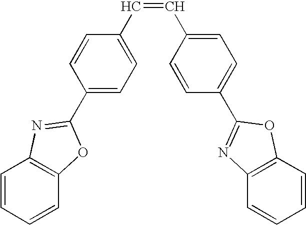

(Comparative Example Compound 116)

The crystallization temperature falls (ΔT_{CP}) of Comparative Examples 115 and 116 are +1.8 and +2.6° C.; there is almost no change or a slight fall in crystallization temperature. The crystallization temperature ranges (ΔT_{C}) are +0.1 to +0.2° C. (ΔΔT_{C}) compared to the control (original crystalline resin), and the crystallization rate remains almost unchanged. Therefore, the compounds of Comparative Examples 115 and 116 do not possess a function as a nucleating-effect-suppressor.

From the results of Examples 101 to 180, the compounds having a polycyclic structure wherein four or more 5-membered or higher cyclic structures are condensed to form condensed ring possessed a function as a nucleating-effect-suppressor. On the other hand, from the results of Comparative Examples 115 and 116, it is found that the compounds having four or more 5-membered or 6-membered rings and not having a polycyclic structure having three or more of them are condensed to form condensed ring, do not possess a function of a nucleating-effect-suppressor.

From evaluations conducted on polycyclic structure compounds wherein various cyclic structures are condensed to form condensed ring, and compounds having a polycyclic structure with various substituents introduced thereto, using a differential scanning calorimeter, the following was revealed. That is, the compounds having a polycyclic structure wherein three or more 4-membered or higher cyclic structures are condensed to form condensed ring, when contained in a crystalline composition, are capable of effectively lowering the crystallization point (crystallization temperature) and crystallization rate of the crystalline composition, and are also capable of lengthening the nucleation induction period thereof, and hence effectively work as materials that suppress the nucleating effect. On the other hand, those having two or less cyclic structures condensed to form condensed ring and those having three or more cyclic structures, none of which, however, are condensed to form condensed ring, are incapable of lowering the crystallization rate.

### Example 181

Using 100 parts of nylon 66 as the crystalline resin and 2.5 parts of each of 4,7-dimethyl-1,10-phenanthrolin, 6,7-dihydro-5,8-dimethyl[b,j][1,10]phenanthrolin, 4-methyl-1,10-phenanthrolin and 3,4,7,8-tetramethyl-1,10-phenanthrolin as the nucleating-effect-suppressor, a measuring sample was obtained by the aforementioned cast method. Example Compound 181, which is the nucleating-effect-suppressor in this Example, is a mixture of compounds of the following structures, each of which has a function as a nucleating-effect-suppressor.

TABLE 18

| Example | Example Compound | T_{CP} | Δ T_{CP} | T_{CIP} | T_{CEP} | Δ T_{C} | Δ Δ T_{C} |
|---|---|---|---|---|---|---|---|
| Example 181 | Example Compound181 | 218.3 | 14.5 | 227.9 | 209.4 | 18.5 | 9.0 |

Unit: ° C.

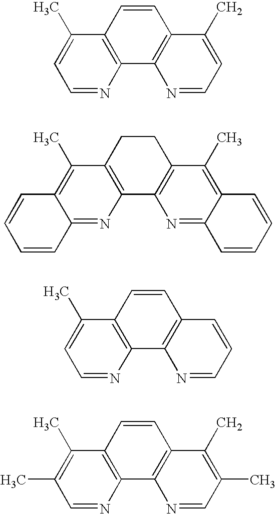

(Example Compound 181: A mixture of Example Compound 36, Example
Compound 45, Example Compound 37 and Example Compound 40)

The crystallization temperature (T⁰_{CP}) of nylon 66 (control: original crystalline resin) is 232.8° C., and the crystallization temperature fall (ΔT_{CP}) in Example 181 is +14.5° C.

Also, the crystallization temperature range (ΔT_{C}) of Example 181 expanded by +9.0° C. compared to the crystallization temperature range (ΔT⁰_{C}) of 9.5° C. of nylon 66 (control: original crystalline resin), showing that the crystallization rate fell significantly. Therefore, the aforementioned mixture of compounds possesses a remarkable function as a nucleating-effect-suppressor.

### Examples 182 to 187

Examples 182 to 187 pertain to Example Compounds 182 to 187, which have a structure of a salt of a compound having a polycyclic structure and possessing a function as a nucleating-effect-suppressor, and a sulfonic acid or a carboxylic acid. The structures of the individual example compounds are as follows.

TABLE 19

| Example | Example Compound | T_{CP} | Δ T_{CP} | T_{CIP} | T_{CEP} | Δ T_{C} | Δ Δ T_{C} |
|---|---|---|---|---|---|---|---|
| Example 182 | Example Compound182 | 217.7 | 15.1 | 228.1 | 209.5 | 18.6 | 9.1 |
| Example 183 | Example Compound183 | 215.4 | 17.4 | 226.7 | 209.5 | 17.2 | 7.7 |
| Example 184 | Example Compound184 | 217.4 | 15.4 | 228.3 | 208.7 | 19.6 | 10.1 |
| Example 185 | Example Compound185 | 219.6 | 13.2 | 228.4 | 211.9 | 16.5 | 7.0 |
| Example 186 | Example Compound186 | 217.1 | 15.7 | 227.0 | 209.7 | 17.3 | 7.8 |
| Example 187 | Example Compound187 | 218.2 | 14.6 | 228.8 | 209.9 | 18.9 | 9.4 |

Unit: ° C.

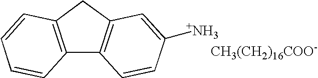

(Example Compound 182)

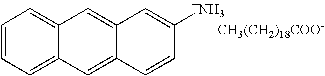

(Example Compound 183)

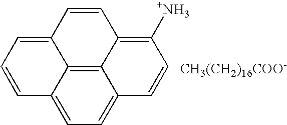

(Example Compound 184)

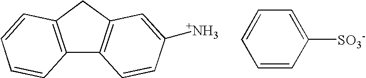

(Example Compound 185)

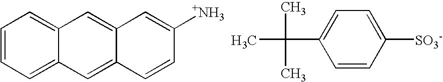

(Example Compound 186)

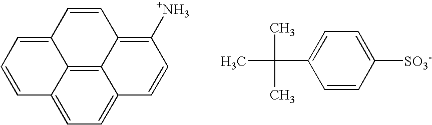

(Example Compound 187)

The crystallization temperature (T⁰_{CP}) of nylon 66 (control: original crystalline resin) is 232.8° C., and the crystallization temperature falls (ΔT_{CP}) in Examples 182 to 187 are +13.2 to +17.4° C.

Also, the crystallization temperature ranges (ΔT_{C}) of Examples 182 to 187 expanded by +7.0 to +10.11° C. (ΔΔT_{C}) compared to the crystallization temperature range (ΔT⁰_{C}) of 9.5° C. of nylon 66 (control: original crystalline resin), showing that the crystallization rate fell significantly. Therefore, these compounds possess a remarkable function as a nucleating-effect-suppressor.

### Comparative Examples 117 to 125

Comparative Examples 117 to 125 pertain to long-chain aliphatic compounds. The structures of the individual comparative example compounds are as follows.

TABLE 20

| | Comparative Example | | | | | | |
|---|---|---|---|---|---|---|---|
| Comparative Example | Compound | T_{CP} | Δ T_{CP} | T_{CIP} | T_{CEP} | Δ T_{C} | Δ Δ T_{C} |
| Comparative Example | Comparative Example | 231.6 | 1.2 | 234.1 | 224.7 | 9.4 | −0.1 |
| 117 | Compound117 | | | | | | |
| Comparative Example | Comparative Example | 231.3 | 1.5 | 234.1 | 224.3 | 9.8 | 0.3 |
| 118 | Compound118 | | | | | | |
| Comparative Example | Comparative Example | 231 | 1.8 | 233.8 | 224.3 | 9.5 | 0 |
| 119 | Compound119 | | | | | | |
| Comparative Example | Comparative Example | 231.1 | 1.7 | 234.3 | 224.5 | 9.8 | 0.3 |
| 120 | Compound120 | | | | | | |
| Comparative Example | Comparative Example | 231.8 | 1 | 234.5 | 224.7 | 9.8 | 0.3 |
| 121 | Compound121 | | | | | | |
| Comparative Example | Comparative Example | 230.9 | 1.9 | 233.8 | 224.4 | 9.4 | −0.1 |
| 122 | Compound122 | | | | | | |
| Comparative Example | Comparative Example | 230 | 2.8 | 234.5 | 222.9 | 11.6 | 2.1 |
| 123 | Compound123 | | | | | | |
| Comparative Example | Comparative Example | 232.6 | 0.2 | 234.8 | 225.4 | 9.4 | −0.1 |
| 124 | Compound124 | | | | | | |
| Comparative Example | Comparative Example | 232.1 | 0.7 | 234.4 | 225.2 | 9.2 | −0.3 |
| 125 | Compound125 | | | | | | |

Unit: ° C.
CH₃(CH₂)₁₆COOH
(Comparative Example Compound 117)
CH₃(CH₂)₁₈COOH
(Comparative Example Compound 118)
CH₃(CH₂)₂₀COOH
(Comparative Example Compound 119)

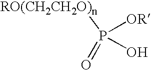

(Comparative Example Compound 120)

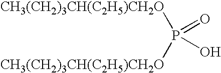

(Comparative Example Compound 121)

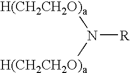

(Comparative Example Compound 122)

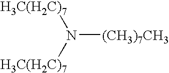

(Comparative Example Compound 123)

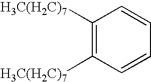

(Comparative Example Compound 124)

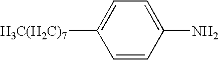

(Comparative Example Compound 125)

Comparative Example Compound 120 is PLYSURF A215C (trade name), manufactured by Dai-ichi Kogyo Seiyaku Co., Ltd., and Comparative Example Compound 122 is AMILADIN (trade name), manufactured by Dai-ichi Kogyo Seiyaku Co., Ltd. In Comparative Example Compounds 120 and 122, R represents an alkyl group or an alkylallyl group, n represents the molar number of ethylene oxide added, and R represents H or R (CH₂CH₂O)ₙ.

The crystallization temperature falls (ΔT_{CP}) of Comparative Examples 117 to 125 are +0.2 to +2.8° C.; there is almost no change or a slight fall in crystallization temperature. Also, the crystallization temperature ranges (ΔT_{C}) of Comparative Examples 117 to 125 are −0.3 to +2.1° C. (ΔΔT_{C}) compared to the control (original crystalline resin), and the crystallization rate remained almost unchanged or rose slightly. Therefore, the compounds of Comparative Examples 117 to 125 do not possess a function as a nucleating-effect-suppressor.

### Examples 188 to 191

In Examples 188 to 191, polybutylene terephthalate resin [manufactured by Du Pont, trade name: CRASTIN 6130NC] was used as the crystalline resin and Example Compounds 188 to 191, which have a polycyclic structure wherein 5-membered or 6-membered rings are condensed to form condensed ring, were used as the nucleating-effect-suppressors. The structures of the individual example compounds are as follows.

100 parts of purified PBT (polybutylene terephthalate resin [crystalline resin]) and 10 parts of the nucleating-effect-suppressor of the present invention (example compounds shown in Table 21) were dissolved in 1,1,1,3,3,3-hexafluoro-2-propanol with heating. This was placed in a petri dish, allowed to stand at room temperature to evaporate the 1,1,1,3,3,3 -hexafluoro-2-propanol, and then was dried using a vacuum dryer at 70° C. for 15 hours or longer to yield a measuring sample. For control, after the purified PBT alone was dissolved in 1,1,1,3,3,3-hexafluoro-2-propanol with heating, the solution was placed in a petri dish and allowed to stand at room temperature. After the 1,1,1,3,3,3-hexafluoro-2-propanol was evaporated, it was dried using a vacuum dryer at 70° C. for 15 hours or longer to yield a control sample (cast method).

For each measuring sample and control sample, thermal analysis to measure the crystallization temperature (T_{CP}), extrapolated crystallization initiation temperature (T_{CIP}) and extrapolated crystallization end temperature (T_{CEP}) was conducted using a differential scanning calorimeter (manufactured by SEIKO INSTRUMENTS INC., trade name: DSC6200, COOLING CONTROLLER). In this thermal analysis, a cycle of heating from 20° C. to 245° C. at 20° C./min, maintaining 245° C. for 3 minutes, and then cooling from 245° C. to 20° C. at 10° C./min, was repeated five times. From the measurement data of extrapolated crystallization initiation temperature (T_{CIP}) and extrapolated crystallization end temperature (T_{CEP}) obtained for each measuring sample, the crystallization temperature range (ΔT_{C}) [difference between extrapolated crystallization end temperature and extrapolated crystallization initiation temperature] was calculated. Likewise, for the control sample, the crystallization temperature (T⁰_{CP}), extrapolated crystallization initiation temperature (T⁰_{CIP}) and the extrapolated crystallization end temperature (T⁰_{CEP}) were measured, and the crystallization temperature range (ΔT⁰_{C}) was calculated.

Crystallization temperature falls were judged by ΔT_{CP} (ΔT_{CP}=T⁰_{CP}−T_{CP}) and crystallization rate falls were judged by comparing ΔT_{C} and A T⁰_{C}(ΔΔT_{C}=T_{C}−T⁰_{C}).

TABLE 21

| Example | Example Compound | T_{CP} | Δ T_{CP} | T_{CIP} | T_{CEP} | Δ T_{C} | Δ Δ T_{C} |
|---|---|---|---|---|---|---|---|
| Crystalline resin | No additive | 183.6 | | 190.7 | 177.7 | 13.0 | |
| Example 188 | Example Compound45 | 180.2 | 3.4 | 187.6 | 173.2 | 14.4 | 1.4 |
| Example 189 | Example Compound133 | 178.8 | 4.8 | 186.9 | 172.3 | 14.6 | 1.6 |
| Example 190 | Example Compound110 | 178.3 | 5.3 | 187.2 | 172.7 | 14.5 | 1.5 |
| Example 191 | Example Compound136 | 179.5 | 4.1 | 187.3 | 172.9 | 14.4 | 1.4 |

Unit: ° C.

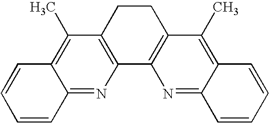

(Example Compound 45)

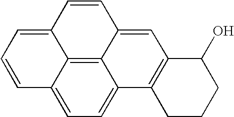

(Example Compound 133)

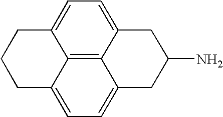

(Example Compound 110)

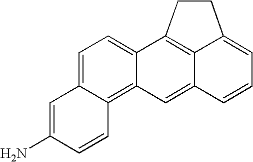

(Example Compound 136)

The crystallization temperature (T⁰_{CP}) of PBT (control: original crystalline resin) is 183.6° C., and the crystallization temperature falls (ΔT_{CP}) in Examples 188 to 191 are +3.4 to +5.3° C.

Also, the crystallization temperature ranges (ΔT_{C}) of Examples 188 to 191 expanded by +1.4 to +1.6° C. (ΔΔT_{C}) compared to the crystallization temperature range (ΔT⁰_{C}) of 13.0° C. of PBT (control: original crystalline resin), showing that the crystallization rate fell. Therefore, these compounds possess a function as a nucleating-effect-suppressor.

### Examples 192 to 194 and Comparative Examples 126 to 128

In Examples 192 to 194 and Comparative Examples 126 to 128, glass-fiber-reinforced nylon 66 (a fiber-reinforced polyamide resin having a mixing ratio by weight of polyamide resin:glass fiber=67:33 (manufactured by Du Pont, trade name: 70G33L)) was used as the crystalline resin, Example Compounds 36, 29 and 34 (Comparative Example Compounds 126 to 128) as the nucleating-effect-suppressors were added thereto, and a molded plate was obtained by injection molding. This molded plate and a molded plate obtained from glass-fiber-reinforced nylon 66 (original crystalline resin) alone by injection molding were compared in terms of appearance and gloss.

Injection molding was conducted as described below. To 500 g of the aforementioned glass-reinforced nylon 66, 5 g of any one of Example Compounds 36, 29 and 34 and Comparative Example Compounds 126 to 128 was added, these ingredients were stirred and blended in a stainless steel tumbler for 20 minutes, and the obtained mixture was injection-molded at a nozzle temperature of 300° C. and a mold temperature of 80° C. (other molding conditions according to the ordinary method) using an injection molding machine (manufactured by KAWAGUCHI, Ltd., trade name: KM-50C). For the obtained test piece [49×79×3 mm], glossiness was determined and appearance was evaluated; the results are shown in Table 22.

Glossiness Test and Evaluation

Glossiness was determined by measuring the gloss value at an angle of incidence of 60 degrees with respect to the test piece using a glossmeter (manufactured by Suga Test Instruments Co., Ltd., trade name: HG-268). The measurement site in the test piece was at the center of the molded product.

Generally, those having high gloss values are judged to be high in surface smoothness and rich in surface gloss. Also, by this test, not only the smoothness of the test piece, but also the phenomenon in which a fibrous reinforcing material such as glass fiber floats in a fiber-reinforced crystalline resin, can be grasped.

### Example Compounds and Comparative Example Compounds

Example 192: 4,7-Dimethyl-1,10-phenanthrolin (Example Compound 36)
Example 193: 3-Naphthoflavon (Example Compound 29)
Example 194: Acridine orange base (Example Compound 34)
Comparative Example 126: 1,2-Diphenylindol (Comparative Example Compound 126)
Comparative Example 127: 2,3-Diphenylquinoxaline (Comparative Example Compound 127)

Comparative Example 128: N-phenyl-2-naphthylamine (Comparative Example Compound 128)

TABLE 22

| Example | Example Compound | Surface glossiness | | Appearance |
|---|---|---|---|---|
| Crystalline | No additive | 61.94 | 100.0% | |
| resin | | | | |
| Example 192 | Example Compound 36 | 76.16 | 123.0% | Good |
| Example 193 | Example Compound 29 | 68.60 | 111.0% | Good |
| Example 194 | Example Compound 34 | 69.18 | 112.0% | Good |
| Comparative | Comparative Example | 59.78 | 96.5% | White float |
| Example 126 | Compound 126 | | | of glass |
| Comparative | Comparative Example | 63.85 | 103.0% | White float |
| Example 127 | Compound 127 | | | of glass |
| Comparative | Comparative Example | 63.05 | 102.0% | White float |
| Example 128 | Compound 128 | | | of glass |

In Examples 192 to 194, glossiness improved considerably compared to the original glass-fiber-reinforced nylon 66. It is considered that because the period in which the crystalline resin is molten at a constant mold temperature (80° C.) lengthens due to a crystallization temperature fall by the nucleating-effect-suppressor of the present invention, surface gloss improves.

### Example 195 to Example 201 and Comparative Example 129

Film-like measuring samples obtained by the aforementioned cast method using nylon 66 and the following example compounds, and a film-like control sample obtained by the cast method using nylon 66 alone were compared in terms of the number of sphaerocrystals.

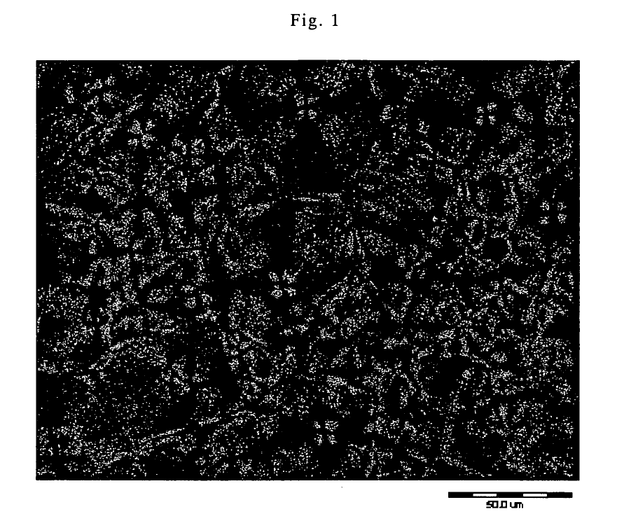

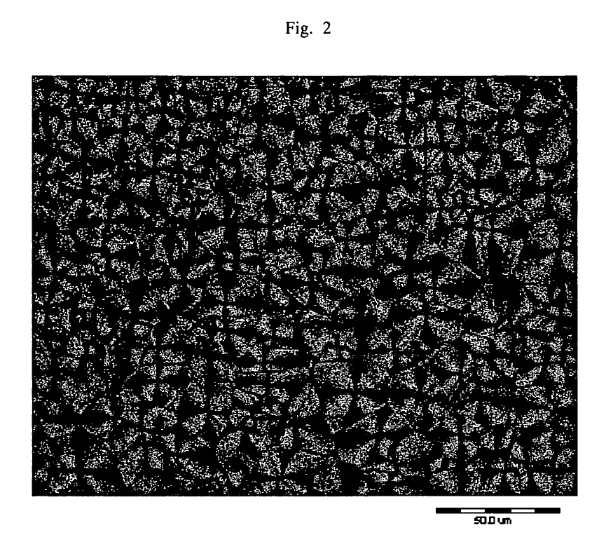

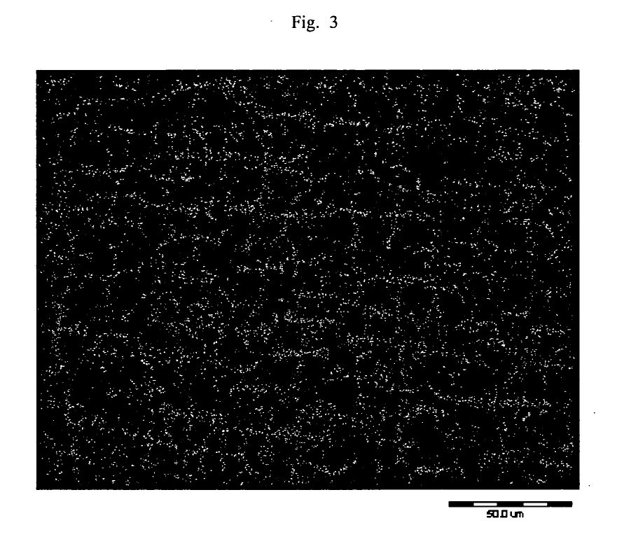

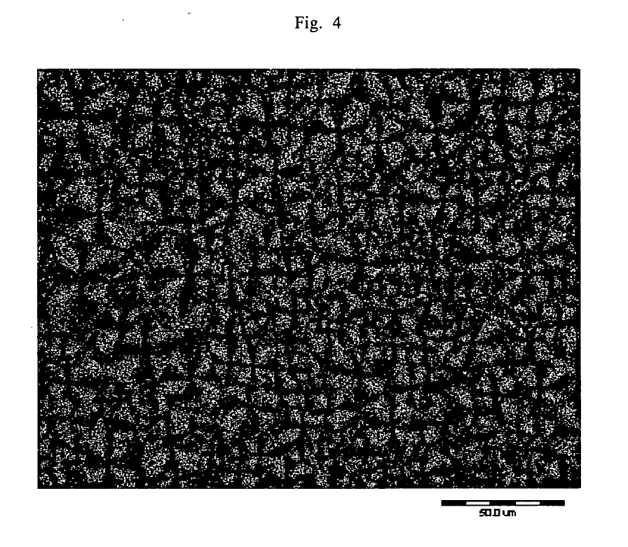

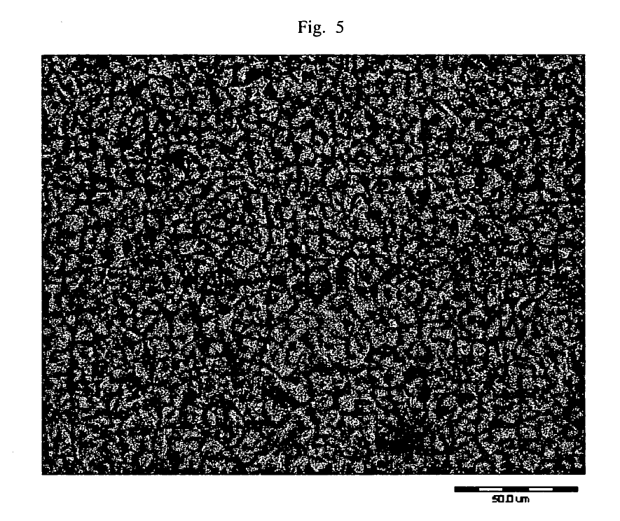

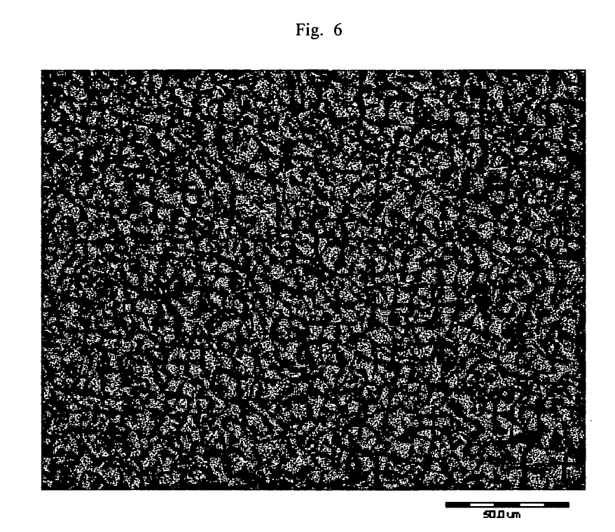

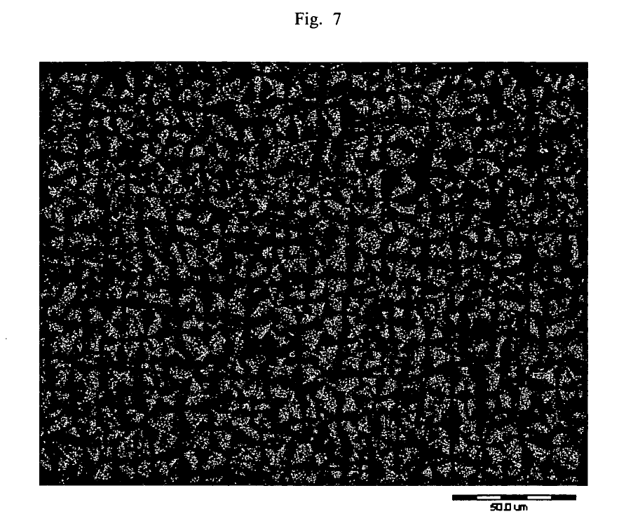

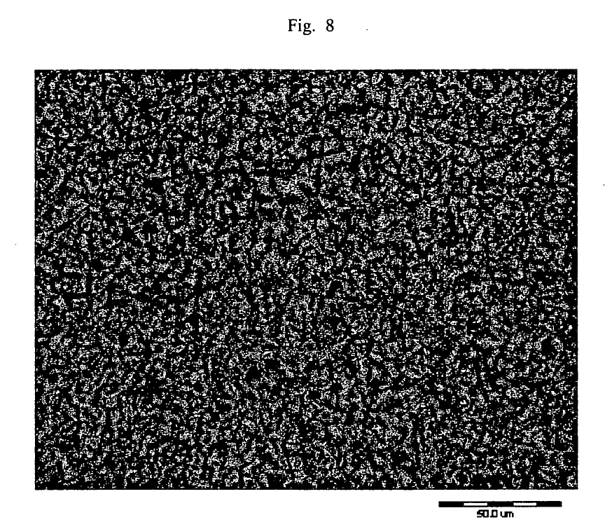

The number of sphaerocrystals was counted as described below. That is, each of the film-like measuring samples and control sample obtained using the aforementioned cast method was inserted between a slide glass and a cover glass and heated on a hot plate. When each film-like sample melted, it was pressed and then allowed to cool at room temperature. After being cool to room temperature, each sample was examined using a polarizing plate under a light microscope. The results of this observation are shown in Table 23. FIG. 1 to FIG. 7 and FIG. 8 are photomicrographs in Examples 195 to 201 and Comparative Example 129, respectively. Note that the scale in the lower right of each photograph is graduated in 10 μm for each division and 50 μm for a total of five divisions. By this, it was confirmed that the sizes of sphaerocrystals in a crystalline resin composition containing a nucleating-effect-suppressor are larger than the sizes of sphaerocrystals in the original crystalline resin, which does not contain the nucleating-effect-suppressor.

Samples Used
Example 195: 4,7-Dimethyl-1,10-phenanthrolin (Example Compound 36)
Example 196: 1-Aminopyrene (Example Compound 15)
Example 197: 1-Aminoanthracene (Example Compound 1)
Example 198: 2-Acetylfluorene (Example Compound 54)
Example 199: 2,9-Dimethyl-4,7-diphenyl-1,10-phenanthrolin (Example Compound 41)
Example 200: 3,4,7,8-Tetramethyl-1,10-phenanthrolin (Example Compound 40)
Example 201: 2-Aminoanthracene (Example Compound 9)
Comparative Example 129: Original crystalline resin Comparative Example 130: 1-Aminonaphthalene (Comparative Example Compound 1)
Comparative Example 131: 2-Aminonaphthalene (Comparative Example Compound 2)
Comparative Example 132: 4,4′-Dimethyl-2,2′-dipyridyl (Comparative Example Compound 12)

Comparative Example 133: 2,2′-Biquinoline (Comparative Example Compound 13)

TABLE 23

| | Example | | | | |
|---|---|---|---|---|---|
| Example | Compound | Amount | Number/36345 μm² | | Tcp[° C.] |
| Example 195 | Example | 10 parts | 40 | 15.6% | 213.8 |
| | Compound 36 | | | | |
| Example 196 | Example | 10 parts | 107 | 42.8% | 218.9 |
| | Compound 15 | | | | |
| Example 197 | Example | 10 parts | 120 | 46.9% | 219.6 |
| | Compound 1 | | | | |
| Example 198 | Example | 30 parts | 135 | 52.7% | 221.7 |
| | Compound 54 | | | | |
| Example 199 | Example | 10 parts | 164 | 64.1% | 215.8 |
| | Compound 41 | | | | |
| Example 200 | Example | 10 parts | 191 | 74.6% | 222.3 |
| | Compound 40 | | | | |
| Example 201 | Example | 10 parts | 191 | 74.6% | 221.0 |
| | Compound 9 | | | | |
| Comparative | Crystalline | | 256 | 100.0% | 232.8 |
| Example 129 | resin | | | | |
| Comparative | Comparative | 10 parts | 269 | 105.1% | 232.2 |
| Example 130 | Example | | | | |
| | Compound 1 | | | | |
| Comparative | Comparative | 10 parts | 278 | 108.6% | 232.0 |
| Example 131 | Example | | | | |
| | Compound 2 | | | | |
| Comparative | Comparative | 10 parts | 271 | 105.9% | 231.6 |
| Example 132 | Example | | | | |
| | Compound 12 | | | | |
| Comparative | Comparative | 10 parts | 276 | 107.8% | 231.9 |
| Example 133 | Example | | | | |
| | Compound 13 | | | | |

As shown in Table 23, by containing the nucleating-effect-suppressor of the present invention, the number of sphaerocrystals of a crystalline resin composition decreases. From this fact, it is considered that crystal nuclei are more unlikely to occur in crystalline resin compositions containing the nucleating-effect-suppressor of the present invention.

1-75. (canceled)

76. A method of controlling the crystallization of a crystalline resin composition,
wherein by containing one kind or more of a nucleating-effect-suppressor comprising any of the compounds having at least one structure selected from among polycyclic structures wherein three or more 4-membered or higher cyclic structures are condensed to form condensed ring, excluding nigrosine, aniline black and copper phthalocyanine derivatives, in a crystalline resin, the crystallization temperature and crystallization rate of a crystalline resin composition containing the nucleating-effect-suppressor are lowered compared to the crystallization temperature and crystallization rate of a crystalline resin in the crystalline resin composition, which does not contain the aforementioned nucleating-effect-suppressor.

77. The method of controlling the crystallization of claim 76, wherein at least one of said polycyclic structures is a structure selected from among Skeletal Structures enumerated below, and the individual bonds that constitute each skeletal structure are single or double bonds.

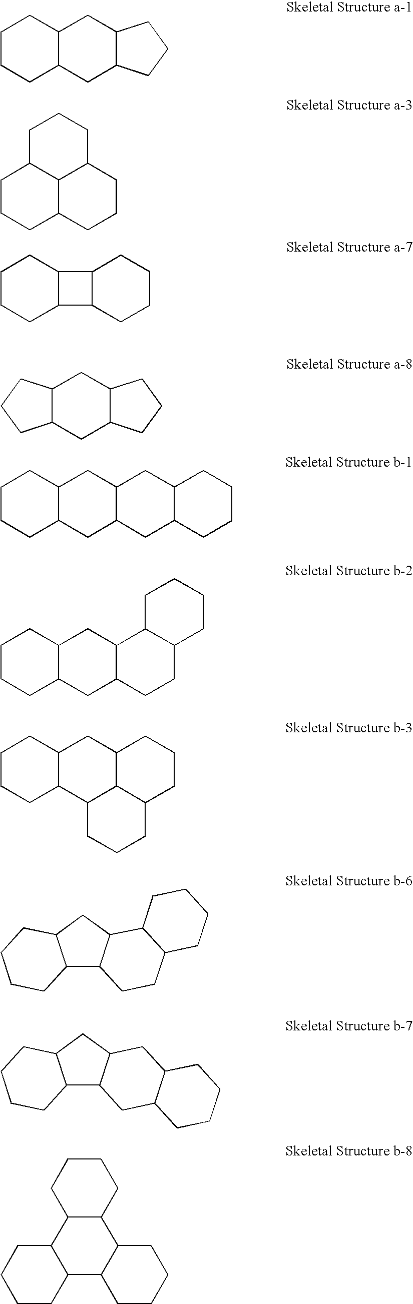

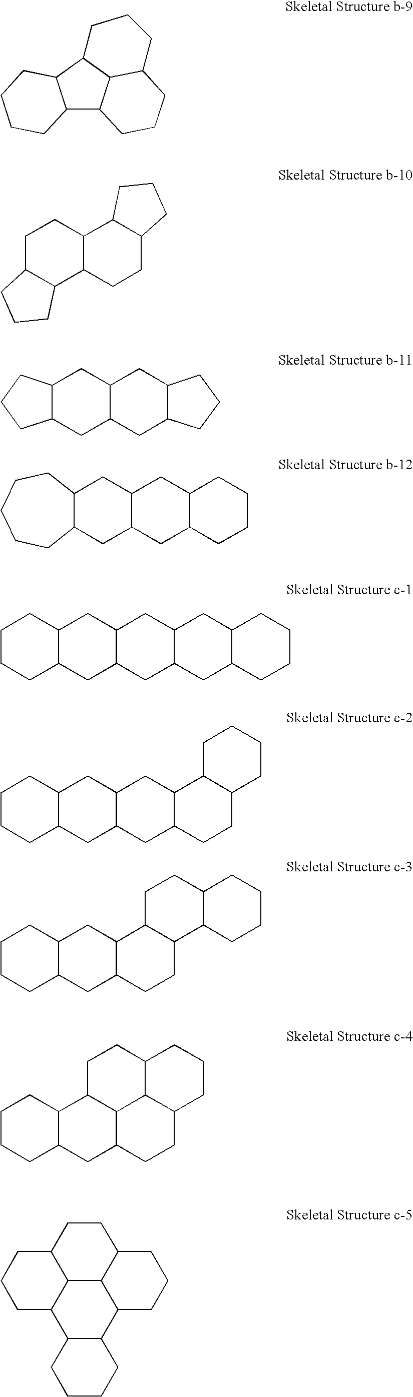

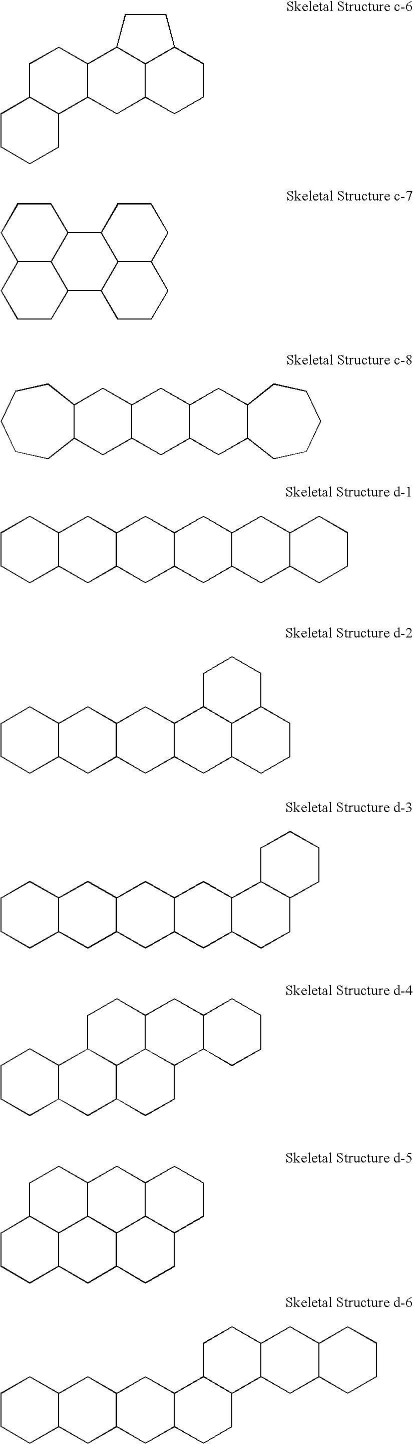

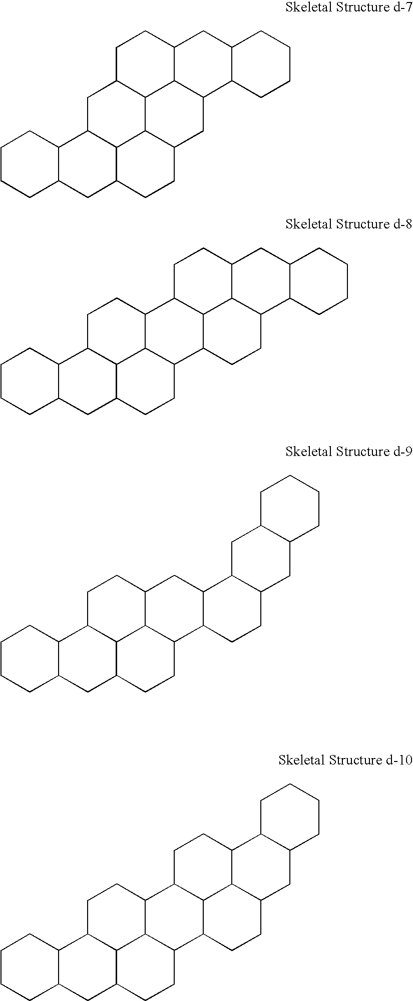

78. The method of controlling the crystallization of claim 76, wherein at least one of said polycyclic structures is a structure selected from among Basic Structures enumerated below.

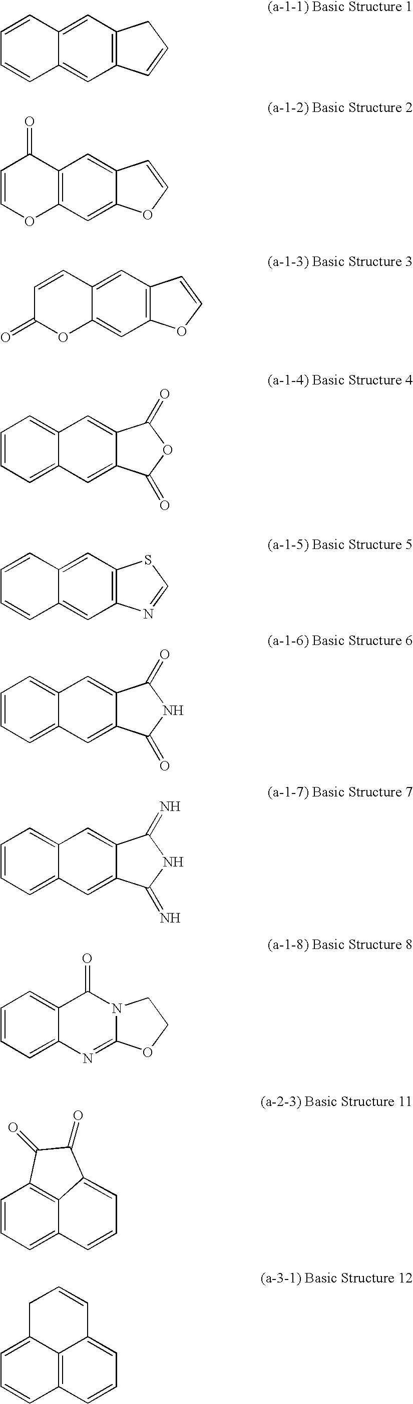

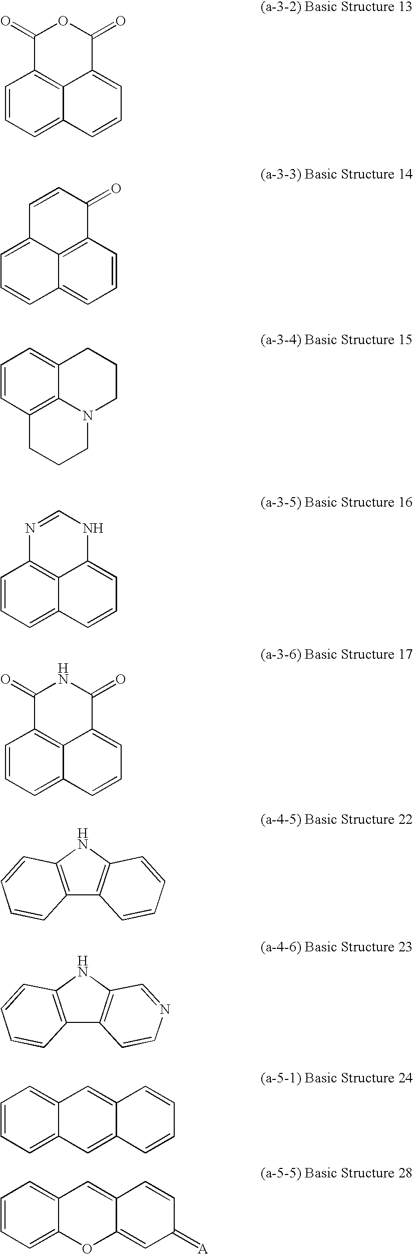

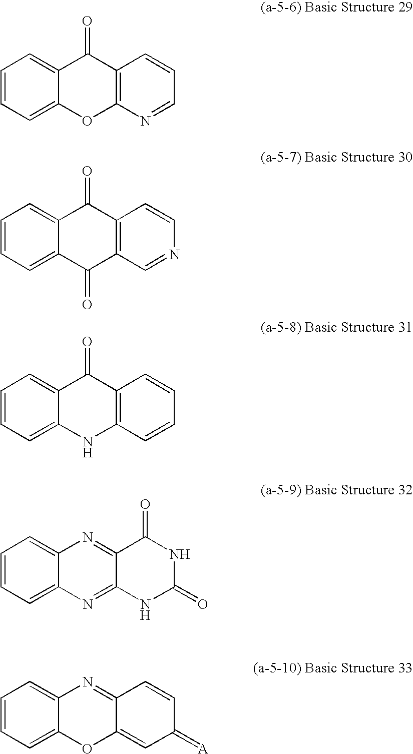

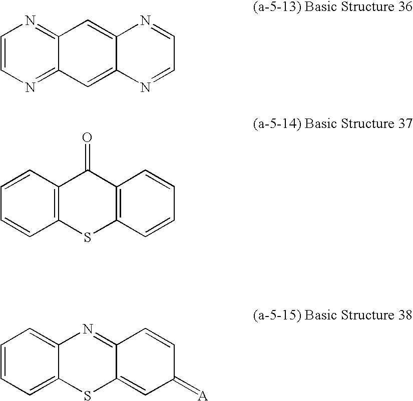

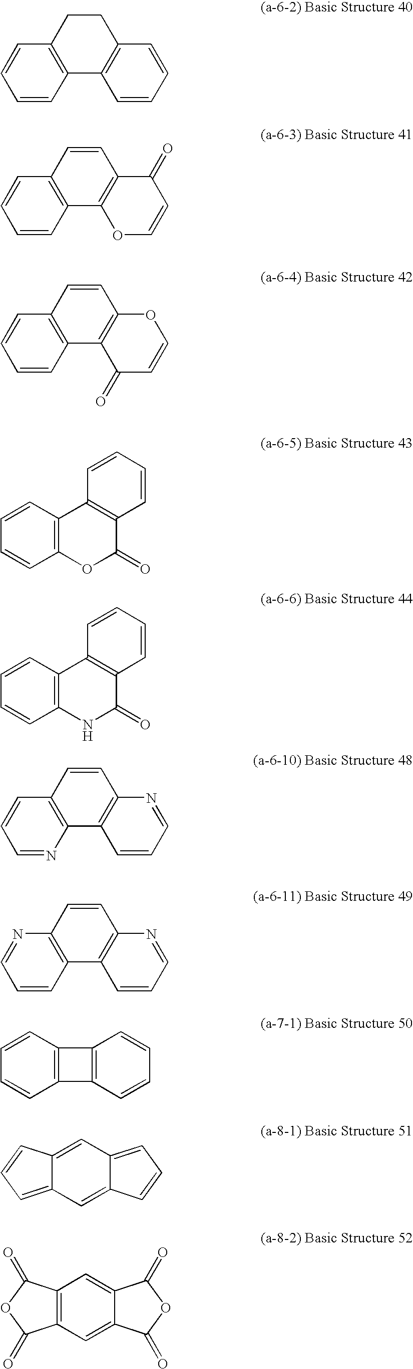

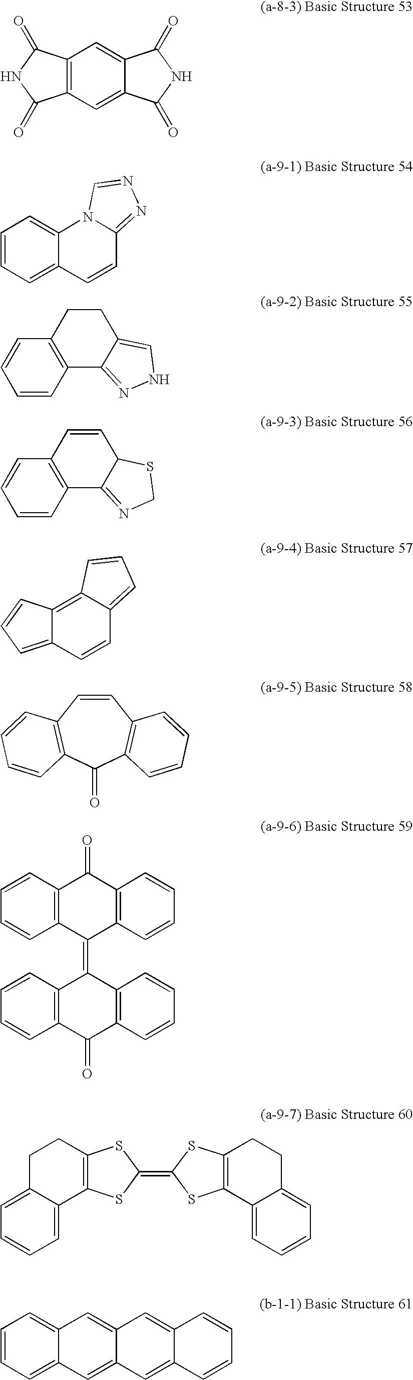

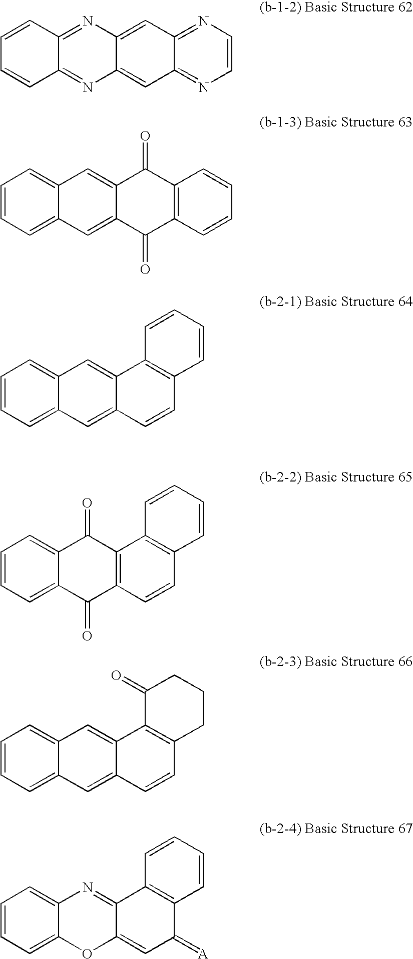

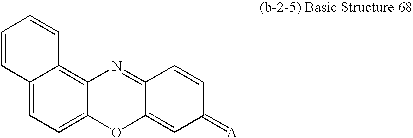

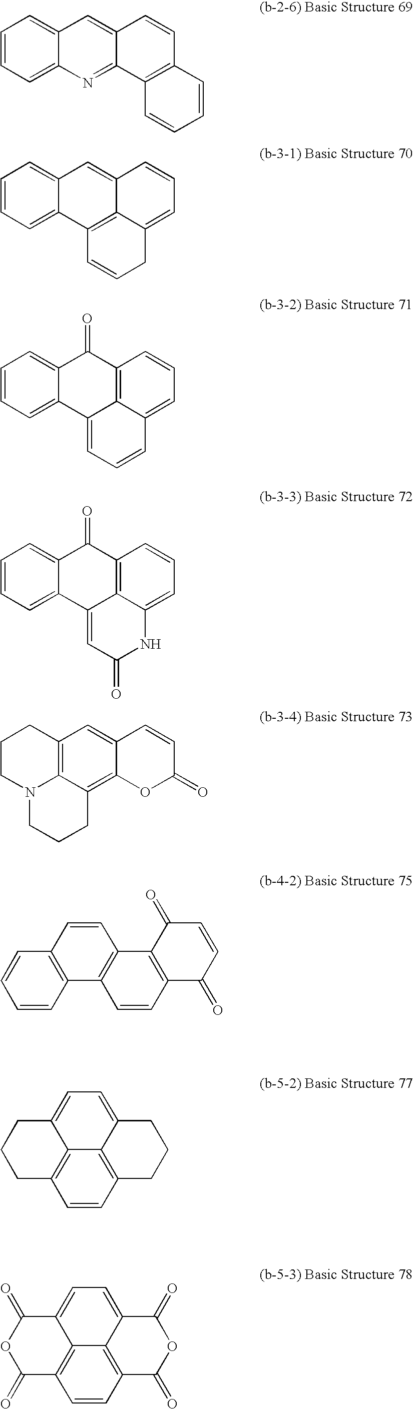

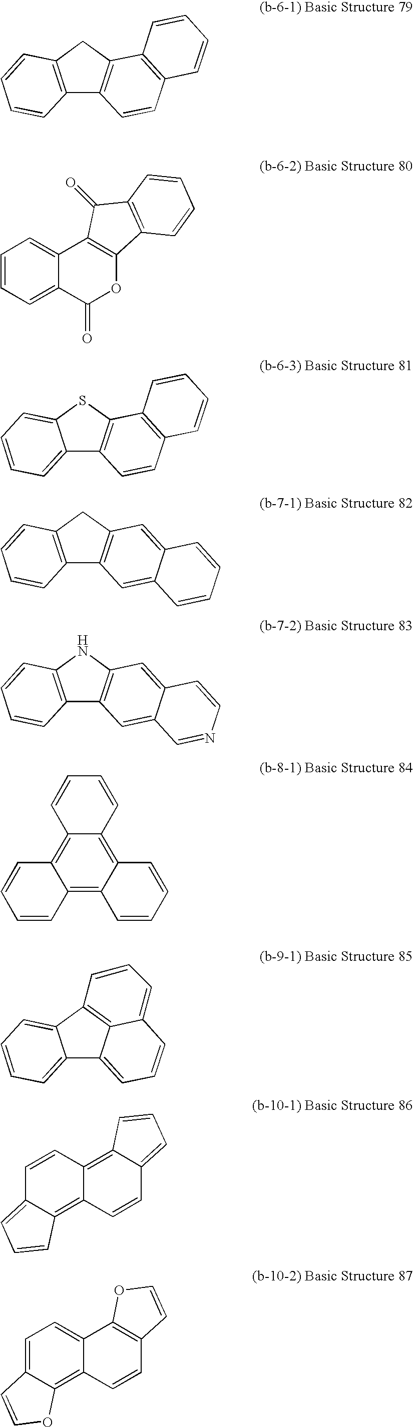

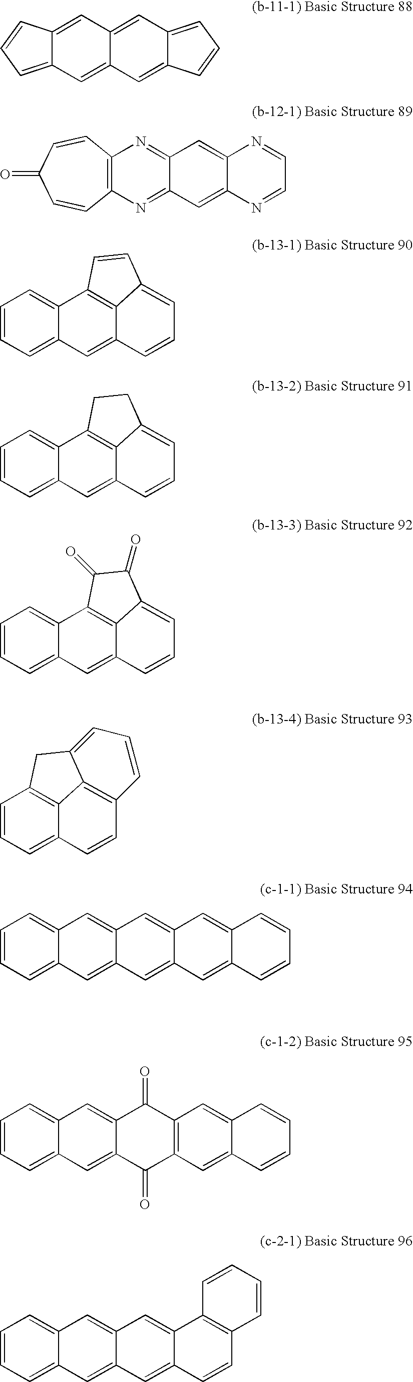

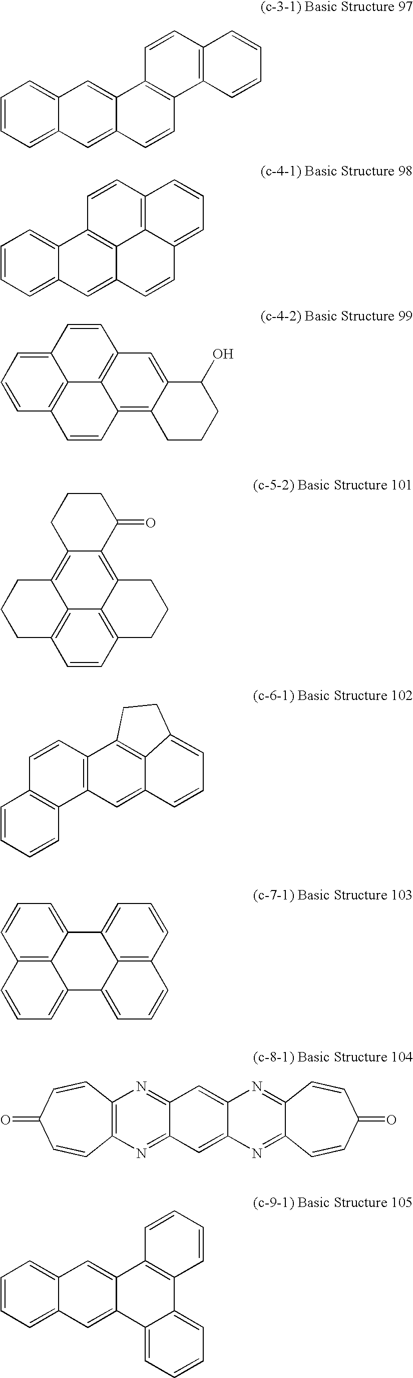

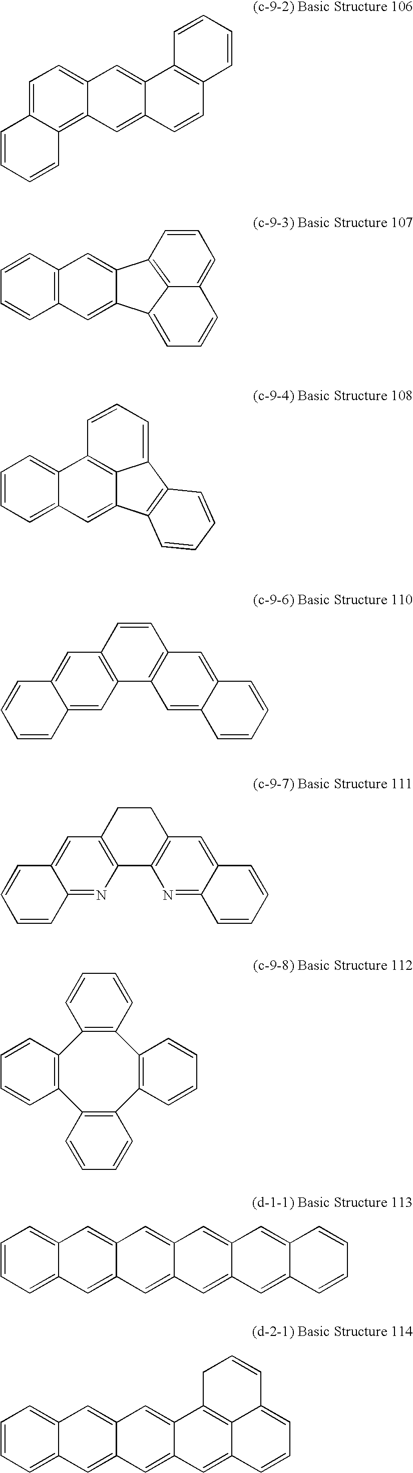

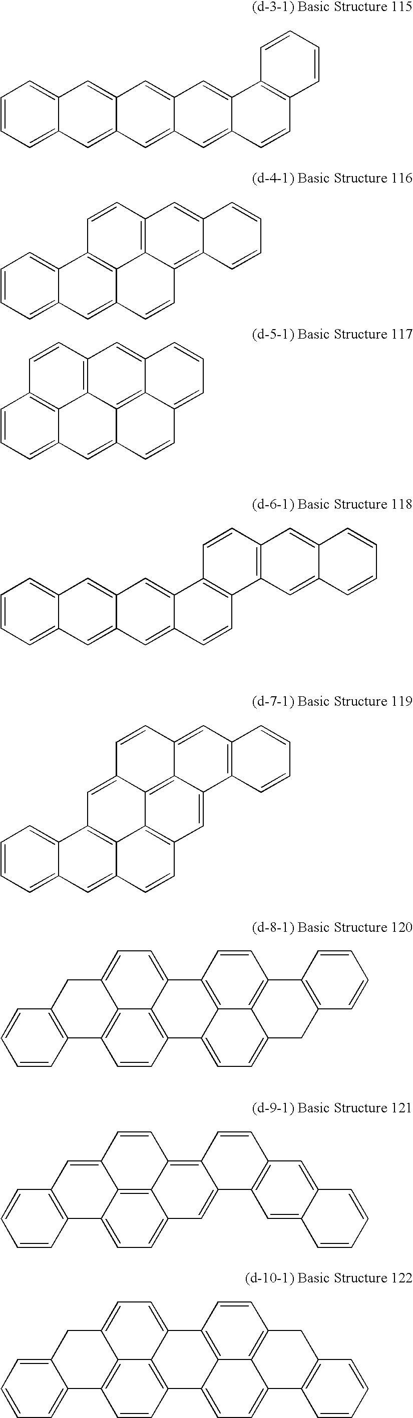

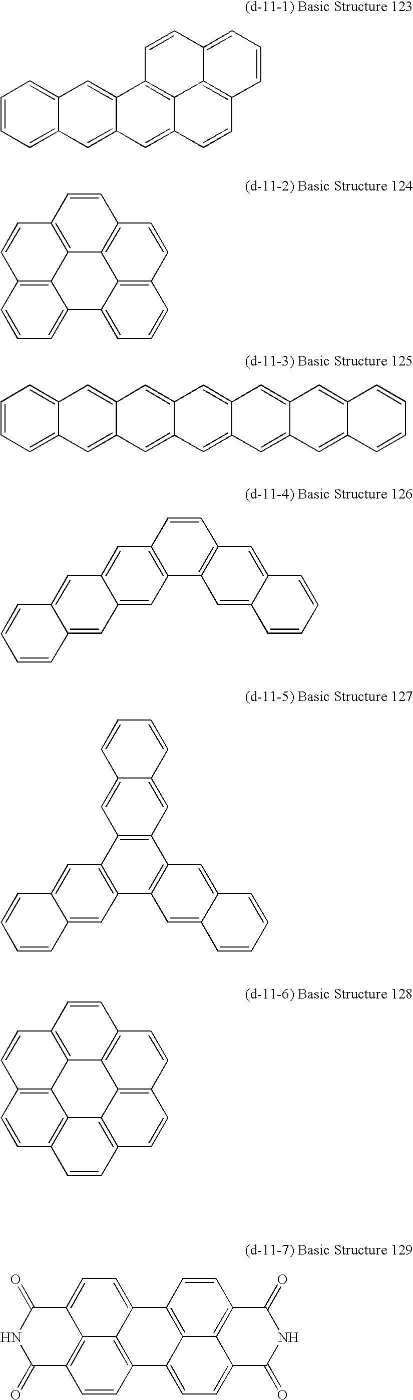

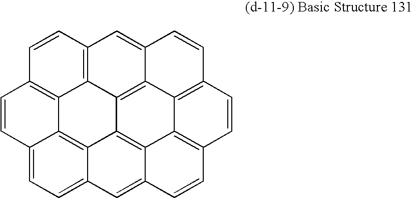

79. The method of controlling the crystallization of claim 76, wherein at least one of said polycyclic structures has one kind or two kinds or more selected from among a halogen, a nitro group, a cyano group, an alkyl group, an alkoxy group, an aralkyl group, an allyl group, an alkenyl group, an alkynyl group, an aryl group, an acyl group, an alkoxycarbonyl group, an aryloxycarbonyl group, an alkylaminocarbonyl group, an arylaminocarbonyl group, an alkylamino group, an arylamino group, an amino group, an acylamino group, a sulfonamide group, a sulfone group and a carboxyl group as substituents.

80. The method of controlling the crystallization of claim 76, wherein said compound having at least one structure selected from among polycyclic structures wherein three or more 4-membered or higher cyclic structures are condensed to form condensed ring is a salt comprising a cation and an anion that are tonically bound.

81. The method of controlling the crystallization of claim 80, wherein said salt is a salt formed as a result of the ionization of a sulfone group, a carboxyl group or an amino group having or not having a substituent in the basic structure of the said nucleating-effect-suppressor.

82. The method of controlling the crystallization of claim 80, wherein said anion is an anion from a carboxylic acid or a sulfonic acid.

83. The method of controlling the crystallization of claim 82, wherein said carboxylic acid and sulfonic acid are an aromatic or aliphatic sulfonic acid and an aromatic or aliphatic carboxylic acid, respectively.

84. The method of controlling the crystallization of claim 76, wherein said compound is any of the compounds having at least one structure selected from among polycyclic structures wherein six or more 4-membered or higher cyclic structures are condensed to form condensed ring, excluding nigrosine, aniline black, copper phthalocyanine derivatives, and decacyclene.

85. The method of controlling the crystallization of claim 76, wherein said compound has at least one structure selected from among polycyclic structures wherein three or more 4-membered or higher cyclic structures are condensed to form condensed ring,
the polycyclic structure having any one or more among a pyrrole ring, a pyroline ring, a pyrrolidine ring, a pyrazole ring, a pyrazoline ring, an imidazole ring, an imidazoline ring, an imidazolidine ring, an oxolan ring, a dioxolan ring, a thiolan ring, a thiazole ring, a cyclohexane ring, a piperidine ring, a piperazine ring, a pyridone ring, an oxane ring, a dioxane ring, a thian ring, a dithian ring and a thiazine ring,
the compound above being any of the compounds excluding nigrosine, aniline black and copper phthalocyanine derivatives.

86. The method of controlling the crystallization of claim 76, wherein said crystallization temperature fall is 4° C. or more.

87. The method of controlling the crystallization of claim 76, wherein by containing one kind or more of a nucleating-effect-suppressor comprising any of the compounds having at least one structure selected from among polycyclic structures wherein three or more 4-membered or higher cyclic structures are condensed to form condensed ring, excluding nigrosine, aniline black and copper phthalocyanine derivatives, in a crystalline resin, the average diameter of sphaerocrystals in a crystalline resin composition containing the nucleating-effect-suppressor is made 2 times or more the average diameter of sphaerocrystals in a crystalline resin in the aforementioned crystalline resin composition, which does not contain said nucleating-effect-suppressor.

88. The method of controlling the crystallization of claim 76, wherein by containing one kind or more of a nucleating-effect-suppressor comprising any of the compounds having at least one structure selected from among polycyclic structures wherein three or more 4-membered or higher cyclic structures are condensed to form condensed ring, excluding nigrosine, aniline black and copper phthalocyanine derivatives, in a crystalline resin, the number of sphaerocrystals in a prescribed area in a crystalline resin composition containing the nucleating-effect-suppressor is decreased compared to the number of sphaerocrystals in the aforementioned prescribed area in a crystalline resin in the aforementioned crystalline resin composition, which does not contain said nucleating-effect-suppressor.

89. The method of controlling the crystallization of claim 76, wherein said crystalline resin contains a fibrous reinforcing material, the crystallization temperature and crystallization rate of a crystalline resin composition containing the nucleating-effect-suppressor are lowered compared to the crystallization temperature and crystallization rate of a crystalline resin in the crystalline resin composition, which does not contain said nucleating-effect-suppressor.

90. The method of controlling the crystallization of claim 76, wherein said compound is colorless or light-colored.

91. A crystalline resin composition which contains a nucleating-effect-suppressor comprising a compound that controls the crystallization of the crystalline resin, said compound being any of the compounds having at least one structure selected from among polycyclic structures wherein three or more 4-membered or higher cyclic structures are condensed to form condensed ring, excluding nigrosine, aniline black and copper phthalocyanine derivatives, the crystallization temperature being lower than the crystallization temperature of a crystalline resin in the crystalline resin composition, which does not contain said nucleating-effect-suppressor.

92. The crystalline resin composition of claim 91, wherein at least one of said polycyclic structures is a structure selected from among Skeletal Structures enumerated below, and the individual bonds that constitute each skeletal structure are single or double bonds.

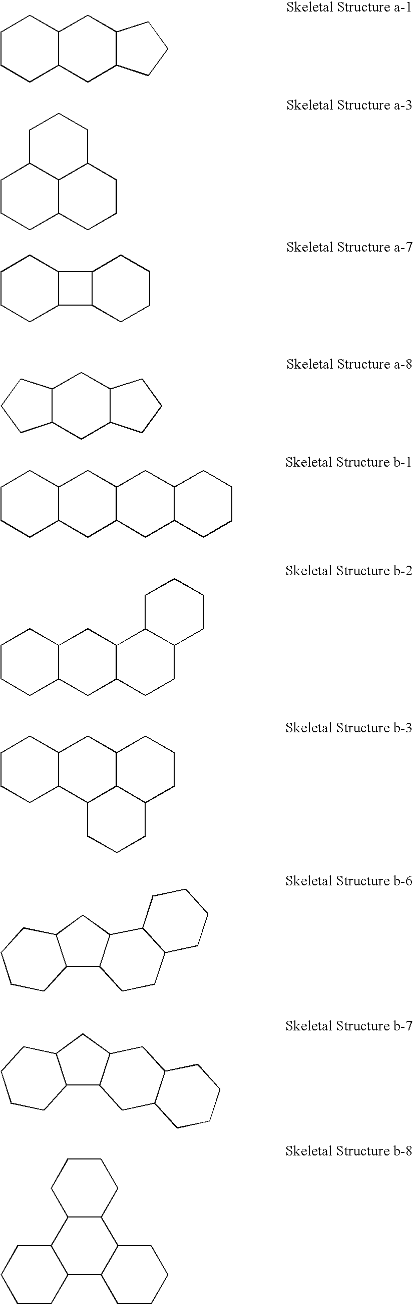

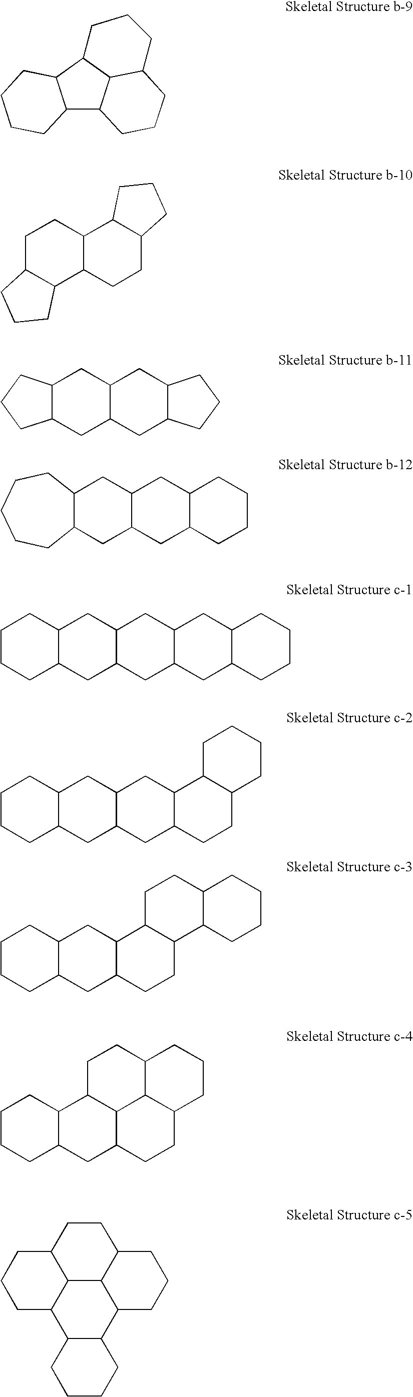

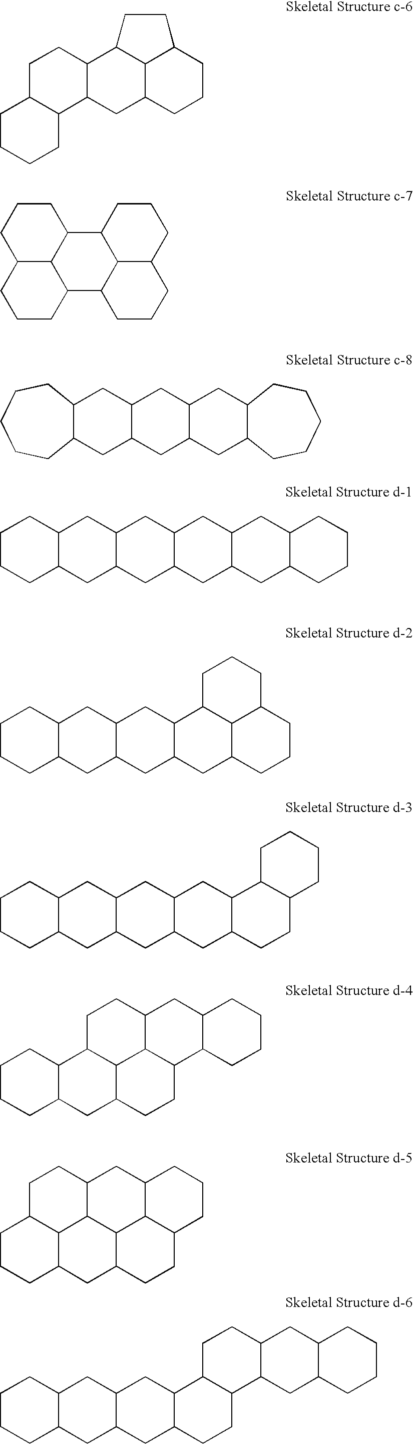

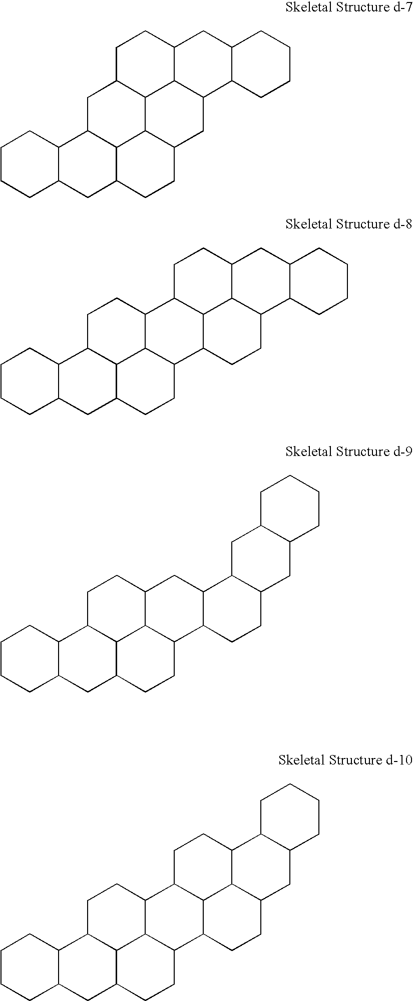

93. The crystalline resin composition of claim 91, wherein at least one of said polycyclic structures is a structure selected from among Basic Structures enumerated below.

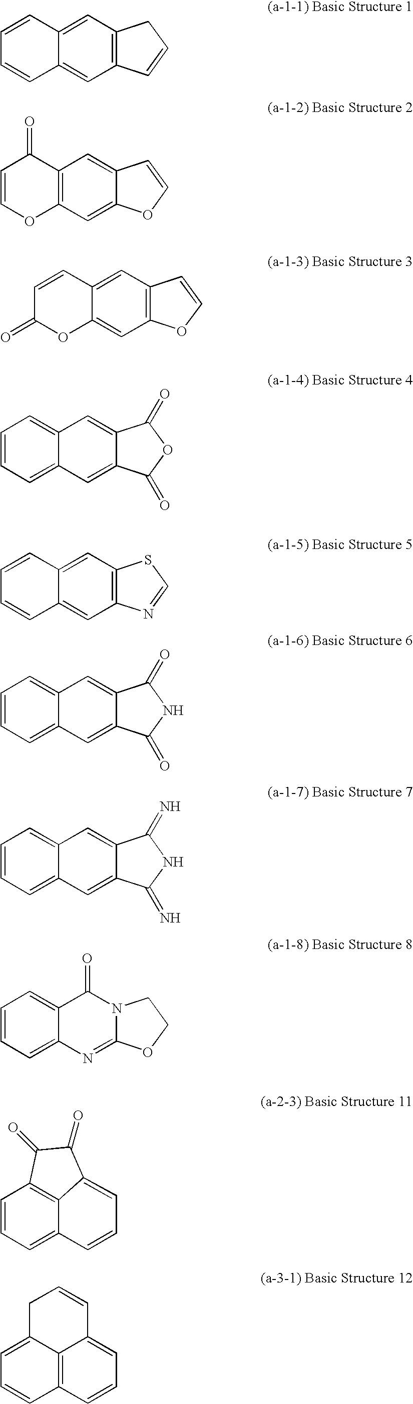

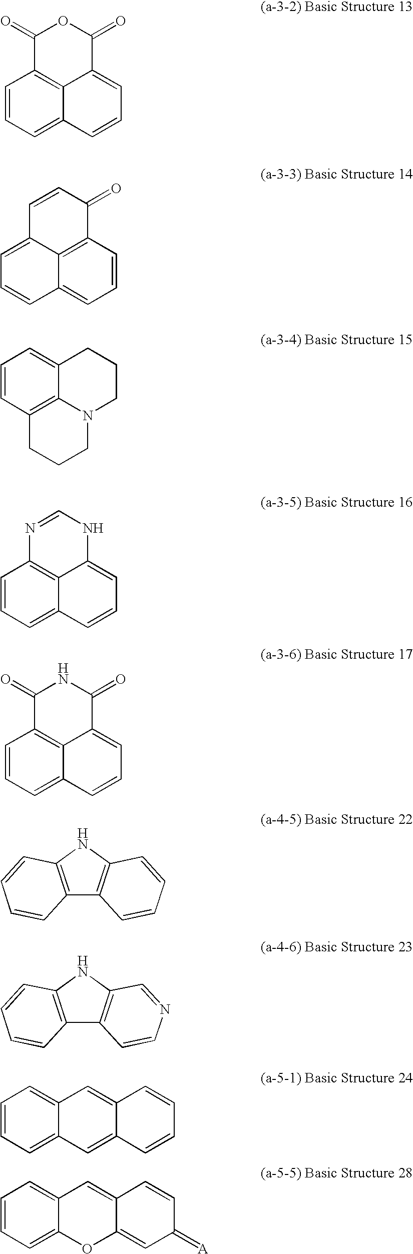

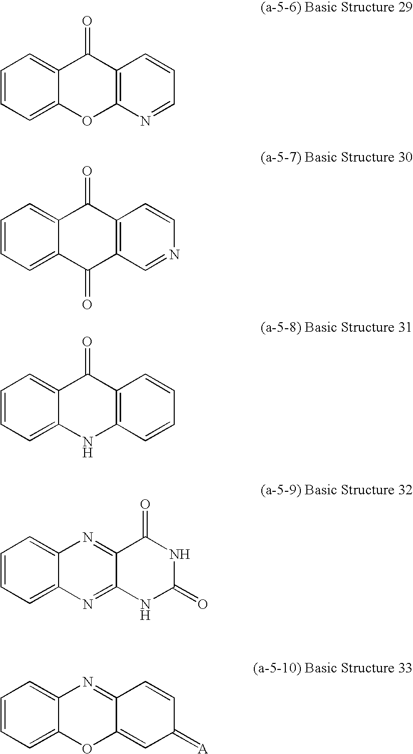

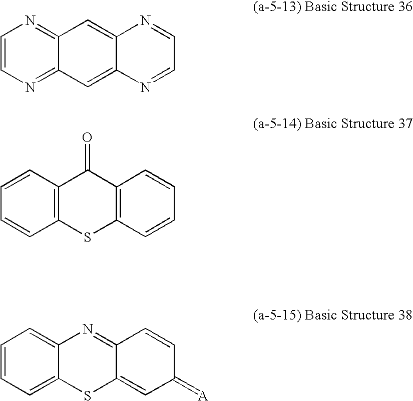

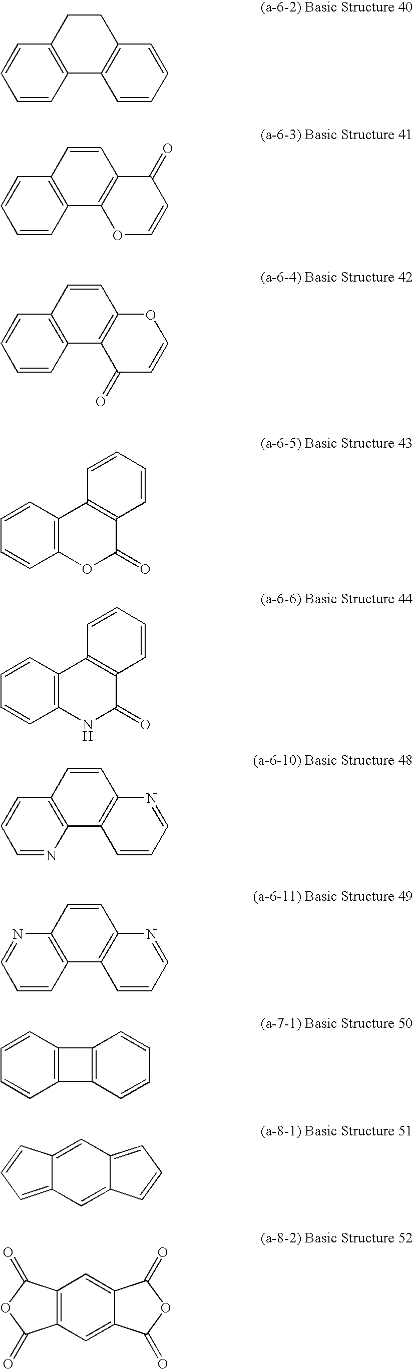

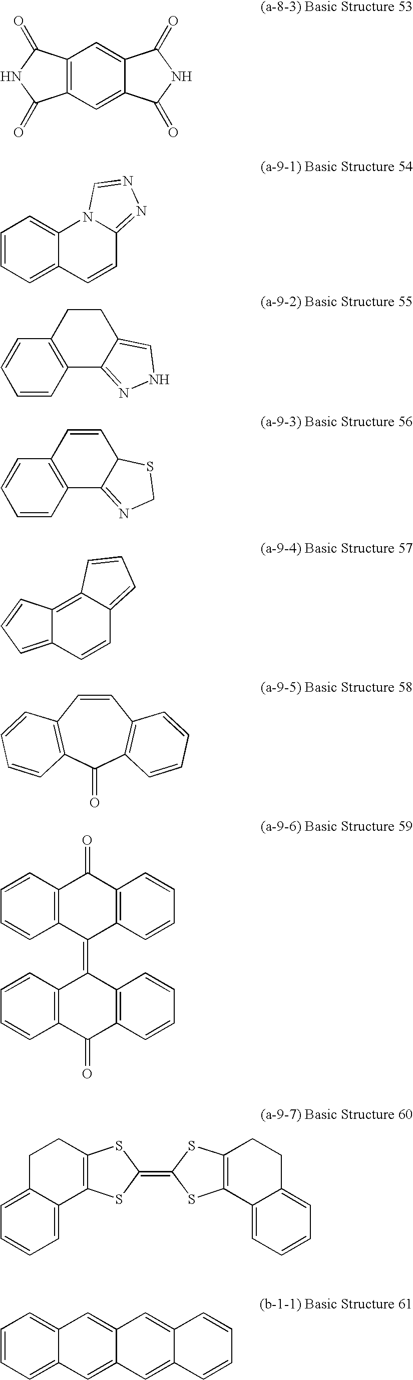

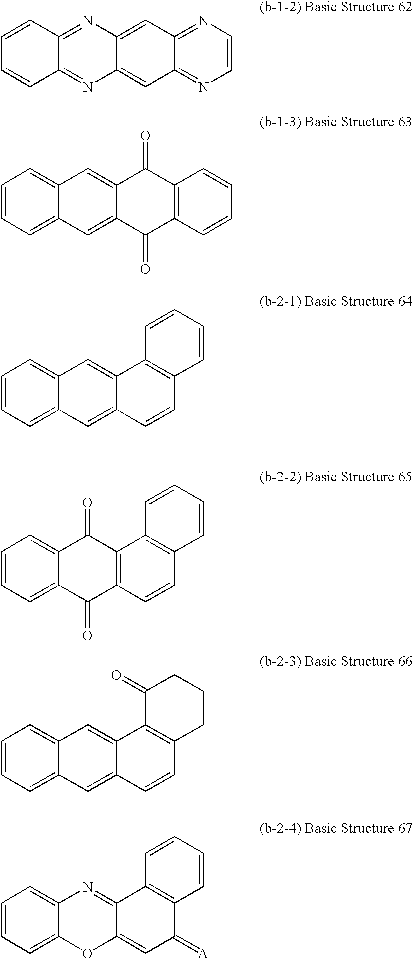

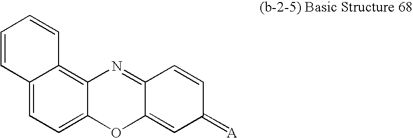

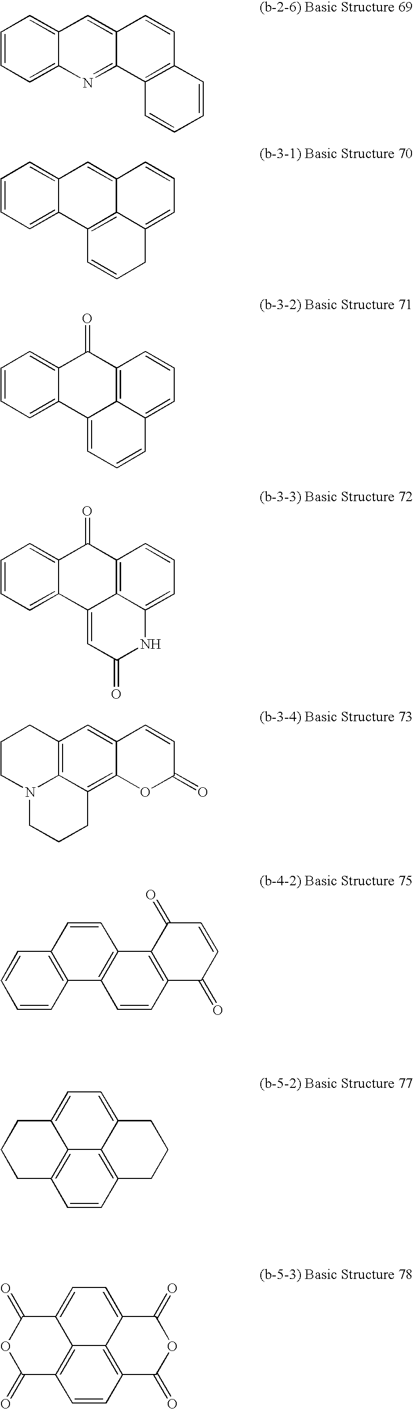

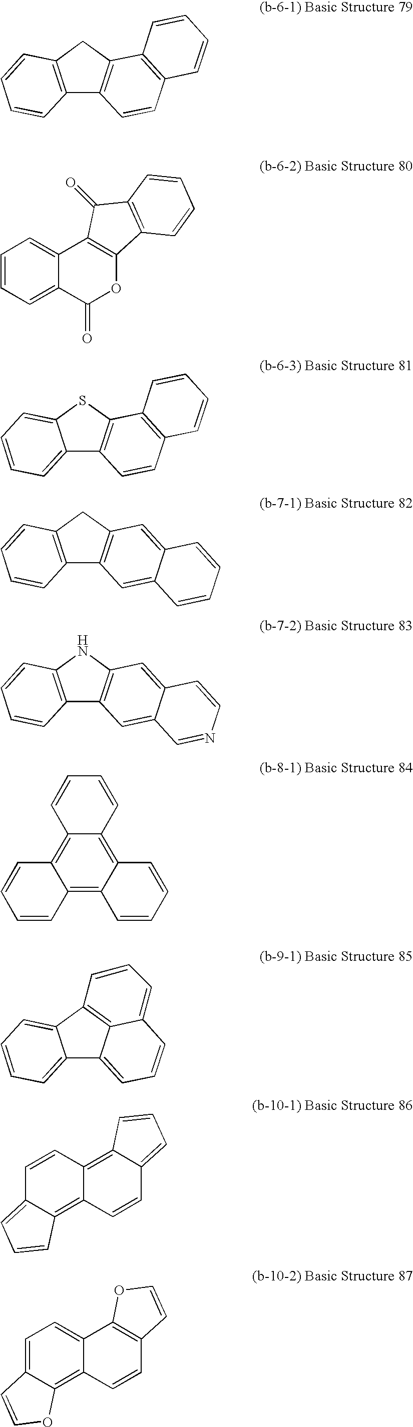

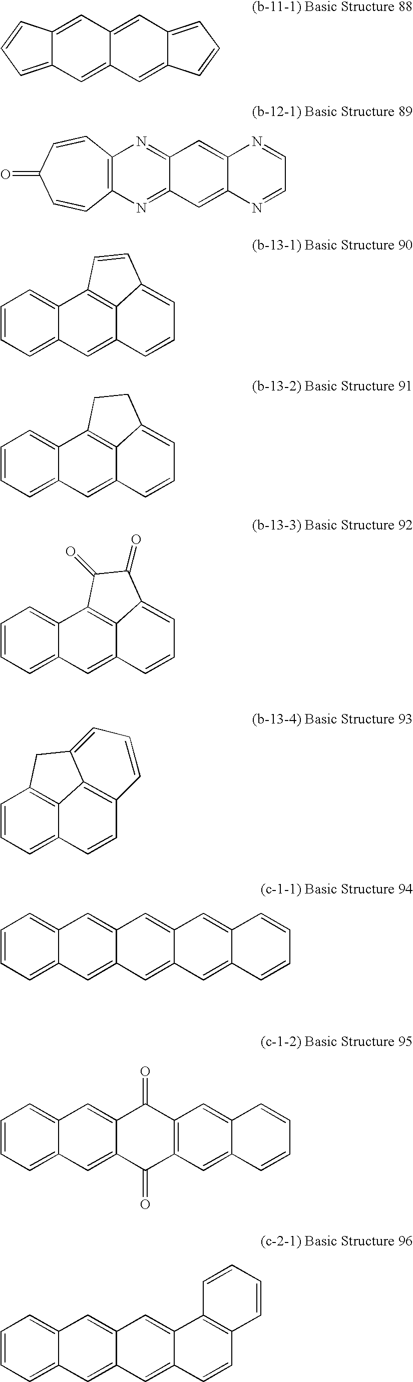

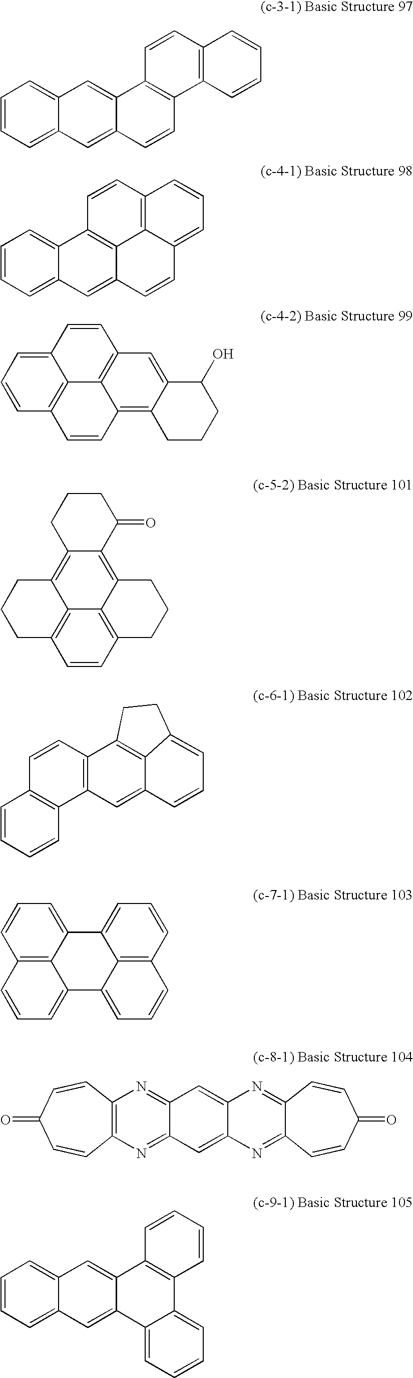

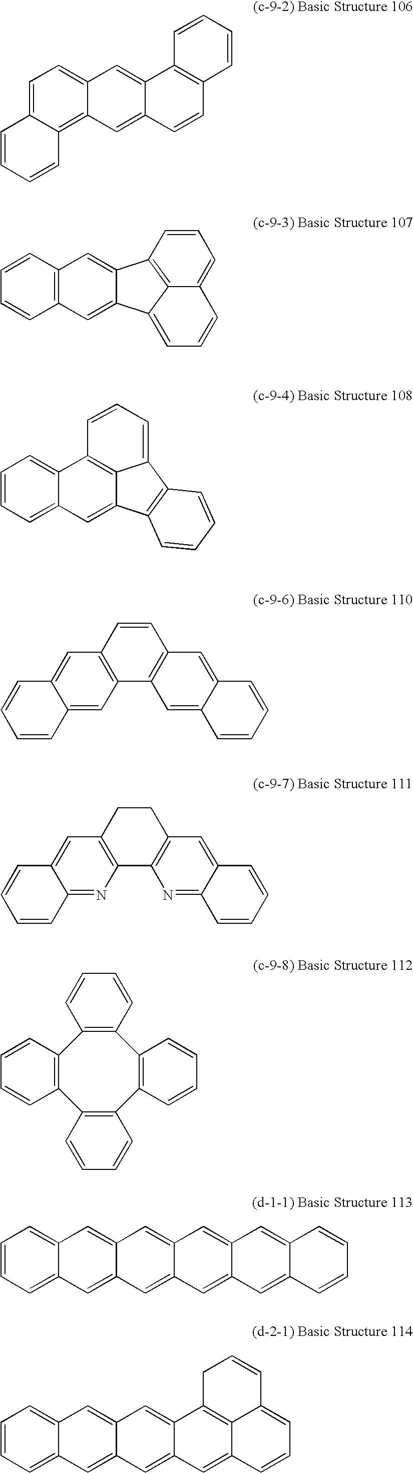

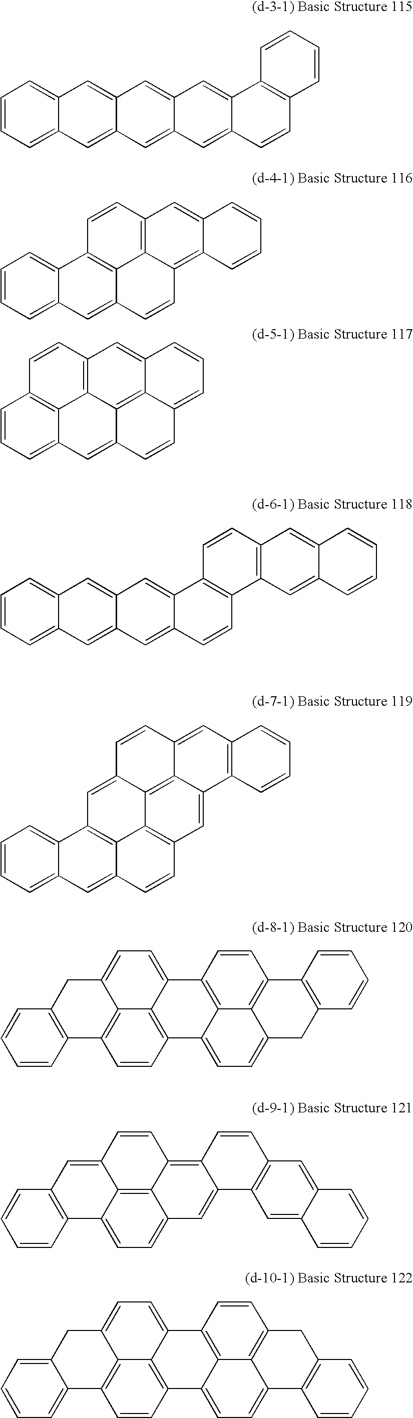

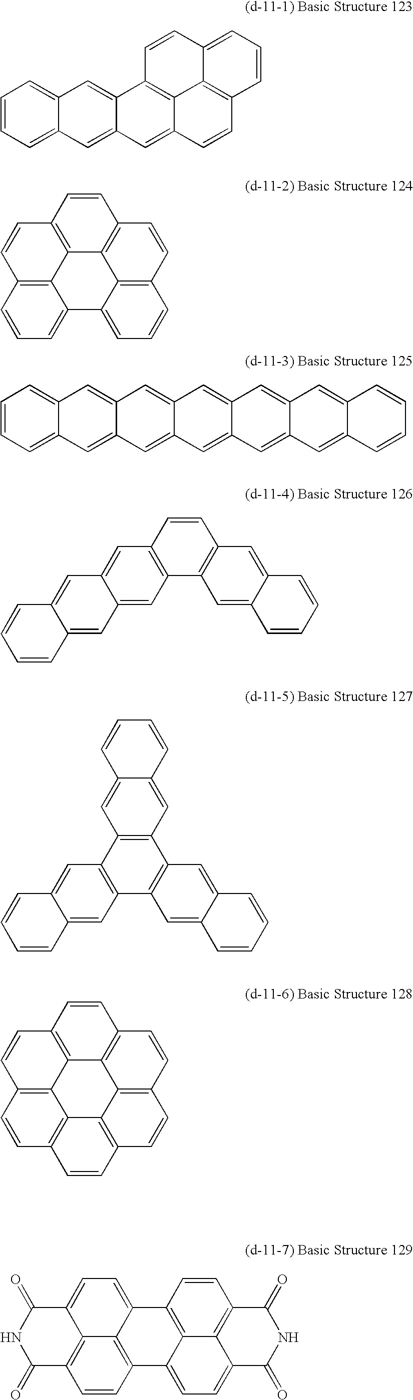

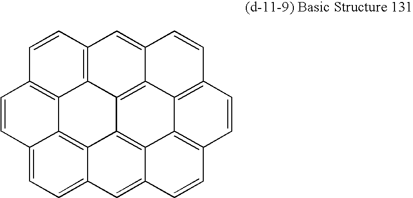

94. The crystalline resin composition of claim 91, wherein at least one of said polycyclic structures has one kind or two kinds or more selected from among a halogen, a nitro group, a cyano group, an alkyl group, an alkoxy group, an aralkyl group, an allyl group, an alkenyl group, an alkynyl group, an aryl group, an acyl group, an alkoxycarbonyl group, an aryloxycarbonyl group, an alkylaminocarbonyl group, an arylaminocarbonyl group, an alkylamino group, an arylamino group, an amino group, an acylamino group, a sulfonamide group, a sulfone group and a carboxyl group as substituents.

95. The crystalline resin composition of claim 91, wherein said compound having at least one structure selected from among polycyclic structures wherein three or more 4-membered or higher cyclic structures are condensed to form condensed ring is a salt comprising a cation and an anion that are ionically bound.

96. The crystalline resin composition of claim 95, wherein said salt is a salt formed as a result of the ionization of a sulfone group, a carboxyl group or an amino group having or not having a substituent in the basic structure of the said nucleating-effect-suppressor.

97. The crystalline resin composition of claim 95, wherein said anion is an anion from a carboxylic acid or a sulfonic acid.

98. The crystalline resin composition of claim 97, wherein said carboxylic acid and sulfonic acid are an aromatic or aliphatic sulfonic acid and an aromatic or aliphatic carboxylic acid, respectively.

99. The crystalline resin composition of claim 91, wherein said compound is any of the compounds having at least one structure selected from among polycyclic structures wherein six or more 4-membered or higher cyclic structures are condensed to form condensed ring, excluding nigrosine, aniline black, copper phthalocyanine derivatives, and decacyclene.

100. The crystalline resin composition of claim 91, wherein said compound has at least one structure selected from among polycyclic structures wherein three or more 4-membered or higher cyclic structures are condensed to form condensed ring,
the polycyclic structure having any one or more among a pyrrole ring, a pyroline ring, a pyrrolidine ring, a pyrazole ring, a pyrazoline ring, an imidazole ring, an imidazoline ring, an imidazolidine ring, an oxolan ring, a dioxolan ring, a thiolan ring, a thiazole ring, a cyclohexane ring, a piperidine ring, a piperazine ring, a pyridone ring, an oxane ring, a dioxane ring, a thian ring, a dithian ring and a thiazine ring,
the compound above being any of the compounds excluding nigrosine, aniline black and copper phthalocyanine derivatives.

101. The crystalline resin composition of claim 91, wherein said crystallization temperature fall is 4° C. or more.

102. The crystalline resin composition of claim 91, wherein said crystalline resin is one or a mixture of two or more selected from among polyamide resin, polyethylene resin, polypropylene resin, polyethylene terephthalate resin, polybutylene terephthalate resin, polyphenylene sulfide resin and polyether ether ketone resin.

103. The crystalline resin composition of claim 91, which contains a fibrous reinforcing material.

104. A crystalline resin molded product which contains a nucleating-effect-suppressor comprising a compound that controls the crystallization of a crystalline resin in the crystalline resin, the aforementioned compound being any of the compounds having at least one structure selected from among polycyclic structures wherein three or more 4-membered or higher cyclic structures are condensed to form condensed ring, excluding nigrosine, aniline black and copper phthalocyanine derivatives.

105. The crystalline resin molded product of claim 104, wherein the average diameter of sphaerocrystals is 2 times or more the average diameter of sphaerocrystals in the crystalline resin in said crystalline resin composition, which does not contain the above-described nucleating-effect-suppressor.

106. The crystalline resin molded product of claim 104, wherein the number of sphaerocrystals in a prescribed area is decreased compared to the number of sphaerocrystals in the aforementioned prescribed area in the crystalline resin in said crystalline resin molded product, which does not contain the above-described nucleating-effect-suppressor.

107. The crystalline resin molded product of claim 104, wherein said crystalline resin is one or a mixture of two or more selected from among polyamide resin, polyethylene resin, polypropylene resin, polyethylene terephthalate resin, polybutylene terephthalate resin, polyphenylene sulfide resin and polyether ether ketone resin.

108. The crystalline resin molded product of claim 104, which contains a fibrous reinforcing material.
